(19) United States
(12) Patent Application Publication
(10) Pub. No.: US 2026/0271055 A1
(43) Pub. Date: Sep. 10, 2026

(54) SIGNALING FOR EARLY SRS TRIGGERING

(71) Applicant: Samsung Electronics Co., Ltd., Suwon-si (KR)

(72) Inventors: Emad Nader Farag, Flanders, NJ (US); Anil Agiwal, McKinney, TX (US); Eko Onggosanusi, Coppell, TX (US)

(21) Appl. No.: 19/441,777

(22) Filed: Jan. 6, 2026

Related U.S. Application Data
(60) Provisional application No. 63/751,667, filed on Jan. 30, 2025.
(60) Provisional application No. 63/755,727, filed on Feb. 7, 2025.
(60) Provisional application No. 63/858,076, filed on Aug. 5, 2025.

(51) Int. Cl. H04W 74/00; H04W 72/11; H04W 74/0833; H04W 76/27

(52) U.S. Cl. CPC H04W 74/006; H04W 72/11; H04W 74/0833; H04W 76/27

(57) ABSTRACT

Methods and apparatuses for early sounding referenced signal (SRS) triggering. a method of operating a user equipment (UE) is provided. The method includes receiving configuration information for a list of sounding reference signal (SRS) resource sets for antenna switching and a list of timing offsets, initiating a Type-1 random access (RA) procedure to transition from an idle state to a connected state, and transmitting, in a message 3 (msg3) of the RA procedure, information indicating an antenna switching capability. The method further includes receiving a message to trigger transmission of an SRS resource set from the list of SRS resource sets and transmitting the SRS resource set at or after the timing offset. The SRS resource set corresponds to the antenna switching capability. The message indicates a timing offset from the list of timing offsets. The timing offset is relative to a slot that includes the message.

### CROSS-REFERENCE TO RELATED AND CLAIM OF PRIORITY

The present application claims priority under 35 U.S.C. § 119(e) to U.S. Provisional Patent Application No. 63/751,667 filed on Jan. 30, 2025, U.S. Provisional Patent Application No. 63/755,727 filed on Feb. 7, 2025, and U.S. Provisional Patent Application No. 63/858,076 filed on Aug. 5, 2025, which are hereby incorporated by reference in their entirety.

### TECHNICAL FIELD

The present disclosure relates generally to wireless communication systems and, more specifically, the present disclosure relates to signaling for early sounding reference signal (SRS) triggering.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to signaling for early SRS triggering.

In one embodiment, a user equipment (UE) is provided. The UE includes a transceiver configured to receive configuration information for a list of SRS resource sets for antenna switching, and a list of timing offsets and a processor operably coupled to the transceiver. The processor is configured to initiate a Type-1 random access (RA) procedure to transition from an idle state to a connected state. The transceiver is further configured to transmit, in a message 3 (msg3) of the RA procedure, information indicating an antenna switching capability, receive a message to trigger transmission of a SRS resource set from the list of SRS resource sets, and transmit the SRS resource set at or after the timing offset. The SRS resource set corresponds to the antenna switching capability. The message indicates a timing offset from the list of timing offsets. The timing offset is relative to a slot that includes the message.

In another embodiment, a base station (BS) is provided. The BS includes a processor and a transceiver operably coupled to the processor. The transceiver is configured to transmit configuration information for a list of SRS resource sets for antenna switching and a list of timing offsets, receive a PRACH preamble from a UE for a Type-1 RA procedure to transition from an idle state to a connected state, receive, in a msg3 of the RA procedure, information indicating an antenna switching capability, transmit a message to trigger transmission of an SRS resource set from the list of SRS resource sets, and receive the SRS resource set at or after the timing offset. The SRS resource set corresponds to the antenna switching capability. The message indicates a timing offset from the list of timing offsets. The timing offset is relative to a slot that includes the message.

In yet another embodiment, a method of operating a UE is provided. The method includes receiving configuration information for a list of SRS resource sets for antenna switching and a list of timing offsets, initiating a Type-1 RA procedure to transition from an idle state to a connected state, and transmitting, in a msg3 of the RA procedure, information indicating an antenna switching capability. The method further includes receiving a message to trigger transmission of an SRS resource set from the list of SRS resource sets and transmitting the SRS resource set at or after the timing offset. The SRS resource set corresponds to the antenna switching capability. The message indicates a timing offset from the list of timing offsets. The timing offset is relative to a slot that includes the message.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example BS according to embodiments of the present disclosure;

FIG. 3 illustrates an example UE according to embodiments of the present disclosure;

FIGS. 4A and 4B illustrates an example of a wireless transmit and receive paths according to embodiments of the present disclosure;

FIG. 5A illustrates an example of a wireless system according to embodiments of the present disclosure;

FIG. 5B illustrates an example of a multi-beam operation according to embodiments of the present disclosure;

FIG. 6 illustrates an example of a transmitter structure for beamforming according to embodiments of the present disclosure;

FIG. 7 illustrates an example primary synchronization signal (PSS)/secondary synchronization signal (SSS)/physical broadcast channel (PBCH) (SSB) block according to embodiments of the present disclosure;

FIG. 8 illustrates an example type-1 random access procedure according to embodiments of the present disclosure;

FIG. 9 illustrates an example type-2 random access procedure according to embodiments of the present disclosure;

FIG. 9A illustrates an example medium access control (MAC) random access response (RAR) (for type-1 random access procedure) according to embodiments of the present disclosure;

FIG. 9B illustrates an example fallback RAR (for type-2 random access procedure) according to embodiments of the present disclosure;

FIG. 9C illustrates an example success RAR (for type-2 random access procedure) according to embodiments of the present disclosure;

FIG. 10 illustrates an example of configuring a SRS resource according to embodiments of the present disclosure;

FIG. 11 illustrates an example of various UE configurations according to embodiments of the present disclosure;

FIGS. 12A and 12B illustrate examples of SRS as sub-band SRS according to embodiments of the present disclosure;

FIGS. 13A-13E illustrate examples of fields related to a UE-ID and SRS resource ID according to embodiments of the present disclosure;

FIGS. 14A-14C illustrate examples of SRS ID being indicated in downlink control information (DCI) format according to embodiments of the present disclosure;

FIGS. 15A and 15B illustrate examples of SRS configuration according to embodiments of the present disclosure;

FIGS. 16A and 16B illustrate examples of transmitting SRS resources per instance according to embodiments of the present disclosure;

FIG. 17 illustrates an example procedure for early SRS transmission according to embodiments of the present disclosure;

FIG. 18 illustrates another example procedure for early SRS transmission according to embodiments of the present disclosure;

FIG. 19 illustrates an example of UE reception of a downlink assignment and transmission of associated early SRS according to embodiments of the present disclosure;

FIG. 20 illustrates an example of UE transmission of xTyR capability according to embodiments of the present disclosure; and

FIG. 21 illustrates an example method performed by a UE in a wireless communication system according to embodiments of the present disclosure.

### DETAILED DESCRIPTION

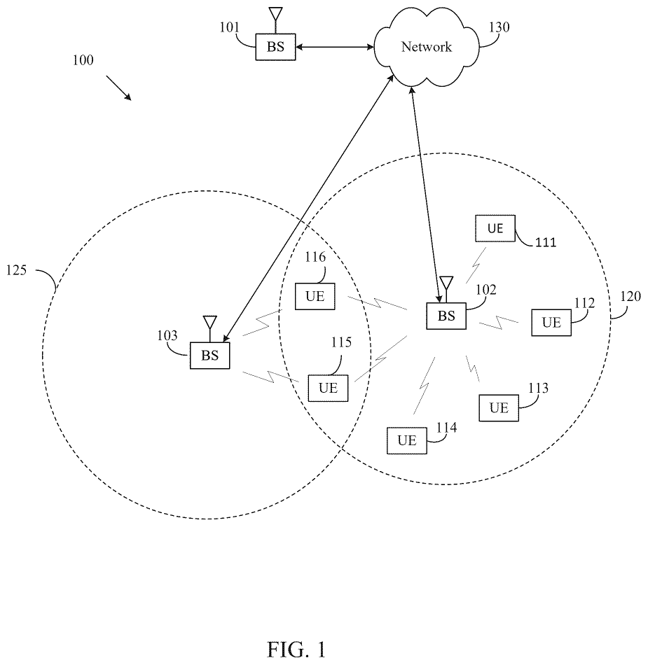

FIGS. 1-21, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR and 6GR communication systems.

In addition, in 5G/NR and 6GR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein [REF 1]3GPP TS 38.211 v18.1.0, “NR; Physical channels and modulation;” [REF 2]3GPP TS 38.212 v18.1.0, “NR; Multiplexing and Channel coding;” [REF 3]3GPP TS 38.213 v18.1.0, “NR; Physical Layer Procedures for Control;” [REF 4]3GPP TS 38.214 v18.1.0, “NR; Physical Layer Procedures for Data;” [REF 5]3GPP TS 38.321 v18.0.0, “NR; Medium Access Control (MAC) protocol specification;” and [REF 6]3GPP TS 38.331 v18.0.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a BS 101, a BS 102, and a BS 103. The BS 101 communicates with the BS 102 and the BS 103. The BS 101 also communicates with at least one network 130, such as the Internet, a proprietary Internet Protocol (IP) network, or other data network.

The BS 102 provides wireless broadband access to the network 130 for a first plurality of user equipments (UEs) within a coverage area 120 of the BS 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The BS 103 provides wireless broadband access to the network 130 for a second plurality of UEs within a coverage area 125 of the BS 103. The second plurality of UEs includes the UE 115 and the UE 116. In some embodiments, one or more of the BS s 101-103 may communicate with each other and with the UEs 111-116 using 6GR, 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a 6GR base station, a macrocell, a femtocell, a WiFi access point (AP), or other wirelessly enabled devices. Base stations may provide wireless access in accordance with one or more wireless communication protocols, e.g., 6GR, 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with BSs, such as the coverage areas 120 and 125, may have other shapes, including irregular shapes, depending upon the configuration of the BSs and variations in the radio environment associated with natural and man-made obstructions.

As described in more detail below, one or more of the UEs 111-116 include circuitry, programing, or a combination thereof for performing signaling and methods for early SRS triggering. In certain embodiments, one or more of the BSs 101-103 include circuitry, programing, or a combination thereof to support signaling and methods for early SRS triggering.

Although FIG. 1 illustrates one example of a wireless network, various changes may be made to FIG. 1. For example, the wireless network 100 could include any number of BSs and any number of UEs in any suitable arrangement. Also, the BS 101 could communicate directly with any number of UEs and provide those UEs with wireless broadband access to the network 130. Similarly, each BS 102-103 could communicate directly with the network 130 and provide UEs with direct wireless broadband access to the network 130. Further, the BSs 101, 102, and/or 103 could provide access to other or additional external networks, such as external telephone networks or other types of data networks.

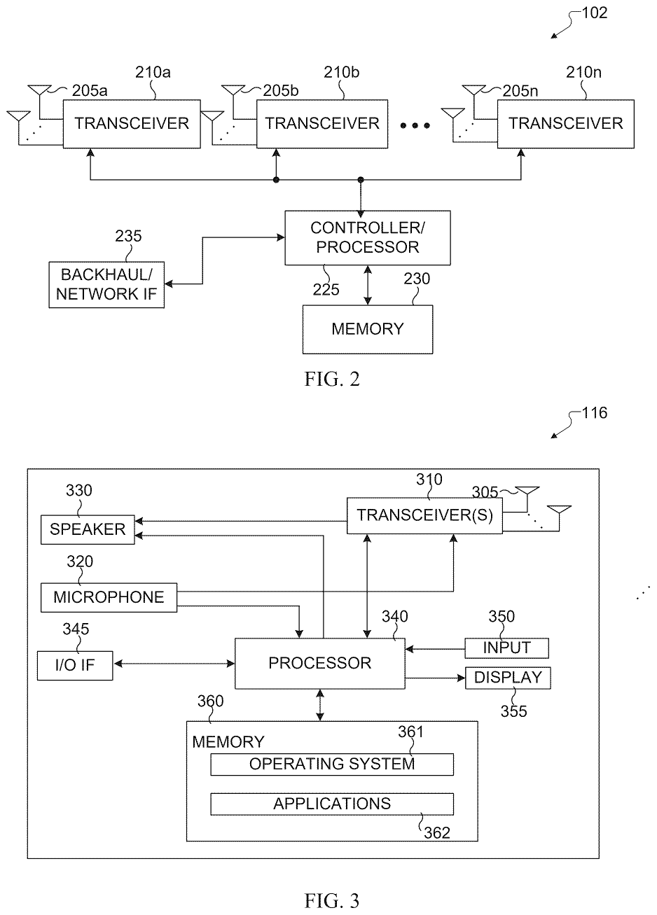

FIG. 2 illustrates an example BS 102 according to embodiments of the present disclosure. The embodiment of the BS 102 illustrated in FIG. 2 is for illustration only, and the BSs 101 and 103 of FIG. 1 could have the same or similar configuration. However, BSs come in a wide variety of configurations, and FIG. 2 does not limit the scope of this disclosure to any particular implementation ofa BS.

As shown in FIG. 2, the BS 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the BS 102. For example, the controller/processor 225 could control the reception of uplink (UL) channels or signals and the transmission of downlink (DL) channels or signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the BS 102 by the controller/processor 225.

The controller/processor 225 is also capable of executing programs and other processes resident in the memory 230, such as supporting signaling and methods for early SRS triggering. The controller/processor 225 can move data into or out of the memory 230 as required by an executing process.

The controller/processor 225 is also coupled to the backhaul or network interface 235. The backhaul or network interface 235 allows the BS 102 to communicate with other devices or systems over a backhaul connection or over a network. The interface 235 could support communications over any suitable wired or wireless connection(s). For example, when the BS 102 is implemented as part of a cellular communication system (such as one supporting 6GR, 5G/NR, LTE, or LTE-A), the interface 235 could allow the BS 102 to communicate with other BSs over a wired or wireless backhaul connection. When the BS 102 is implemented as an access point, the interface 235 could allow the BS 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of BS 102, various changes may be made to FIG. 2. For example, the BS 102 could include any number of each component shown in FIG. 2. Also, various components in FIG. 2 could be combined, further subdivided, or omitted and additional components could be added according to particular needs.

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a BS of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels or signals and the transmission of UL channels or signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes that utilize signaling and methods for early SRS triggering as described in embodiments of the present disclosure. The processor 340 can move data into or out of the memory 360 as required by an executing process. In some embodiments, the processor 340 is configured to execute the applications 362 based on the OS 361 or in response to signals received from BSs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

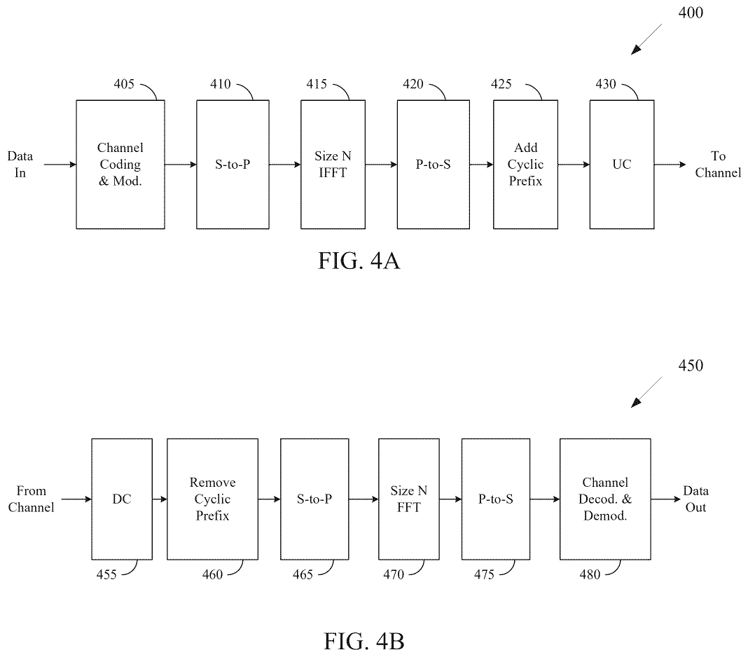

FIG. 4A and FIG. 4B illustrate an example of wireless transmit and receive paths 400 and 450, respectively, according to embodiments of the present disclosure. For example, a transmit path 400 may be described as being implemented in a BS (such as BS 102), while a receive path 450 may be described as being implemented in a UE (such as UE 116). However, it will be understood that the receive path 450 can be implemented in a BS and that the transmit path 400 can be implemented in a UE. In some embodiments, the transmit path 400 is configured to support signaling and methods for early SRS triggering as described in embodiments of the present disclosure. In some embodiments, the receive path 450 is configured to support signaling and methods for early SRS triggering as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the BS 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the BSs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to BSs 101-103 and may implement a receive path 450 for receiving in the downlink from BSs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

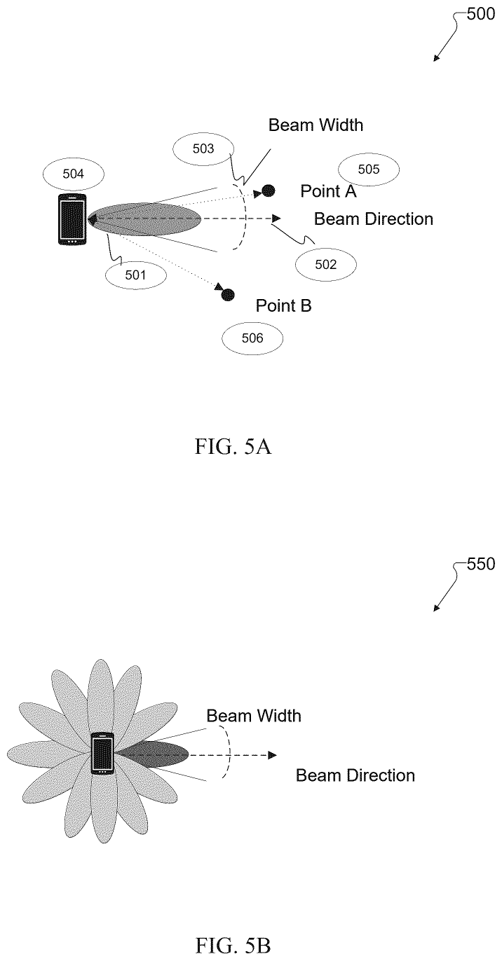

As illustrated in FIG. 5A, in a wireless system 500, a beam 501 for a device 504 can be characterized by a beam direction 502 and a beam width 503. For example, the device 504 (or UE 116) transmits RF energy in a beam direction and within a beam width. The device 504 receives RF energy in a beam direction and within a beam width. As illustrated in FIG. 5A, a device at point A 505 can receive from and transmit to device 504 as Point A is within a beam width and direction of a beam from device 504. As illustrated in FIG. 5A, a device at point B 506 cannot receive from and transmit to device 504 as Point B 506 is outside a beam width and direction of a beam from device 504. While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example of a multi-beam operation 550 according to embodiments of the present disclosure. For example, the multi-beam operation 550 can be utilized by UE 116 of FIG. 3. This example is for illustration only and other embodiments can be used without departing from the scope of the present disclosure.

In a wireless system, a device can transmit and/or receive on multiple beams. This is known as “multi-beam operation”. While FIG. 5B, for illustrative purposes, a beam is in 2D, it should be apparent to those skilled in the art, that a beam can be 3D, where a beam can be transmitted to or received from any direction in space.

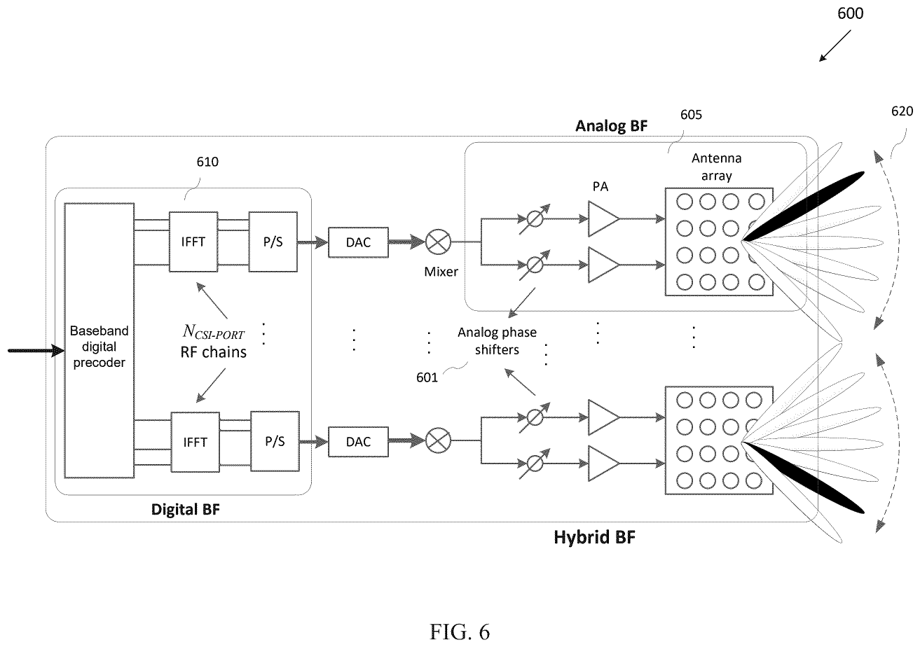

FIG. 6 illustrates an example of a transmitter structure 600 for beamforming according to embodiments of the present disclosure. In certain embodiments, one or more of BS 102 or UE 116 includes the transmitter structure 600. For example, one or more of antenna 205 and its associated systems or antenna 305 and its associated systems can be included in transmitter structure 600. This example is for illustration only and other embodiments can be used without departing from the scope of the present disclosure.

Accordingly, embodiments of the present disclosure recognize that Rel-14 LTE and Rel-15 NR support up to 32 channel state information refence signal (CSI-RS) antenna ports which enable an eNB or a BS to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz. In this case, the system can employ only analog beams. Due to the 02 absorption loss around 60 GHz frequency (~10 dB additional loss per 100 m distance), a larger number and narrower analog beams (hence a larger number of radiators in the array) are needed to compensate for the additional path loss.

In this disclosure, a beam can be determined by either of,
A transmission configuration indication (TCI) state, that establishes a quasi-colocation (QCL) relationship between a source reference signal (e.g., synchronization signal block (SSB) and/or CSI-RS) and a target reference signal
A spatial relation information that establishes an association to a source reference signal, such as SSB or CSI-RS or sounding reference signal (SRS).

In either case, the ID of the source reference signal identifies the beam.

The TCI state and/or the spatial relation reference RS can determine a spatial Rx filter for reception of downlink channels at the UE, or a spatial TX filter for transmission of uplink channels from the UE.

Rel-17 introduced the unified TCI framework, where a unified or master or main TCI state is signaled to the UE. The unified or master or main TCI state can be one of:
In case of joint TCI state indication, wherein a same beam is used for DL and UL channels, a joint TCI state that can be used at least for UE-dedicated DL channels and UE-dedicated UL channels.
In case of separate TCI state indication, wherein different beams are used for DL and UL channels, a DL TCI state can be used at least for UE-dedicated DL channels.
In case of separate TCI state indication, wherein different beams are used for DL and UL channels, a UL TCI state can be used at least for UE-dedicated UL channels.

The unified (main or indicated) TCI state is TCI state of UE-dedicated reception on PDSCH/PDCCH or dynamic-grant/configured-grant based PUSCH and all of dedicated PUCCH resources. In this disclosure, a TCI state can be referred to as a spatial resource unit.

The unified TCI framework also applies to intra-cell beam management, wherein, the TCI states have a source RS that is directly or indirectly associated, through a quasi-co-location relation, e.g., spatial relation, with an SSB or port/PG of a serving cell (e.g., the TCI state is associated with a TRP of a serving cell). The unified TCI state framework also applies to inter-cell beam management, wherein a TCI state can have a source RS that is directly or indirectly associated, through a quasi-co-location relation, e.g., spatial relation, with an SSB or port/PG of cell that has a physical cell identity (PCI) different from the PCI of the serving cell (e.g., the TCI state is associated with a TRP of a cell having a PCI different from the PCI of the serving cell).

Quasi-co-location (QCL) relation, can be quasi-location with respect to one or more of the following relations [38.214—section 5.1.5]:
Type A, {Doppler shift, Doppler spread, average delay, delay spread}
Type B, {Doppler shift, Doppler spread}
Type C, {Doppler shift, average delay}
Type D, {Spatial Rx parameter} or port/PG

In addition, quasi-co-location relation and source reference signal or port/PG can also provide a spatial relation for UL channels, e.g., a DL source reference signal or ports/PGs provides information on the spatial domain filter or port/PG to be used for UL transmissions, or the UL source reference signal or ports/PGs provides the spatial domain filter to be used for UL transmissions, e.g., same spatial domain filter for UL source reference signal and UL transmissions.

The unified (main or indicated) TCI state applies at least to UE dedicated DL and UL channels. The unified (main or indicated) TCI can also apply to other DL and/or UL channels and/or signals e.g. non-UE dedicated channel and sounding reference signal (SRS).

A UE is indicated a TCI state by MAC CE when the MAC CE activates one TCI state code point. The UE applies the TCI state code point after a beam application time from the corresponding HARQ-ACK feedback. A UE is indicated a TCI state by a DL related DCI format (e.g., DCI Format 1_1, or DCI format 1_2) or an UL related DCI format (e.g. format 0_1 or 0_2) or purpose design channel or DCI Format for TCI state indication or beam indication, wherein the DCI format includes a “transmission configuration indication” field that includes/indicates a TCI state code point out of the TCI state code points activated by a MAC CE. A DL related DCI format (or an UL related DCI format or purpose design channel or DCI Format for TCI state indication) can be used to indicate a TCI state when the UE is activated with more than one TCI state code points. The DL related DCI format can be with a DL assignment for PDSCH reception or without an DL assignment. Likewise, the UL related DCI format can be with a UL grant for PUSCH transmission or without an UL grant. A TCI state can also be indicated in a purpose designed channel or DCI Format for TCI state indication. A TCI state (TCI state code point) indicated/included in a DL related DCI format or UL related DCI format or purpose design channel or DCI Format for TCI state indication is applied after a beam application time from the corresponding HARQ-ACK feedback.

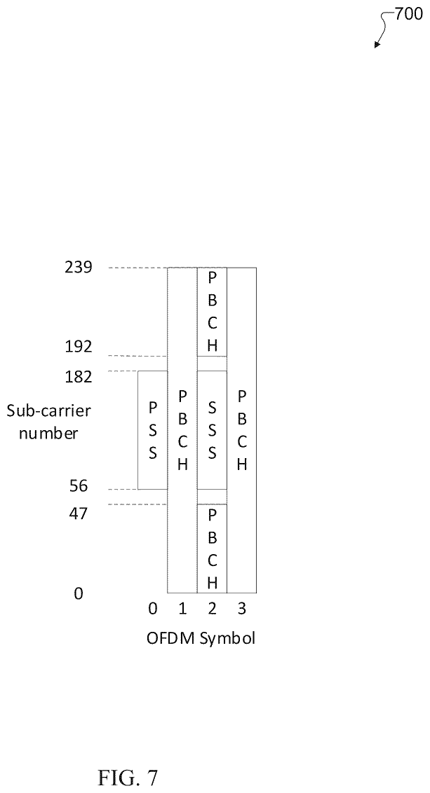

FIG. 7 illustrates an example SSB block 700 according to embodiments of the present disclosure. The example SSB block 700 shown in FIG. 7 is for illustration only and other embodiments can be used without departing from the scope of the present disclosure.

In NR/5G, a geographical area served by the network can be partitioned into cells as aforementioned. For example, a cell can be associated with a synchronization signal, physical broadcast channel (PBCH) block (SS/PBCH block). Within a cell, other common channels and/or signals can be transmitted to users in the cell. In another example, a cell is served by one or more TRPs or by one or more RUs.

In NR/5G, a UE performs the cell search procedure to acquire time and frequency synchronization within a cell and to detect the physical layer Cell ID (PCI) of the cell. To perform cell search, the UE receives the following signals and channel: (1) the primary synchronization signal (PSS), (2) the secondary synchronization signal (SSS) and (3) the physical broadcast channel (PBCH). A PSS/SSS/PBCH block (SS/PBCH block) is referred to as SSB and consists of 4 consecutive symbols, and 20 resource blocks (RBs) (240 subcarriers), as illustrated in FIG. 7.

SSBs are organized in groups or bursts of up to N SSBs, transmitted within half a frame, each SSB within the group or burst has an index i, where i=0, 1, . . . , N−1, within each group or burst of SSBs, the SSBs are time-division multiplexed and arranged in increasing order of i, with increasing time. For carrier frequencies less than or equal to 3 GHz, N=4. For carrier frequencies in FR1 that are larger than 3 GHz, N=8. For carrier frequencies in FR2, N=64. The SSB indices actually transmitted are provided by ssb-PositionsInBurst in system information block one (SIB1) or in ServingCellConfigCommon or in SSB-MTC-AdditionalPCI or in LTM-SSB-Config.

SSBs are transmitted periodically, wherein the allowed periodicities are {5, 10, 20, 40, 80, 160}ms. In addition to cell search, SSBs can also be used for beam management related procedures, such as new beam acquisition, beam measurements, and beam failure detection and recovery. Each SSB with index i can be associated with a spatial domain filter (or beam).

NR introduced a physical random access channel (PRACH) to be used, among other cases, when the UE wants to communicate with the network and doesn't have uplink resources. For example, the physical random access channel can be used during initial access. The PRACH consists of a preamble format comprising one or more preamble sequences transmitted in a PRACH Occasion (RO).

NR supports four different preamble sequence lengths:
Sequence length 839 used with sub-carrier spacings 1.25 kHz and 5 kHz with unrestricted or restricted sets.
Sequence length 139 used with sub-carrier spacings 15 kHz, 30 kHz, 60 kHz and 120 kHz with unrestricted sets.
Sequence length 571 used with sub-carrier spacing 30 kHz with unrestricted sets.
Sequence length 1151 used with sub-carrier spacing 15 kHz with unrestricted sets.

RACH preambles are transmitted in time-frequency resources PRACH Occasions (ROs). Each RO determines the time and frequency resources in which a preamble is transmitted, the resources allocated to an RO in the frequency domain (e.g., number of RBs) and the resource allocated to an RO in the time domain (e.g., number of OFDMA symbols or number of slots), depend on the preamble sequence length, sub-carrier spacing of the preamble, sub-carrier spacing of the PUSCH in the UL BWP, and the preamble format. Multiple PRACH Occasions can be FDMed in one-time instance. This is indicated by higher layer parameter msg1-FDM. The time instances of the PRACH Occasions are determined by the higher layer parameter prach-Configurationlndex, and Tables 6.3.3.2-2, 6.3.3.2-3, and 6.3.3.2-4 of TS 38.211 v18.1.0.

SSBs are associated with ROs. The number of SSBs associated with one RO can be indicated by higher layer parameters such as ssb-perRACH-OccasionAndCB-PreamblesPerSSB and ssb-perRACH-Occasion. The number of SSBs per RO can be {⅛, ¼, ½, 1, 2, 4, 8, 16}. When the number of SSBs per RO is less than 1, multiple ROs are associated with the same SSB index. SS/PBCH block indexes provided by ssb-PositionslnBurst in SIB1 or in ServingCellConfigCommon or in SSB-MTC-AdditionalPCI or in LTM-SSB-Config are mapped to valid PRACH occasions in the following order [38.213 v18.1.0]:
First, in increasing order of preamble indexes within a single PRACH occasion.
Second, in increasing order of frequency resource indexes for frequency multiplexed PRACH occasions.
Third, in increasing order of time resource indexes for time multiplexed PRACH occasions within a PRACH slot.
Fourth, in increasing order of indexes for PRACH slots.

The association period starts from frame 0 for mapping SS/PBCH block indexes to PRACH Occasions.

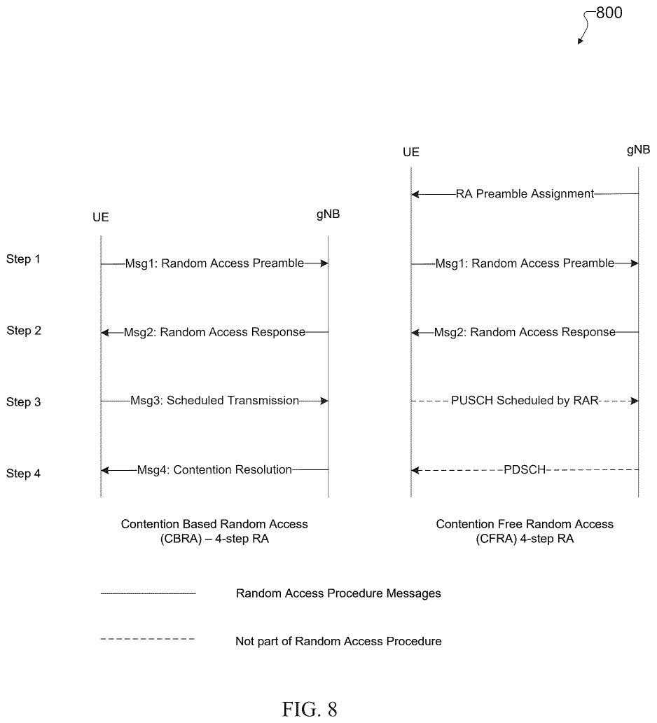

FIG. 8 illustrates an example type-1 random access procedure 800 according to embodiments of the present disclosure. The example type-1 random access procedure 800 shown in FIG. 8 is for illustration only and other embodiments can be used without departing from the scope of the present disclosure.

A random access procedure can be initiated by a PDCCH order, by the MAC entity, or by RRC.

There are two types of random access procedures, type-I random access procedure and type-2 random access procedure.

Type-1 random access procedure also known as four-step random access procedure (4-step RACH), is as illustrated in FIG. 8;
In step 1, the UE transmits a random access preamble, also known as Msg1, to the gNB. The gNB attempts to receive and detect the preamble.
In step 2, the gNB upon receiving the preamble transmits a random access response (RAR), also known as Msg2, to the UE including, among other fields, a time adjustment (TA) command and a RAR uplink grant for a subsequent PUSCH transmission.
In step 3, the UE after receiving the RAR, transmits a PUSCH transmission scheduled by the grant included in the RAR and time adjusted according to the TA received in the RAR. Msg3 or the PUSCH scheduled by the RAR UL grant can include the RRC setup request message.
In step 4, the gNB upon receiving the RRC setup request message, allocates downlink and uplink resources that are transmitted in a downlink PDSCH transmission to the UE.

After the last step, the UE can proceed with reception and transmission of data traffic.

A type-1 random access procedure (4-step RACH) can be contention based random access (CBRA) or contention free random access (CFRA). The CFRA procedure ends after the random access response, the following messages are not part of the random access procedure. For CFRA, in step 0, the gNB indicates to the UE the preamble to use.

In this disclosure Msg1, preamble and PRACH are used inter-changeably for random access preamble.

In this disclosure Msg2 and RAR are used inter-changeably for random access response.

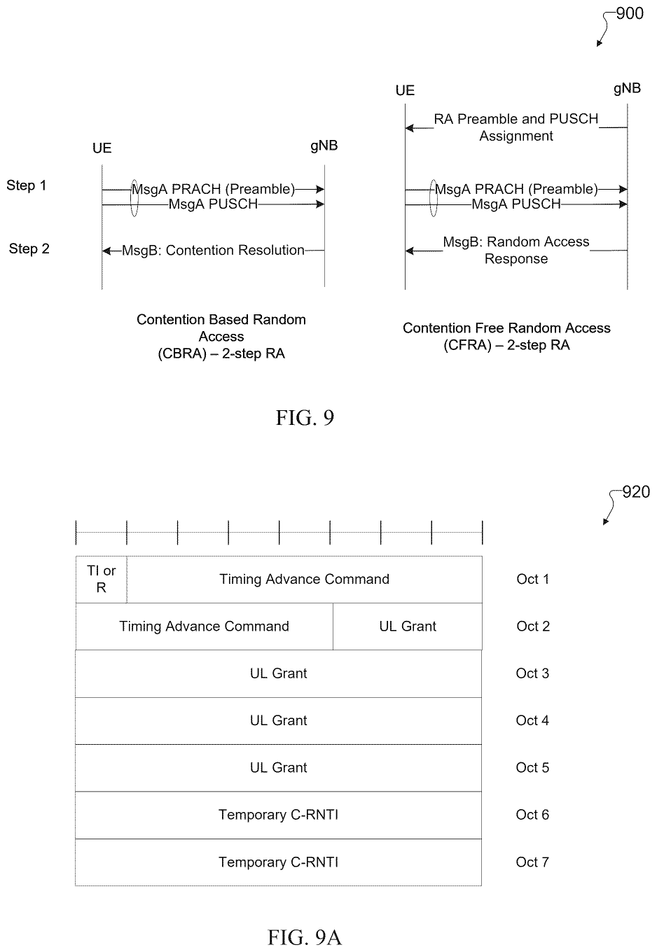

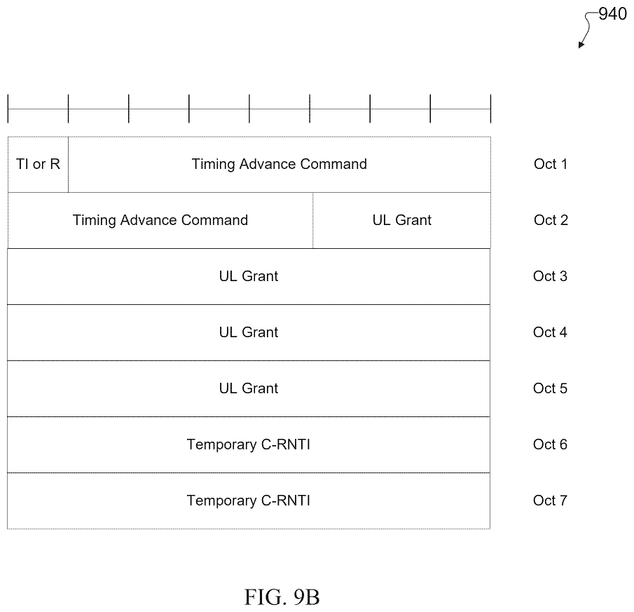

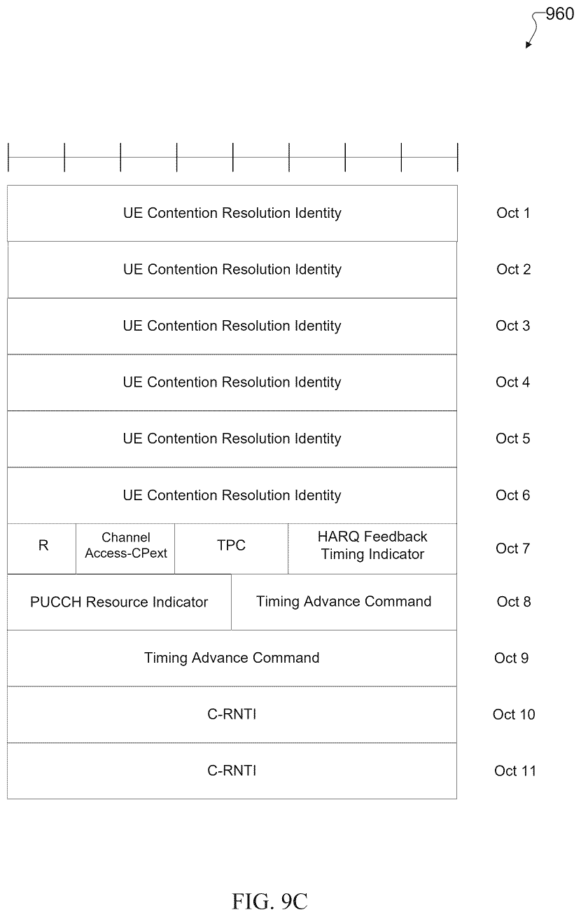

FIG. 9 illustrates an example type-2 random access procedure 900 according to embodiments of the present disclosure. The example type-2 random access procedure 900 shown in FIG. 9 is for illustration only and other embodiments can be used without departing from the scope of the present disclosure.

Rel-16, introduced a new random access procedure; Type-2 random access procedure, also known as 2-step random access procedure (2-step RACH), is as illustrated in FIG. 9, that combines the preamble and PUSCH transmission into a single transmission from the UE to the gNB, which is known as MsgA. Similarly, the RAR and the PDSCH transmission (e.g. Msg4) are combined into a single downlink transmission from the gNB to the UE, which is known as MsgB.

A random access procedure can be triggered for initial access from the RRC_IDLE state. During this procedure, a UE identifies an SS/PBCH block with index i and with an RSRP that exceeds a threshold. The RSRP threshold for SSB selection for RACH resource association is indicated by the network. The UE selects a RO and a preamble within the RO associated with SS/PBCH block index i. The UE transmits a PRACH using the selected RO/preamble. The UE monitors and receives the random access response (RAR), by attempting to detect a DCI format 1_0 with CRC scrambled by a corresponding RA-RNTI during a window controlled by higher layers. If the UE does not detect the DCI format 1_0 with CRC scrambled by the corresponding RA-RNTI within the RAR window, the UE may retransmit PRACH. If the UE detects the DCI format 1_0 with CRC scrambled by the corresponding RA-RNTI, the UE receives a RAR UL grant for the scheduling of a PUSCH. The UE transmits the PUSCH according to the RAR UL grant. In response to the PUSCH transmission scheduled by a RAR UL grant, when a UE has not been provided a C-RNTI, the UE attempts to detect a DCI format 1_0 with CRC scrambled by a corresponding TC-RNTI scheduling a PDSCH that includes a UE contention resolution identity. The spatial domain filters (beams) identified during initial access, are used for subsequent transmissions and receptions to/from the UE until a single TCI state is configured or activated or indicated to the UE. For downlink receptions when a UE does not have the TCI state, the spatial domain filter is that associated with the SS/PBCH block index identified during initial access. For uplink transmissions when a UE does not have the TCI state, the spatial domain filter is that used for PUSCH scheduled by the RAR UL grant.

FIG. 9A illustrates an example MAC RAR 920 (for type-1 random access procedure) according to embodiments of the present disclosure. The example MAC RAR 920 shown in FIG. 9A is for illustration only and other embodiments can be used without departing from the scope of the present disclosure.

The MAC RAR (for Type 1 random access procedure) includes the 12-bit Timing Advance command as illustrated in FIG. 9A (TS 38.321 FIG. 6.2.3-1), where,
R: Reserved bit, set to 0
TI: If two TAGs are configured for the Serving Cell in which the Random Access procedure is being performed, this field indicates one of the two TAGs to which the Timing Advance Command is applied

FIG. 9B illustrates an example fallback RAR 940 (for type-2 random access procedure) according to embodiments of the present disclosure. The example fallback RAR 940 shown in FIG. 9B is for illustration only and other embodiments can be used without departing from the scope of the present disclosure.

The fallback RAR (for Type 2 random access procedure), which is used when MSGA PRACH is successfully received but MSGA PUSCH is not decoded correctly, includes the 12-bit Timing Advance command as illustrated in FIG. 9B (38.321 FIG. 6.2.3a-1), where,
R: Reserved bit, set to 0
TI: If two TAGs are configured for the SpCell, this field indicates one of the two TAGs to which the Timing Advance Command is applied

FIG. 9C illustrates an example success RAR 960 (for type-2 random access procedure) according to embodiments of the present disclosure. The example success RAR 960 shown in FIG. 9C is for illustration only and other embodiments can be used without departing from the scope of the present disclosure.

The success RAR (for Type 2 random access procedure), which is used when MSGA PRACH is successfully received and MSGA PUSCH is decoded correctly, includes the 12-bit Timing Advance command as illustrated in FIG. 9C (38.321 FIG. 6.2.3a-2).

In one example, the UL grant in the MAC RAR or fallbackRAR is given by Table 1:

TABLE 1

| RAR grant field | Number of bits |
|---|---|
| Frequency hopping flag | 1 |
| PUSCH frequency resource | 12, for operation with shared |
| allocation | spectrum channel access |
| | in FR1 or for FR2-2 when |
| | ChannelAccessMode2-r17 |
| | is provided |
| | 14, otherwise |
| PUSCH time resource allocation | 4 |
| MCS | 4 |
| TPC command for PUSCH | 3 |
| CSI request | 1 |
| ChannelAccess-CPext | 2, for operation with shared |
| | spectrum channel access |
| | in FR1 or for FR2-2 when |
| | ChannelAccessMode2-r17 |
| | is provided |
| | 0, otherwise |

Sounding reference signal (SRS) is an uplink reference signal that is used for sounding (i.e., channel state or quality estimation) the UL channel between the UE and the gNB. In case of reciprocity between UL and DL, the channel sounding of the UL channel can also be used for link adaptation and precoding on the DL channel from the gNB to the UE. SRS is transmitted independent of data transmissions on the UL. The SRS usage can be one of: beamManagement, codebook, nonCodebook, antennaSwitching, this is in addition to SRS for positioning.

In NR, SRS resources are configured by the network for example as part of RRC setup or RRC reconfiguration. SRS resources are configured in SRS resource sets. An SRS resource set includes a set of SRS resources, and defines the following parameters: (1) resourceType, which determines the time domain behavior of SRS, SRS can be aperiodic, semi-persistent or periodic. (2) usage, which can be one of: beamManagement, codebook, nonCodebook or antennaSwitching. (3) information related to power control and TCI state.

The configuration of the SRS resource includes the following: (1) information related to the transmission comb, including comb size, comb offset and cyclic shift. (2) Information related to time domain resource mapping including starting symbol within a slot, number of SRS symbols and repetition factor. (3) information related to frequency domain including freqDomainPosition N_RRC, freqDomainShift n_shift, and frequency hopping parameters c-SRS, b-SRS, and b-hop. (4) Information related to group or sequence hopping, whether one of them or neither is enabled. (5) for periodic and semi-persistent SRS, the periodicity and offset of the SRS resource. (6) Sequence ID. (7) Information related to the TCI state or spatial relation info.

In 5G NR, a UE can transmit a sounding reference signal (SRS). A SRS resource is configured by higher layer IE SRS-Resource.

The SRS sequence is a low PAPR sequence of length

$${N}_{ZC} = {M}_{sc , b}^{SRS}$$

given by:

$${r}^{( p )} ( n , {l}^{′} ) = {r}_{u , v}^{( α , δ )} ( n ) = {e}^{j α n} {\overline{r}}_{u , v} ( n ) , 0 \leq n < {M}_{ZC}$$

where

$${M}_{ZC} = {mN}_{sc}^{RB} / {2}^{δ} , δ = log ( {K}_{TC} ) ,$$

with K_{TC}, being the transmission comb number, is provided in higher layer IE transmissionComb, K_{TC}∈{2,4,8}. l′ is the SRS symbol within a SRS resource of a slot,

$${l}^{′} ∈ \{ 0 , 1 , … , {N}_{symb}^{SRS} - 1 \} , {N}_{symb}^{SRS}$$

is the number of SRS symbols in a slot. The cyclic shift αᵢ for antenna port pᵢ is given by

$${α}_{i} = 2 π \frac{{n}_{SRS}^{cs , i}}{{n}_{SRS}^{cs , max}} , and {n}_{SRS}^{cs , i} = ( {n}_{SRS}^{cs} + \frac{{n}_{SRS}^{cs , max} ( {p}_{i} - 1000 )}{{N}_{ap}^{SRS}} ) mod {n}_{SRS}^{cs , max}$$

with

$${n}_{SRS}^{cs}$$

being provided by higher layer in IE transmissionComb,

$${n}_{SRS}^{cs , max}$$

depends on K_{TC} as illustrated in Table 2.

TABLE 2

| K_{TC} | ${n}_{SRS}^{cs , max}$ |
|---|---|
| 2 | 8 |
| 4 | 12 |
| 8 | 6 |

u is the group number u∈{0, 1, . . . , 29}, v is the base sequence number, with v∈{0}, if 6≤N_{ZC}≤60 and v∈{0,1}, if 60<N_{ZC}. The base sequence, r̅_{u,v}(n), is generated as follows:
1. For N_{ZC}∈{6,12,18,24}, r̅_{u,v}(n)=e^{jφ(n)π/4}, with 0≤n<M_{ZC}−1. φ(n) is given by Tables 5.2.2.2-1 to 5.2.2.2-4 of TS 38.211.
2. For

$${N}_{ZC} = 30 , {\overline{r}}_{u , v} ( n ) = {e}^{- j \frac{π ( u + 1 ) ( n + 1 ) ( n + 2 )}{31}} ,$$

with 0≤n<M_{ZC}−1.
3. For N_{ZC}≥30, r̅_{u,v}(n)=x_{q}(n mod N_{ZC}),

$${x}_{q} ( n ) = {e}^{- j \frac{π q m ( m + 1 )}{{N}_{ZC}}} .$$

N_{ZC} is the largest prime number less than

$${M}_{ZC} \cdot q = ⌊ \overline{q} + 1 / 2 ⌋ + v \cdot {( - 1 )}^{⌊ 2 \overline{q} ⌋} \cdot \overline{q} = {N}_{ZC} \frac{u + 1}{31} .$$

The sequence group u is given by:

$$u = ( {f}_{gh} ( {n}_{s , f}^{μ} , {l}^{′} ) + {n}_{ID}^{SRS} ) .$$

### Where,

$${n}_{ID}^{SRS}$$

is provided by higher layer parameter sequenceID, with

$${n}_{ID}^{SRS} ∈ \{ 0 , 1 , … , 65535 \} .$$

Higher layer parameter groupOrSequenceHopping determines the values of u and v:
if groupOrSequenceHopping equals ‘neither’, neither group, nor sequence hopping shall be used and

$${f}_{gh} ( {n}_{s , f}^{μ} , {l}^{′} ) = 0 ,$$

and v=0.
if groupOrSequenceHopping equals ‘groupHopping’, group hopping but not sequence hopping is used and v=0, and

$${f}_{gh} ( {n}_{s , f}^{μ} , {l}^{′} ) = ( {\sum }_{m = 0}^{7} c ( 8 ( {n}_{s , f}^{μ} {N}_{symb}^{slot} + {l}_{0} + {l}^{′} ) + m ) \cdot {2}^{m} ) mod 30 , {N}_{symb}^{slot}$$

is the number of symbols in a slots, l₀ is the first SRS symbols in the slot, and c(n) a length-31 Gold sequence defined as c(n)=(x₁(n+N_{c})+x₂(n+N_{c})) mod 2, with N_{c}=1600, x₁(n+31)=(x₁(n+3)+x₁(n)) mod 2, x₂(n+31)=(x₂(n+3)+x₂(n+2)+x₂(n+1)+x₂(n)) mod 2, the first m-sequence is initialized with x₁(0)=1, and x₁(n)=0, for n=1,2, . . . 30. The second m-sequence is initialized with cᵢₙᵢₜ, where

$${c}_{init} = {n}_{ID}^{SRS} .$$

if groupOrSequenceHopping equals ‘sequenceHopping’, sequence hopping but not group hopping is used and

$${f}_{gh} ( {n}_{s , f}^{μ} , {l}^{′} ) = 0 and$$

$$v = \{ \begin{matrix}c ( {n}_{s , f}^{μ} {N}_{symb}^{slot} + {l}_{0} + {l}^{′} ) & {M}_{sc , b}^{SRS} \geq 6 {N}_{sc}^{RB} \\ 0 & otherwise\end{matrix}$$

$${N}_{symb}^{slot}$$

is the number of symbols in a slots, l₀ is the first SRS symbol in the slot, and c(n) a length-31 Gold sequence as previously defined.

The SRS sequence, r^{(p)}(n, l′) is mapped to resource element

$${a}_{k , l}^{( p )}$$

within a slot, where k is the sub-carrier frequency, l is the symbol number within the slot and p is the antenna port, where for SRS there is one antenna port, by

$${a}_{k , l}^{( p )} = {β}_{SRS} {r}^{( p )} ( {k}^{′} , {l}^{′} )$$

$$l = {l}^{′} + {l}_{0}$$

### Where,

β_{SRS} is a scaling factor,

$${k}^{′} = 0 , 1 , … , {M}_{sc , b}^{SRS} - 1 , {M}_{sc , b}^{SRS} = {m}_{SRS , b} {N}_{sc}^{RB} / {K}_{TC} ,$$

m_{SRS,b} is provided by Table 6.4.14.3-1 of TS 38.211, and

$${l}^{′} = 0 , 1 , … , {N}_{symb}^{SRS} - 1 .$$

FIG. 10 illustrates an example of configuring the SRS resource 1000 according to embodiments of the present disclosure. The example of configuring the sounding SRS resource 1000 shown in FIG. 10 is for illustration only and other embodiments can be used without departing from the scope of the present disclosure.

The time domain position of SRS symbols l is determined by higher layer parameter startPosition (l₀), and higher layer parameter

$$nrofSymbols ( {N}_{symb}^{SRS} ) . l = {l}^{′} + {l}_{0} ,$$

with l₀ the first SRS symbols in the slot, where l₀ ∈{0,1, . . . ,13}. The repetition factor R provided by higher layer parameter repetitionFactor provides the number of SRS symbols used for each frequency hop within a slot, when frequency hopping is enabled as described later, where

$$R \leq {N}_{symb}^{SRS} .$$

In the example of FIG. 10, l₀=10, i.e., symbol index 10 is the starting symbol of the SRS, there are 4 SRS symbols in the slot

$${N}_{symb}^{SRS} = 4 ,$$

and the repetition factor R=2, where the SRS is transmitted in two consecutive symbols in each frequency hop.

The frequency domain position of SRS sub-carriers k consists of two components, (1) the comb offset, which determines which of the K_{TC} sub-carriers to use for SRS transmission, (2) the SRS RBs used for SRS transmission, which determines the starting RB and the number of RBs for SRS.

The comb offset is determined by higher layer parameter combOffset. The comb offset can also depend on the SRS antenna port, and for SRS for positioning, on the SRS symbol index within the slot as described in the following. In the example of FIG. 10, K_{TC}=4, with a comb offset of 1. The comb offset is the same in each symbol (e.g., SRS for MIMO).

The SRS RBs are determined by following higher layer parameters:
c-SRS (C_{SRS}) in higher layer parameter freqHopping. C_{SRS} selects a bandwidth configuration for the SRS resource, corresponding to a row in Table 6.4.1.4.3-1 of TS 38.211. C_{SRS} is in the range of {0, 1, . . . , 63}. The parameter m_{SRS,0} in the selected row determines the maximum SRS bandwidth that can be sounded as illustrated in FIG. 10.
b-SRS (B_{SRS}) in higher layer parameter freqHopping. B_{SRS} determines the transmission bandwidth of the SRS resource, as illustrated in FIG. 10, based on the selected row of Table 6.4.1.4.3-1 of TS 38.211. B_{SRS} is in the range of {0, 1, 2, 3}, and corresponds to a column in Table 6.4.1.4.3-1 of TS 38.211.
b-hop (bₕₒₚ) in higher layer parameter freqHopping. bₕₒₚ determines the actual SRS bandwidth that is sounded, using multiple frequency hops, as illustrated in FIG. 10, based on the selected row of Table 6.4.1.4.3-1 of TS 38.211. bₕₒₚ is in the range of {0, 1, 2, 3}, and corresponds to a column in Table 6.4.1.4.3-1 of TS 38.211. If bₕₒₚ<B_{SRS}, frequency hopping is enabled. Otherwise, bₕₒₚ≥B_{SRS}, frequency hopping is disabled, and the actual SRS bandwidth that is sounded is determined by b=min(B_{SRS}, bₕₒₚ) based on the selected row of Table 6.4.1.4.3-1 of TS 38.211.
freqDomainShift (n_{shift}), in units of RBs in the range {0,1, . . . 268}, adjust the SRS allocation with respect to a reference point as illustrated in FIG. 10. If

$${N}_{BWP}^{start} \leq {n}_{shift}$$

the reference point for

$${k}_{0}^{( p )}$$

is sub-carrier 0 in common resource block (CRB) 0, otherwise the reference point is the lowest subcarrier of the BWP.
freqDomainPosition (n_{RRC}), in units of four RBs in the range {0,1, . . . 67}, determines the position of the actual SRS bandwidth as illustrated in FIG. 10, based on bₕₒₚ, within the maximum SRS bandwidth, based on m_{SRS,0}.
When SRS frequency hopping enabled, the location of the frequency hop depends on a SRS counter n_{SRS} that counts the number of SRS instances.
   For aperiodic SRS, n_{SRS}=[l′/R].
   For periodic and semi-persistent SRS

$${n}_{srs} = ( \frac{{N}_{slot}^{frame , μ} {n}_{f} + {n}_{s , f}^{μ} - {T}_{offset}}{{T}_{SRS}} ) \cdot ( \frac{{N}_{symb}^{SRS}}{R} ) + ⌊ \frac{{l}^{′}}{R} ⌋$$

For slots that satisfy

$$( {N}_{slot}^{frame , μ} {n}_{f} + {n}_{s , f}^{μ} - {T}_{offset} ) mod {T}_{SRS} = 0 .$$

T_{SRS} is the SRS periodicity, and T_{offset} is the SRS offset.

$$k = {K}_{TC} {k}^{′} + {k}_{0}^{( {p}_{i} )} ,$$

K_{TC} is the transmission comb number as previously described,

$${k}_{0}^{( p )} = {\overline{k}}_{0}^{( p )} + {\sum }_{b = 0}^{{B}_{SRS}} {K}_{TC} {M}_{sc , b}^{SRS} {n}_{b} , ,$$

$${\overline{k}}_{0}^{( {p}_{i} )} = {n}_{shift} {N}_{sc}^{RB} + ( {k}_{TC}^{( {p}_{i} )} + {k}_{offset}^{{l}^{′}} ) mod {k}_{TC}$$

$${k}_{TC}^{( {p}_{i} )} = \{ \begin{matrix}( {\overline{k}}_{TC} + {K}_{TC} / 2 ) mod {K}_{TC} & \begin{matrix}\begin{matrix}if {n}_{SRS}^{cs} ∈ \{ \frac{{n}_{SRS}^{cs , max}}{2} , … , {n}_{SRS}^{cs , max} - 1 \} \\ and {N}_{ap}^{SRS} = 4 and\end{matrix} \\ {p}_{i} ∈ \{ 1001 , 1003 \}\end{matrix} \\ {\overline{k}}_{TC} & otherwise\end{matrix}$$

k̅_{TC} is the transmission comb offset included within higher layer IE transmissionComb, with k̅_{TC} ∈{0,1, . . . , K_{TC}−1},

$${k}_{offset}^{{l}^{′}}$$

is a symbol dependent sub-carrier offset given by Table 3, n_{shift} is given by higher layer parameter freqDomainShift and it adjust the frequency allocation with respect to a reference point. If

$${N}_{BWP}^{start} \leq {n}_{shift}$$

the reference point for

$${k}_{0}^{( p )}$$

is sub-carrier 0 in common resource block 0, otherwise the reference point is the lowest subcarrier of the BWP. n_{b} is a frequency positioning index. n_{b} is a frequency position index. If frequency hopping is disabled (i.e., bₕₒₚ≥B_{SRS} as aforementioned), n_{b} remains constant and is given by:

$${n}_{b} = ⌊ \frac{4 {n}_{RRC}}{{m}_{SRS , b}} ⌋ mod {N}_{b}$$

n_{RRC} is given by higher layer parameterfreqDomainPosition, and m_{SRS,b} and N_{b} are determined by Table 6.4.14.3-1 of TS 38.211 for the configured value of C_{SRS}.

If frequency hopping is enabled (i.e., bₕₒₚ<B_{SRS} as aforementioned), n_{b} depends on the SRS counter (n_{SRS}) and is given by:

$${n}_{b} = \{ ( \begin{matrix}⌊ 4 {n}_{R R C} / {m}_{S R S , b} ⌋ mod {N}_{b} & b \leq {b}_{hop} \\ ( {F}_{b} ( {n}_{S R S} ) + ⌊ 4 {n}_{R R C} / {m}_{S R S b} ⌋ ) mod {N}_{b} & otherwise\end{matrix} )$$

where, F_{b}(n_{SRS}) is given by:

$${F}_{b} ( {n}_{S R S} ) = \{ \begin{matrix}\begin{matrix}( {N}_{b} / 2 ) ⌊ \frac{{n}_{SRS} mod {\prod }_{{b}^{′} = {b}_{hop}}^{b} {N}_{{b}^{′}}}{{\prod }_{{b}^{′} = {b}_{hop}}^{b - 1} {N}_{{b}^{′}}} ⌋ + \\ ⌊ \frac{{n}_{SRS} mod {\prod }_{{b}^{′} = {b}_{hop}}^{b} {N}_{{b}^{′}}}{2 {\prod }_{{b}^{′} = {b}_{hop}}^{b - 1} {N}_{{b}^{′}}} ⌋\end{matrix} & if {N}_{b} is even \\ ⌊ {N}_{b} / 2 ⌋ ⌊ {n}_{SRS} / {\prod }_{{b}^{′} = {b}_{hop}}^{b - 1} {N}_{{b}^{′}} ⌋ & if {N}_{b} is odd\end{matrix}$$

and where N_{b}_{ₕₒₚ}=1 regardless of the values of N_{b}

TABLE 3

| | ${k}_{offset}^{0} , {k}_{offset}^{1} , … , {k}_{offset}^{{N}_{symb}^{SRS} - 1}$ | | | | |
|---|---|---|---|---|---|
| K_{TC} | ${N}_{symb}^{SRS} = 1$ | ${N}_{symb}^{SRS} = 2$ | ${N}_{s ymb}^{SRS} = 4$ | ${N}_{symb}^{SRS} = 8$ | ${N}_{symb}^{SRS} = 12$ |
| 2 | 0 | 0, 1 | 0, 1, 0, 1 | — | — |
| 4 | — | 0, 2 | 0, 2, 1, 3 | 0, 2, 1, 3, 0, 2, 1, 3 | 0, 2, 1, 3, 0, 2, 1, 3, 0, 2, 1, 3 |
| 8 | — | — | 0, 4, 2, 6 | 0, 4, 2, 6, 1, 5, 3, 7 | 0, 4, 2, 6, 1, 5, 3, 7, 0, 4, 2, 6 |

The SRS resource can be configured as periodic, semi-persistent or aperiodic using higher layer parameter resourceType. For periodic and semi-persistent resources, a periodicity, T_{SRS}, and a slot offset, O, within the periodicity are configured. The allowed values of the periodicity in slots are:

$${T}_{S R S} ∈ \{ 1 , 2 , 4 , 5 , 8 , 10 , 16 , 20 , 32 , 40 , 64 , 80 , 160 , 320 , 640 , 1280 , 2560 \}$$

Every T_{SRS} slots is a candidate SRS slot. The offset O is with respect to slot 0 of frame 0, the allowed values of offset O where O∈{0,1, . . . , T_{SRS}−1}. Candidate SRS slots are slots satisfying;

$$( {N}_{slot}^{frame , μ} {n}_{f} + {n}_{s , f}^{μ} - {T}_{offset} ) mod {T}_{S R S} = 0 .$$

Periodic SRS resources are transmitted in slots determined by the periodicity and offset once the UE receives and processes the RRC configuration message. While semi-persistent SRS resources are activated by a MAC CE activation message, and can be deactivated by a MAC CE deactivation message,

Aperiodic SRS resources are triggered by a DCI command. The UE transmits the SRS in a slot with a configured offset from the slot of the DCI command. The offset can be a value between 1 to 32 slots, where for slot offset 1, the SRS slot is the slot after the slot containing the DCI trigger.

In NR paging is used to alert idle and inactive UEs of incoming calls, messages and data. Paging is used to trigger RRC setup (e.g., RRC setup request or RRC connection resumption).

Paging is transmitted over the paging channel (PCH). The paging message includes a paging record list, which is a list of UEs being paged, each identified by a TMSI or an I-RNTI. The 5G S-Temporary Mobile Subscription Identifier (5G-S-TMSI), a temporary UE identity provided by the 5GC which uniquely identifies the UE within the tracking area. The I-RNTI is used to identify the suspended UE context of a UE in RRC_INACTIVE.

The following messages describe the contents of a paging message:

| | |
|---|---|
| PCCH-Message ::= | SEQUENCE { |
| message | PCCH-Message Type |
| } | |
| PCCH-Message Type ::= | CHOICE { |

c1 CHOICE {

| paging | Paging, | |
|---|---|---|
| spare1 NULL | | |
| }, | | |
| messageClassExtension | SEQUENCE { } | |
| } | | |
| Paging ::= | SEQUENCE { | |
| pagingRecordList | PagingRecordList | OPTIONAL, - |
| - Need N | | |
| lateNonCriticalExtension | OCTET STRING | |
| OPTIONAL, | | |
| nonCriticalExtension | Paging-v1700-IEs | OPTIONAL |

| | |
|---|---|
| } | |
| PagingRecordList ::= | SEQUENCE (SIZE(1..maxNrofPageRec)) OF PagingRecord |
| PagingRecord ::= | SEQUENCE { |
| ue-Identity | PagingUE-Identity, |
| access Type | ENUMERATED {non3GPP} OPTIONAL, -- Need N |
| . . . | |
| } | |
| PagingUE-Identity ::= | CHOICE { |
| ng-5G-S-TMSI | NG-5G-S-TMSI, |
| fullI-RNTI | I-RNTI-Value, |
| . . . | |
| } | |
| NG-5G-S-TMSI ::= | BIT STRING (SIZE (48)) |
| I-RNTI-Value ::= | BIT STRING (SIZE(40)) |

A UE may use Discontinuous Reception (DRX) in RRC_IDLE and RRC_INACTIVE state in order to reduce power consumption. The UE monitors one paging occasion (PO) per DRX cycle, T. Where, a PO is a set of PDCCH monitoring occasions and can consist of multiple time slots where paging DCI can be sent. A Paging Frame (PF) is one Radio Frame and may contain one or multiple PO(s) or starting point of a PO.

The PF and PO for paging are determined by the following equations:
SFN of the PF is determined by: (SFN+PF_offset) mod T=(T div N)*(UE_ID mod N)
The index i_s of the PO is determined by: i_s=floor (UE_ID/N) mod Ns

### Where,

T is the DRX cycle of the UE, determined by the shortest of the UE specific DRX value(s) and a default DRX value included in SIB1. (1) For CN-initiated paging, a default cycle is broadcast in system information. (2) For CN-initiated paging, a UE specific cycle can be configured via NAS signaling. (3) For RAN-initiated paging, a UE-specific cycle is configured via RRC signaling. A UE in RRC_IDLE uses the shortest of (1) and (2). A UE in RRC_INACTIVE uses the shortest of (1), (2) and (3).
N is a number of total paging frames in T, provided by nAndPagingFrameOffset in SIB1.
Ns is a number of paging occasions for a PF, provided by ns in SIB1
PF_offset is an offset used for PF determination, provided by nAndPagingFrameOffset in SIB1.
UE_ID: 5G-S-TMSI mod 1024

To minimize the probability of paging false alarms, which occur when a UE decodes the PCH due to another UE assigned to the same PO being paged, UEs assigned to the same PO are divided into sub-groups, a DCI carrying a paging early indication (PEI) is transmitted before the corresponding PO to indicate the sub-groups with paging messages in the PO. A UE that is not in the indicated sub-groups indicated by the PEI doesn't decode the corresponding PO. There can be up to 8 sub-groups. The subgroups can be CN controlled sub-groups (determined by the access and mobility function (AMF)), and/or UE-ID based sub-groups.

DCI format 2_7 is used for notifying the paging early indication and TRS availability indication for one or more UEs. DCI Format 2_7 has a CRC scrambled by PEI RNTI. DCI Format 2_7 includes: (1) a paging indication field of size

$${N}_{P O}^{PEI} \cdot {N}_{S G}^{P O} ,$$

where,

$${N}_{P O}^{PEI}$$

is the number of paging occasions configured by higher layer parameter po-NumPerPEI, and

$${N}_{S G}^{P O}$$

is the number of sub-groups of a paging occasion configured by higher layer parameter subgroupsNumPerPO. Each bit in the field indicates one UE subgroup of a paging occasion. (2) TRS availability indication, which can be of size 1-6 bits, where the number of bits is equal to one plus the highest value of all the indBitID(s) provided by the trs-ResourceSetConfig if configured; 0 bits otherwise. Each TRS resource set is configured with an ID i for the association with (i+1)-th indication bit.

This disclosure provides for early triggering of SRS for UEs in RRC_IDLE or RRC_INACTIVE states when the network has data to send to the UE or the UE has data send to network. Early SRS transmission can assist in determining the channel conditions and better link adaptation and better precoding for downlink and uplink transmissions. This disclosure provides for the timing of SRS transmission triggered in a random access (RA) procedure or triggered by a DCI Format after a RA procedure.

Embodiments of the present disclosure recognize that when a UE is in RRC_IDLE state or RRC_INACTIVE state, and data arrives at the network for the UE, or data arrives at the UE for the network, the UE through RRC setup procedure or RRC reconfiguration procedure transitions to the RRC_CONNECTED state. After transition to the RRC_CONNECTED state the network can trigger SRS transmission from the UE for channel quality estimation and the UE can start transmitting and receiving data. The SRS triggered can be wideband SRS or sub-band SRS, which would require several SRS transmission instances to provide an estimate of the channel quality of the full bandwidth. This process, i.e., the estimation of the channel quality, can take tens of milli-seconds, and even longer with sub-band SRS. Data transmission/reception can be delayed until the channel quality has been estimated using SRS, hence increasing latency. Alternatively, data transmission/reception can proceed in parallel with the SRS transmission and by the time the channel quality is estimated, the data (depending on the amount of data) has already or mostly been transmitted or received, hence rendering the channel quality estimation less useful while preceding transmissions/receptions from/to the UE are with reduced spectral efficiency due to the absence of a channel estimate at the gNB for the UE.

To mitigate this issue, it is beneficial to have the channel quality estimated in parallel with the RRC setup procedure, or RRC reconfiguration procedure such that when the UE is ready to transmit or receive data at the completion of the setup or reconfiguration procedures, the channel quality has already been estimated and link adaptation and precoding for uplink or downlink data is based on the estimated channel quality. Hence, there is a benefit for transmitting SRS in parallel with RRC setup procedure, or RRC reconfiguration procedure to reduce latency.

When the network initiates a communication session, the UE is first paged, and this is then followed by a random access (RA) or also referred to as RACH procedure. When the UE initiates a communication session, a RACH procedure is used. This disclosure also provides for signalling and methods for triggering SRS during a RACH procedure or associated with a RACH procedure. In one example, SRS can be triggered using a message separate from the RACH procedure messages. In another example, SRS can be triggered using a RACH procedure message, e.g., SRS can be triggered within RACH msg2 (RAR), or RACH msg4 (e.g., PDSCH message for contention resolution, e.g., containing contention resolution identity) for type-1 random access procedure, or RACH msgB for type-2 random access procedure. In one example, SRS can be triggered using a DCI or MAC CE, after the RACH procedure messages. SRS transmission can be separate from the RACH procedure messages or can be transmitted in conjunction with the RACH procedure messages. In one example, the UE capability to support early SRS and/or SRS antenna switching capability can be indicated to the network in the RACH procedure messages (e.g., in Msg1, Msg3, or MsgA (in the PRACH part of MsgA and/or PUSCH part of MsgA). In one example, a UE context is stored in the network (e.g., when the UE is in the RRC_INACTIVE state), the UE context contains the UE capability to support early SRS and/or SRS antenna switching capability, when the network associates the UE triggering the random access procedure with the UE context, the network can determine the UE capability. The network can trigger the early SRS transmission in the RA procedure, e.g., Msg2 or Msg4 or MsgB, or in a DCI Format transmitted after the RA procedure. The early SRS trigger can indicate the timing of the SRS transmission.

The present disclosure relates to a 5G/NR and/or 6G communication system.

This disclosure provides aspects related to design of early triggering of SRS for UEs in RRC_IDLE and RRC_INACTIVE states. This disclosure includes the following:
Trigger of SRS in the RA procedure, e.g., Msg2 or Msg4 or MsgB, with a time offset indicating when the early SRS will be transmitted.
Configuration of a UE in the RA procedure, e.g., Msg2 or Msg4 or MsgB, to monitor a DCI Format for triggering early SRS.
DCI Format can be UE specific DCI Format and UE-group common DCI Format.
Timing of early SRS transmission.
Configuration and indication of SRS resource for early SRS in RA procedure messages or in DCI Format triggering early SRS.

In the following, both FDD and TDD are considered as a duplex method for DL and UL signaling. In addition, full duplex (XDD) operation is possible, e.g., sub-band full duplex (SBFD) or single frequency full duplex (SFFD).

Although exemplary descriptions and embodiments to follow assume orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure provides for several components that can be used in conjunction or in combination with one another, or can operate as standalone schemes.

In this disclosure, RRC signaling (e.g., configuration by RRC signaling) includes (1) common information provided by common signaling, e.g., this can be system information block (SIB)-based RRC signaling (e.g., SIB1 or other SIB) or (2) RRC dedicated signaling that is sent to a specific UE wherein the information can be common/cell-specific information or dedicated/UE-specific information or (3) UE-group RRC signaling.

In this disclosure MAC CE signaling can be UE-specific e.g., to one UE or can be UE common (e.g., to a group of UEs or to all UEs in a cell). MAC CE signaling can be DL MAC CE signaling or UL MAC CE signaling.

In this disclosure L1 control signaling includes: (1) DL control information (e.g., DCI on PDCCH and/or DL control information on PDSCH), DCI can be one stage/part DCI or two-stage/part DCI and/or (2) UL control information (e.g., UCI on PUCCH or PUSCH). L1 control signaling be UE-specific e.g., to one UE and can be UE common (e.g., for a group of UEs or for all UEs in a cell).

In this disclosure, configuration can refer to configuration by semi-static signaling (e.g., RRC or SIB signaling). In one example, a configuration can be applicable to multiple transmission instances, until a configuration is received and applied.

In this disclosure, indication can refer to indication by dynamic signaling (e.g., L1 control (e.g., DCI Format) or MAC CE signaling). In one example, an indication can be for an associated occasion(s) (e.g., an occasion or multiple occasions associated with the indication).

In this disclosure a list with N elements can be denoted as L (i), where i can take N values, and L(i) can correspond to the element associated with index i. In one example, i can take N arbitrary values. In one example, i=0, 1, . . . , N−1. In one example, i=1, 2, . . . , N. In one example, i is an identity of an element in the list.

In the present disclosure, the term “activation” describes an operation wherein a UE receives and decodes first information provided by a first signal from the network (or gNB) and, based on the first information, the UE determines a starting point in time. The starting point can be a present or a future slot/subframe or symbol and the exact location is either implicitly or explicitly indicated, or is otherwise defined in the system operation or is configured by higher layers. Upon successfully decoding the first information, the UE responds according to an indication provided by the first information. The term “deactivation” describes an operation wherein a UE receives and decodes second information provided by a second signal from the network (or gNB) and, based on the second information from the signal, the UE determines a stopping point in time. The stopping point can be a present or a future slot/subframe or symbol and the exact location is either implicitly or explicitly indicated, or is otherwise defined in the system operation or is configured by higher layers. Upon successfully decoding the second information, the UE responds according to an indication provided by the second information. The first signal can be same as the second signal or the first information can be same as the second information, wherein a first part of the information can be associated with an “activation” operation and with first UEs or with first parameters for transmissions/receptions by a UE, and a second part of the information can be associated with a “deactivation” operation and with second UEs or with second parameters for transmissions/receptions by the UE. For example, the second information can be absent, and deactivation can be implicitly derived. For example, when a UE has received an activation information in a previous indication, and is not included among UEs with activation information in a next indication, the UE can determine the latter indication as an implicit deactivation indication.

In this disclosure, a time unit, for example, can be a symbol or a slot or sub-frame or a frame. In one example, a time-unit can be multiple symbols, or multiple slots or multiple sub-frames or multiple frames. In one example, a time-unit can be a sub-slot (e.g., part of a slot). In one example, a time-unit can be specified in units of time, e.g., microseconds, or milliseconds or seconds, etc.

In this disclosure, a frequency-unit, for example, can be a sub-carrier or a resource block (RB) or a sub-channel, wherein a sub-channel is a group or RBs, or a bandwidth part (BWP). In one example, a frequency-unit can be multiple sub-carriers, or multiple RBs or multiple sub-channels. In one example, a frequency-unit can be a sub-RB (e.g., part of a RB). A frequency-unit can be specified in units of frequency, e.g., Hz, or kHz or MHz, etc.

In this disclosure Msg5 refers to the message transmitted by the UE in response to Msg4. For example, Msg5 can be connection setup complete or resume complete.

Terminology such as TCI, TCI states, SpatialRelationlnfo, target RS, reference RS, Msg1, Msg2, Msg3, Msg4, Msg5, MsgA, MsgB and other terms is used for illustrative purposes and is therefore not normative. Other terms that refer to same functions can also be used.

A “reference RS” (e.g., reference source RS) corresponds to a set of characteristics of a DL beam or an UL TX beam, such as a direction, a precoding/beamforming, a number of ports, and so on. For instance, the UE can receive a source RS index/ID in a TCI state assigned to (or associated with) a DL transmission (and/or UL transmission), the UE applies the known characteristics of the source RS to the assigned DL transmission (and/or UL transmission). The source RS can be received and measured by the UE (in this case, the source RS is a downlink measurement signal such as NZP CSI-RS and/or SSB) with the result of the measurement used for calculating a beam report (e.g., including at least one L1-RSRP/L1-SINR accompanied by at least one CRI or SSBRI). As the NW/gNB receives the beam report, the NW can be better equipped with information to assign a particular DL (and/or UL) TX beam to the UE. Optionally or alternatively, the source RS can be transmitted by the UE (in this case, the source RS is an uplink measurement signal such as SRS). As the NW/gNB receives the source RS, the NW/gNB can measure and calculate the needed information to assign a particular DL (or/and UL) TX beam to the UE, for example in case of channel reciprocity.

In this disclosure, DCI Format is used for L1 control information in the DL direction from gNB to UE. DCI Format (i.e., L1 control information) can be single stage/part control information or two stage/part control information. In one example, the DCI format can be carried on a physical downlink control channel (PDCCH). In one example, DCI format can be carried on a physical downlink shared channel (PDSCH). In one example, DCI can be split between PDCCH (e.g., for a first part) and PDSCH (e.g. for a second part).

In this disclosure, a higher layer message (e.g., SIB-based or RRC-based or MAC CE-based) can be carried by a physical downlink shared channel (PDSCH). In one example, the PDSCH can be scheduled by a DCI format.

In one example, the configuration of early SRS resources can be configured or updated, by RRC signaling and/or MAC CE signaling and/or L1 control signaling.

In one example, the configuration of the SRS resource(s) and SRS resource set(s) can include:
SRS resource(s) in SRS resource set.
SRS resource ID
Time and frequency resources (e.g., symbols within a slot for SRS, starting symbol for SRS, number of repetitions, time slot for SRS, periodicity and offset of SRS (e.g., in case of periodic or semi-persistent SRS), starting RB for SRS, number of RBs for SRS, whether frequency hopping is enabled and if enabled frequency hopping pattern, etc.).
Number of instances, K, of SRS transmitted when SRS is triggered.
Comb size, comb offset and cycle shift.
Sequence for reference signal.
Power for reference signal.
SRS usage, e.g., beamManagement, codebook, nonCodebook, antennaSwitching. In one example, SRS usage is antennaSwitching.

In this disclosure SRS antenna switching capability, refers to the UE's SRS antenna switching capability or the UE's SRS antenna switching configuration or SRS antenna switching resource configuration.

In one example, SRS resource configuration can include supportedSRS-TxPortSwitch, wherein supportedSRS-TxPortSwitch can be {t1r2 for 1T2R, t1r4 for 1T4R, t2r4 for 2T4R, t1r4-t2r4 for 1T4R/2T4R, t1r for 1T=1R, t2r2 for 2T=2R, t4r4 for 4T=4R, notSupported}. In one example, a UE can select SRS resources based on UE's antenna switching capability or capabilities. In one example, the antenna switching capability can be one of {“Not supported”, “1T2R”, “1T4R”, “2T4R”, “1T4R/2T4R”, “1T=1R”, “2T=2R”, “4T=4R” }. In one example, if a UE antenna switching capability is unknown at the time of triggering or of transmission of the early SRS a default capability can is used. In one example, the default capability is “antenna switching not supported”. In one example, the default capability is 1T2R. In one example, the default capability is 1T=1R. In one example, the default capability is configured by the SIB, e.g., SIB1. In one example, the resource used for early SRS are determined based on the antenna switching capability as described in TS 38.214 clause 6.2.1.2. For example,
For 1T2R, two SRS resources transmitted in different symbols, each SRS resource in a given set consisting of a single SRS port, and the SRS port of the second resource in the set is associated with a different UE antenna port than the SRS port of the first resource in the same set.
For 2T4R, two SRS resources transmitted in different symbols, each SRS resource in a given set consisting of two SRS ports, and the SRS port pair of the second resource is associated with a different UE antenna port pair than the SRS port pair of the first resource.
For 1T4R, four SRS resources transmitted in different symbols of two different slots, and where the SRS port of each SRS resource in the given two sets is associated with a different UE antenna port.
For 1T=1R, or 2T=2R, or 4T=4R, one SRS resource, where the number of SRS ports for each resource is equal to 1, 2, or 4 respectively.

In aforementioned examples, the configuration of early SRS can include multiple SRS (e.g., 2) resource sets for each antenna switching capability, wherein a first resource set is for type periodic or semi-persistent SRS and a second resource set is for type aperiodic SRS.

In a variant example, SRS resource configuration can include supportedSRS-TxPortSwitch, wherein supportedSRS-TxPortSwitch can be (‘t1r2’ for 1T2R, ‘t1r1-t1r2’ for 1T=1R/1T2R, ‘t2r4’ for 2T4R, ‘t1r4’ for 1T4R, ‘t1r1-t1r2-t1r4’ for 1T=1R/1T2R/1T4R, ‘t1r4-t2r4’ for 1T4R/2T4R, ‘t1r1-t1r2-t2r2-t2r4’ for 1T=1R/1T2R/2T=2R/2T4R, ‘t1r1-t1r2-t2r2-t1r4-t2r4’ for 1T=1R/1T2R/2T=2R/1T4R/2T4R, ‘t1r1’ for 1T=1R, ‘t2r2’ for 2T=2R, ‘t1r1-t2r2’ for 1T=1R/2T=2R, ‘t4r4’ for 4T=4R, or ‘t1r1-t2r2-t4r4’ for 1T=1R/2T=2R/4T=4R), or the UE may be configured with only one of the following configurations depending on the indicated UE capability or capabilities supportedSRS-TxPortSwitchBeyond4Rx (‘t1r1’ for 1T=1R, ‘t2r2’ for 2T=2R, ‘t1r2’ for 1T2R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R) or the UE may be configured with the following configurations depending on the indicated UE capability (or capabilities) [e.g., newUECapabilitySupporting8T8R](‘t1r1’ for 1T=1R, ‘t2r2’ for 2T=2R, ‘t1r2’ for 1T2R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R, ‘[noTDM]’ or ‘[TDM and noTDM]’ for 8T8R). In one example, if a UE antenna switching capability is unknown at the time of triggering or of transmission of the early SRS a default capability can be used. In one example, the default capability is “antenna switching not supported”. In one example, the default capability is 1T2R. In one example, the default capability is 1T=1R. In one example, the default capability is configured by the SIB. In one example, the resource used for early SRS are determined based on the antenna switching capability as described in TS 38.214 clause 6.2.1.2.

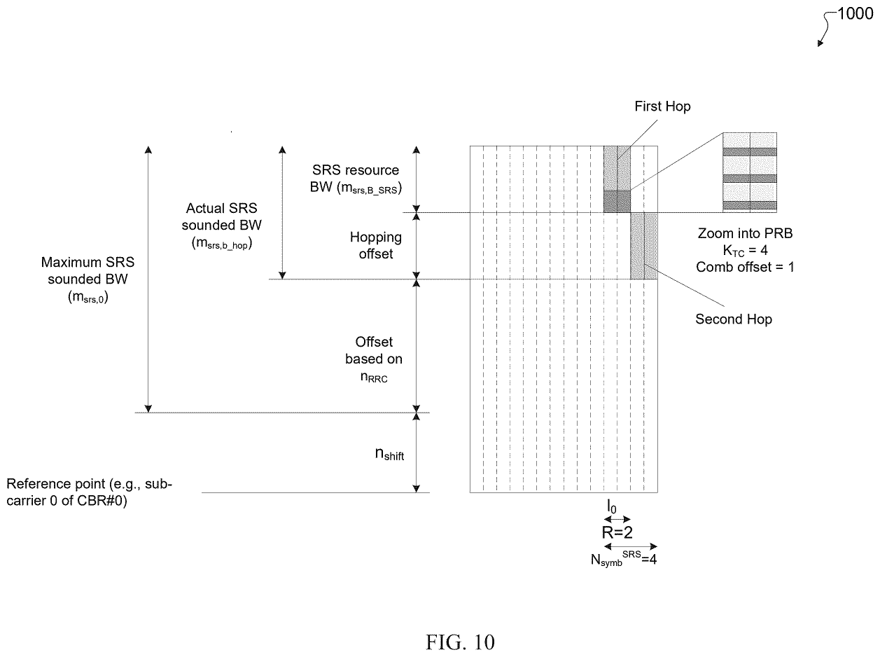

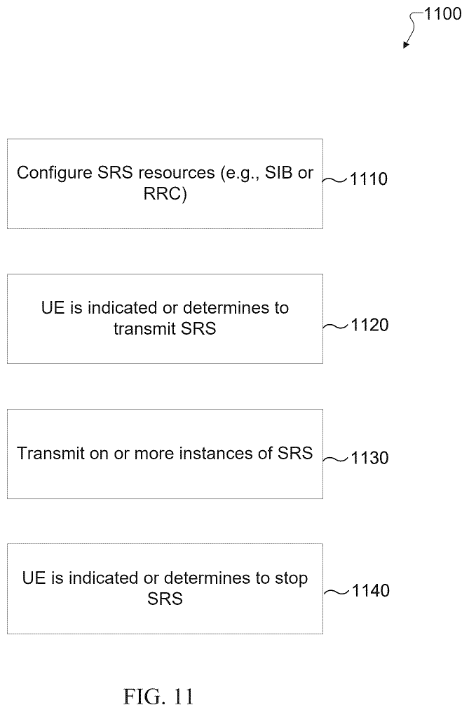

FIG. 11 illustrates an example of various UE configurations 1100 according to embodiments of the present disclosure. The example of various UE configurations 1100 shown in FIG. 11 is for illustration only and other embodiments can be used without departing from the scope of the present disclosure.

A UE can be configured with SRS resources and/or SRS resource sets by system information by system information (e.g., system information block (SIB), e.g., SIB1 or other SIB) or by RRC configuration (1110). The UE can be indicated or determines to transmit SRS (1120). In one example, the indication/determination can be by a message associated with a random access (e.g., RACH) procedure. In one example, the indication can be by a message for triggering SRS transmission. The UE, based on the indication or determination of SRS transmission, and the configured SRS resources, transmits SRS in one or more SRS transmission instances (1130). In one example, the transmission is one-shot (e.g., one SRS transmission instance, or one SRS transmission instance per subband). In one example, the transmission is N-shot (e.g., N SRS transmission instances, or N SRS transmission instances per subband). In one example, the transmission is periodic. In one example, a UE can optionally determine or is indicated to stop SRS transmission (1140) (for example in case of periodic SRS transmission, or in case of N-shot SRS transmission).

In the examples of this disclosure, the gNB or network sends a message to a UE (or to a group of UEs), and the message triggers a transmission of a SRS resource. In one example, the UE transmitting the SRS can be intended receiver of the message, for example this can be a random access response (RAR) to the UE that transmitted the preamble, or a MsgB to the UE that transmitted a MsgA for a type-2 random access procedure, or a contention resolution message or Msg4 to a UE that transmitted Msg3 of the random access procedure, or a message triggering SRS transmission. In one example, the message triggering the SRS transmission is a DCI Format or a PDSCH (e.g., containing a MAC CE) scheduled by a DCI Format. In one example, the message triggering the SRS transmission is a DCI Format or a PDSCH (e.g., containing a MAC CE) scheduled by a DCI Format, and the UE is configured to monitor the DCI Format for early SRS triggering in a random access procedure (e.g., Msg2 or Msg4 or MsgB). In one example, the triggering of the early SRS and the early SRS resource is based on a capability indicated to the network by UE, e.g., capability to support early SRS and/or xTyR SRS antenna switching capability, wherein the indication can be by PRACH preamble and/or Msg3 or MsgA PRACH and/or MsgA PUSCH.

In one example, resources used for SRS transmission, can be one of a set or group of resources configured by the network, e.g., by system information (e.g., SIB1 or other SIB) or RRC configuration. The SRS resource set ID and/or the SRS resource ID can be indicated or determined as described in this disclosure. In one example, when an SRS resource set ID and/or an SRS resource ID is indicated or determined, a subset of SRS resource sets or SRS resources is determined as described in this disclosure and a resource within the subset is indicated as described in this disclosure. In one example, when an SRS resource set ID and/or an SRS resource ID is indicated or determined, a subset of SRS resources is indicated as described in this disclosure and a resource within the subset is determined as described in this disclosure.

In one example, the configuration of the SRS resource parameters or a subset of the SRS resource parameters can be indicated to the UE in the message triggering the SRS transmission (e.g., Msg2 or Msg4 or MsgB of a RA procedure or DCI Format or PDSCH (e.g., MAC CE) triggering SRS transmission. In one example, the configuration of the SRS resource parameters or a subset of the SRS resource parameters can be indicated to the UE in a first message (e.g., Msg2 or Msg4 or MsgB of a RA procedure), and the SRS transmission is triggered in a second message, e.g. DCI Format or PDSCH (e.g., MAC CE) triggering SRS transmission.

In one example, the time (slot/symbols) of the SRS transmission (e.g., the first instance of the SRS transmission) can be relative to the message or channel from the network triggering the SRS transmission. In one example, the time of the SRS transmission (e.g., the first instance of the SRS transmission) can be relative to a message or channel of the random access procedure. In one example, the time of the SRS transmission can be included in the information triggering the SRS transmission.

In one example, an SRS transmission triggered as described in this disclosure can be one of.
A single instance SRS transmission. In one example, the single transmission instance is for the SRS resource. In one example, the single transmission instance is per sub-band of SRS.
K instances of SRS transmissions. Wherein, K can be defined in the system specifications and/or configured or updated by system information and/or RRC signaling and/or MAC CE signaling and/or L1 control signaling. In one example, K can be indicated in the message triggering the SRS transmission. In one example, the K transmission instances are for the SRS resource (e.g., these can over a wideband or multiple sub-bands). In one example, the K transmission instances are per sub-band of SRS (e.g., each sub-band of SRS is transmitted in K transmission instances). Optionally, the UE can be indicated or determines to early terminate SRS transmissions.
A periodical or semi-persistent transmission until a reconfiguration message or deactivation message is transmitted to the UE, e.g., to stop the SRS transmission.

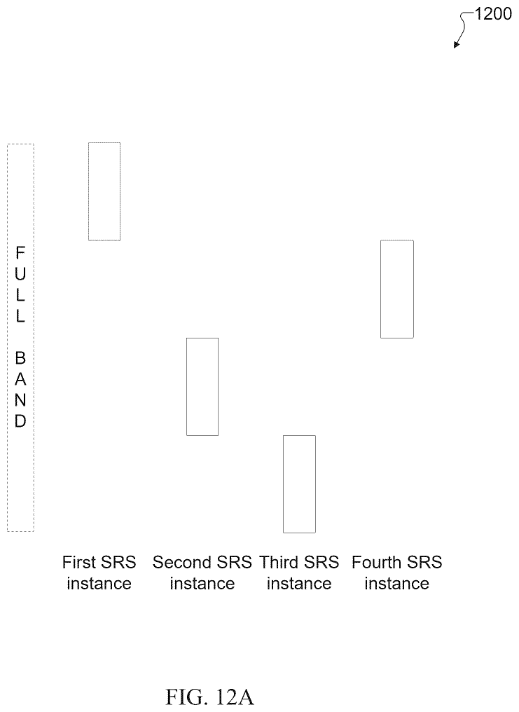

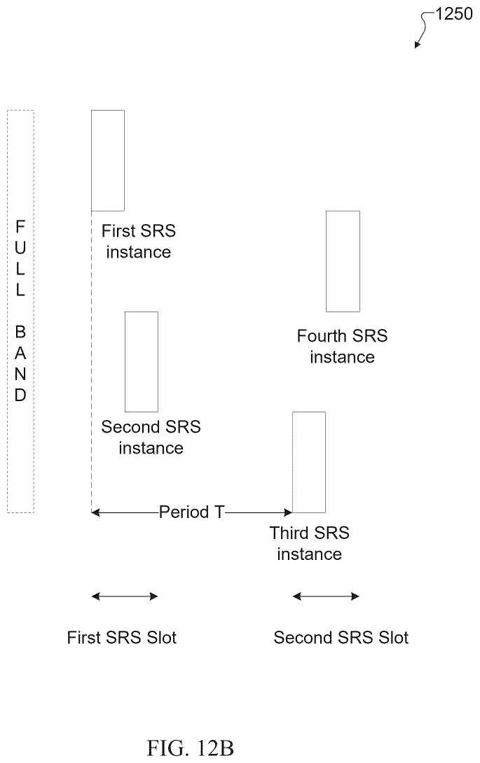

FIGS. 12A and 12B illustrate examples of SRS as sub-band SRS 1200, 1250 according to embodiments of the present disclosure. The example of SRS as sub-band SRS 1200, 1250 shown in FIGS. 12A and 12B are for illustration only and other embodiments can be used without departing from the scope of the present disclosure.

In one example, SRS is sub-band SRS. The number of sub-bands within the full band is N. In one example, SRS is transmitted K times when triggered. In one example K=N, In one example, K>=N. In one example, a hopping pattern is used to sweep the SRS transmission in the different sub-bands, as illustrated in FIG. 12A.

FIG. 12A illustrates an example with 4 sub-bands in the full band (i.e., N=4). SRS is transmitted in 4 different SRS instances at different frequency locations to estimate the quality of the channel in the full band.

In one example, SRS is configured with L symbols per slots, and R symbols for repetition, and N sub-bands. A slots contains N₁ instances of SRS, wherein

$${N}_{1} = \frac{L}{R} .$$

The SRS is repeated over N instances, which can correspond to

$$\frac{N}{{N}_{1}}$$

SRS slots as illustrated in FIG. 12B.

FIG. 12B illustrates an example with 4 sub-bands in the full band (i.e., N=4), L=4 and R=2. There are two (=L/R=4/2) SRS instances per slot. SRS is transmitted in 4 different SRS instances, in two SRS slots, at different frequency locations to estimate the quality of the channel in the full band.

In one example, the DCI format includes a UE ID. In one example, the UE ID is a UE ID assigned or allocated by the core network, for example S-Temporary Mobile Subscription Identifier (S-TMSI or NG 5G S-TMSI). In one example, the ULE ID is part of (or related to) the UE ID assigned by the core network, e.g. indicted UE ID is the n least significant bits of the UE ID, or indicted UE ID is the n most significant bits of the UE ID, or indicated ID is UE ID % N, or indicated ID is ceiling (UE ID/N). Where, % is the modulus function, where x % y is the remainder of dividing x by y. In one example, the UE ID is a UE ID assigned or allocated by the radio access network (RAN). In one example, UE ID is the I-RNTI. In one example, the UE-ID is a short I-RNTI (e.g., 24 bits of the I-RNTI). In one example, the UE ID is a long I-RNTI (e.g., 40 bits I-RNTI). In one example, the UE ID is part of (or related to) the UE ID assigned by the RAN, e.g. indicted UE ID is the n least significant bits of the UE ID, or indicted UE ID is the n most significant bits of the UE ID, or indicated ID is UE ID % N, or indicated ID is ceiling (UE ID/N). In one example, the UE ID is provided in the RA procedure (e.g., Msg2 or Msg4 or MsgB). In one example, the DCI Format includes a CRC and the CRC is scrambled with a UE specific RNTI, e.g., C-RNTI. In one example, the DCI Format is to multiple UEs and is scrambled by a group common RNTI. In one example, the DCI Format is to multiple UEs and is scrambled by a group common RNTI for early SRS. In one example, the DCI Format is to multiple UEs and includes multiple blocks corresponding to the multiple UEs, and a UE is configured or indicated a block number or starting location of a block for the UE. In one example, the DCI Format is to multiple UEs and includes multiple blocks corresponding to the multiple UEs, and a block includes a UE ID and possibly other information related to the SRS resource.

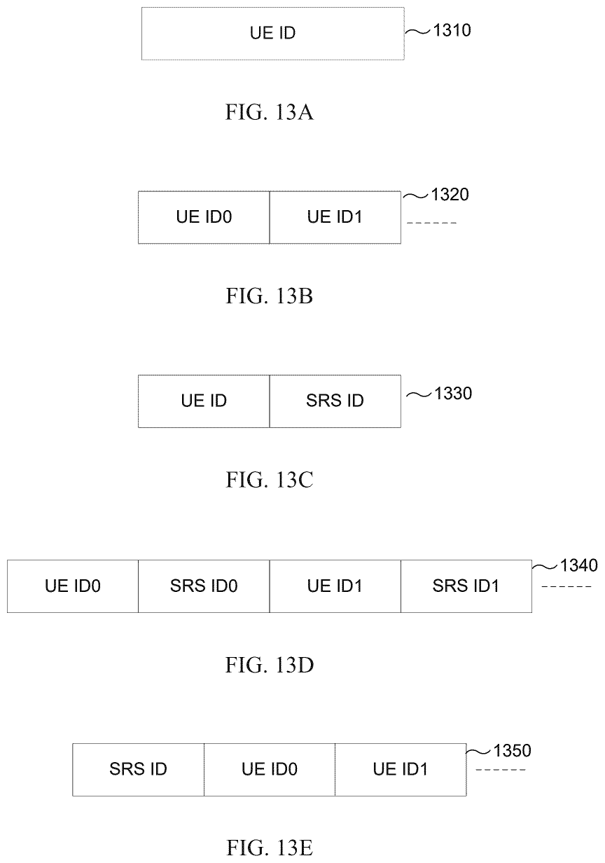

FIGS. 13A-13E illustrate examples of fields related to a UE-ID and SRS resource ID 1310-1350 in a message triggering SRS transmission according to embodiments of the present disclosure. The examples of fields related to a UE-ID and SRS resource ID 1310-1350 shown in FIGS. 13A-13E are for illustration only and other embodiments can be used without departing from the scope of the present disclosure.

As illustrated in FIGS. 13A-13E, the message can be a DCI Format and/or a higher layer message as described in this disclosure. Other fields are not excluded from the message of FIGS. 13A-13E.

In one example, DCI Format includes 1 UE ID, for example as illustrated in FIG. 13A (1310) and FIG. 13C (1330), wherein a UE-ID is as aforementioned. In one example, DCI format includes N UE-IDs, for example as illustrated in FIG. 13B (1320), FIG. 13D (1340) and FIG. 13E (1350), wherein a UE-ID is as aforementioned. In one example, N is defined in the system specifications, e.g., N=2 or N=3 or N=4, . . . . In one example, N is configured to the UE, for example, N can be in the system information e.g. SIBI or configured by RRC signaling and/or MAC CE signaling and/or L1 control signaling. In one example, the DCI Format is a two-stage or two-part DCI Format, the first stage or part includes the number N of UE IDs and the N UE IDs are included in the second stage or part. In one example, N can be configured or indicated to the UE in RA procedure (e.g., Msg2 or Msg4 or MsgB).

In one example, the RNTI of the DCI Format (e.g., used to scramble the CRC of the DCI Format) can be indicated to the UE in the RA procedure (e.g., Msg2 or Msg4 or MsgB). In one example, the RNTI of the DCI Format is UE-specific RNTI (e.g., C-RNTI). In one example, the RNTI of the DCI Format is UE-group common RNTI. In one example, the RNTI of the DCI Format is UE-group common RNTI for early SRS.

In one example, the UE can be indicated in the RA procedure (e.g., Msg2 or Msg4 or MsgB) to monitor DCI Format for early SRS. In one example, network can indicate to the UE if it supports DCI Format triggering of early SRS, wherein the indication can be based on SIB signaling and/or signaling in RA procedure (e.g., Msg2 or Msg4 or MsgB). In one example, the UE can indicate to the network in RA procedure (e.g., Msg1 or Msg3 or Msg A PRACH or MsgA PUSCH) if it monitors DCI Format for early SRS.

In one example, SRS resource (or SRS resource set) is configured by system information. In one example, M SRS resources (or M SRS resource sets) are configured by system information, wherein a UE can determine the SRS resources (or SRS resource set(s)) to use when triggered to transmit SRS (e.g., by indication in the DCI Format). In one example, M SRS resources (or M SRS resource sets) are configured by system information, wherein a UE can determine the SRS resource (or SRS resource set) to use when triggered to transmit SRS. In one example, SRS resource ID (and/or SRS resource set ID) is included in the configuration of the SRS resource. In one example, the SRS resource ID (or SRS resource set ID) is determined based on the order of the SRS resource (or SRS resource set) in the list of M SRS resources (or M SRS resource sets). For a first SRS resource/resource set in the list has SRS resource ID 0 or SRS resource ID 1. A second SRS resource/resource set in the list has SRS resource ID 1 or SRS resource ID 2 respectively.

In one example, a SRS resource/resource set determination can be based on a mapping between UE-ID and the M configured SRS resources/resource sets. In one example, a SRS resource/resource set determination can be based on a mapping between the resources used for the PDCCH reception providing the DCI Format (e.g., time and/or frequency resources, e.g., (e.g., starting) channel control elements (CCEs) or (e.g., starting) resource element groups (REGs) or (e.g., starting) resource blocks (RBs) or (e.g., starting) symbols or slots or subframes or frames etc.) and the M configured SRS resources/resource sets. In one example, a SRS resource/resource set determination can be based on a mapping between UE-ID and resources used for PDCCH reception providing the DCI Format as aforementioned, and the M configured SRS resources/resource sets.

In one example, the DCI format includes a SRS resource ID as illustrated in FIG. 13C (1330), FIG. 13D (1340) and FIG. 13E (1350). In one example, a SRS resource/resource set ID is included for each UE ID for example as illustrated in FIG. 13C (1330) and FIG. 13D (1340), wherein UE ID0 triggers SRS ID0, UE ID1 triggers SRS ID1, etc. In a variant example, DCI Format includes one SRS ID as illustrated in FIG. 13E (1350). In one example of FIG. 13E (1350), the SRS ID is for the UE ID0, the SRS ID for another UE ID can be determined based on the SRS ID and a rule, for example, UE ID1 can use SRS ID+1, UE ID2 can use SRS ID+2, etc. The rule can be a function of the SRS ID and the UE ID. In one example, the UE-ID can be configured or indicated to the UE in the RA procedure (e.g., Msg2 or Msg4 or MsgB).

In one example, the CRC of the DCI Format is scrambled with a RNTI and the RNTI is associated with triggering SRS. In one example, the RNTI is group common RNTI. In one example, the RNTI is group common RNTI for early SRS. In one example, the RNTI is UE-specific RNTI (e.g., for C-RNTI). In one example, the RNTI is indicated or configured to the UE in the RA procedure (e.g., Msg2 or Msg4 or MsgB).

In one example, the DCI Format indicates the UE to trigger the SRS transmission. In one example, the DCI Format includes a bitmap, and there is mapping or linkage between a bit in the bitmap and the UE. In one example, the DCI Format includes multiple blocks, and there is mapping or linkage between a block in the DCI Format and the UE. In one example, this mapping or linkage is based on rule (e.g., derived based on the UE ID). In one example, this mapping or linkage is based on a network configuration. In one example, this mapping or linkage is based on a combination of a rule and network configuration. In one example, a UE is configured with a bit in the bitmap that corresponds to the UE. In one example, a UE is configured or indicated a block number or a starting location of the block, and the UE determines the block in the DCI Format intended for it based on the aforementioned configuration or indication. In one example, the indication or configuration is in the RA procedure (e.g., Msg2 or Msg4 or MsgB).

In one example, the DCI Format indicated to the UE to trigger the SRS transmissions based on the time and/or frequency resources of the PDCCH providing the DCI Format, e.g., (e.g., starting) channel control elements (CCEs) or (e.g., starting) resource element groups (REGs) or (e.g., starting) resource blocks (RBs) or (e.g., starting) symbols or slots or subframes or frames, etc. In one example, this mapping or linkage is based on rule (e.g., derived based on the UE ID). In one example, this mapping or linkage is based on a network configuration. In one example, this mapping or linkage is based on a combination of a rule and network configuration. In one example, a UE is configured with the time and frequency resources of the DCI Format that correspond to the UE.

In one example, the DCI Format indicates to the UE to trigger the SRS transmissions based on the RNTI used to scramble the CRC of the DCI format. In one example, multiple RNTIs are configured for a DCI format triggering SRS. In one example, this mapping or linkage between RNTI and UE is based on a rule (e.g., derived based on the UE ID). In one example, this mapping or linkage between RNTI and UE is based on a network configuration. In one example, this mapping or linkage between RNTI and UE is based on a combination of a rule and network configuration. In one example, a UE is configured with a RNTI for SRS triggering that corresponds to the UE. In one example, the RNTI is a UE-specific RNTI, e.g., C-RNTI. In one example, the RNTI is a group common RNTI (e.g., for multiple UEs). In one example, the RNTI is a group common RNTI (e.g., for multiple UEs) for early SRS. In one example, the RNTI is configured or indicated to the UE in the RA procedure (e.g., Msg2 or Msg4 or MsgB). In one example, for a group common RNTI the UE is further configured or indicated block or bit within the DCI Format as aforementioned.

In one example, the DCI Format indicates to the UE to trigger the SRS based on one or more of bitmap or group of blocks and time/frequency resource for the PDCCH providing the DCI format and the RNTI for DCI Format as aforementioned.

In one example, the DCI Format triggering SRS transmission indicates to the UE to transmit the SRS transmission, and the SRS ID is determined. In one example, a determination can be based on a mapping or linkage between UE-ID and the M configured SRS resources/resource sets. In one example, a determination can be based on a mapping or linkage between the resources used for the PDCCH providing the DCI Format (e.g., time and/or frequency resources, e.g., (e.g., starting) channel control elements (CCEs) or (e.g., starting) resource element groups (REGs) or (e.g., starting) resource blocks (RBs) or (e.g., starting) symbols or slots or subframes or frames etc.) and the M configured SRS resources/resource sets. In one example, a determination can be based on a mapping or linkage between UE-ID and resources used for reception of the PDCCH providing the DCI Format as aforementioned, and the M configured SRS resources/resource sets. In one example, the SRS resource/resource set is configured by network in Msg2 and/or Msg4 and/or MsgB, and the UE uses the SRS resource/resource set based on the configuration in Msg2 and/or Msg4 and/or MsgB. In one example the SRS resource/resource set configuration in Msg2 and/or Msg4 and/or MsgB is based on the indicated antenna switching capability xTyR by the UE. In one example, multiple SRS resources/resource sets are configured in the SIB, and the UE is indicated an SRS resource/resource set of the multiple SRS resources/resource sets in Msg2 and/or Msg4 and/or MsgB. In one example, multiple SRS resources/resource sets are configured in the SIB, and the UE is indicated an SRS resource/resource set in the DCI format triggering the SRS. In one example, the determination or indication (in Msg2 and/or Msg4 and/or MsgB and/or DCI Format triggering early SRS) of the SRS resource/resource set is based on the xTyR capability of the UE, wherein the xTyR capability of the UE can be indicated to the network in the RA procedure (e.g., Msg1 and/or Msg3 or MsgA PRACH and/or MsgA PUSCH). In one example, a set/list of resources/resource sets is configured for each xTyR capability and the UE is indicated a SRS resource/resource set within the set/list of resources/resource sets configured for capability xTyR indicated by the RA procedure, wherein the indication can be in Msg2 and/or Msg4 and/or MsgB and/or DCI Format triggering early SRS. In one example, the network indicates a resource/resource set, from the resources/resource sets configured by the SIB or Msg4 or MsgB, that supports the xTyR capability indicated by the UE in the RA procedure. In one example, the indication of the resource/resource set within the set of resources/resource sets is by RA procedure (e.g., Msg2 or Msg4 or MsgB) or by the DCI Format triggering the early SRS.

In one example, the DCI Format triggering the SRS is for one UE. In one example, the DCI Format has a CRC and the CRC is scrambled by a UE-specific RNTI (e.g., C-RNTI). In one example, the DCI Format includes one or more of the following fields:
SRS resource ID and/or SRS resource set ID (e.g., if multiple SRS resources are configured to UE, e.g., by SIB or Msg4). In one example, the SRS resource ID or resource set ID is further determined based on the xTyR capability as indicated by the UE in the RA procedure as aforementioned.
[Minimum] Time offset to first early SRS instance. The time offset can be in time-units and/or in symbols and/or in slots and/or in sub-frames and/or in frames.
Number of SRS instances and/or SRS slots.
Whether frequency hopping is enabled.
Type of SRS resource semi-persistent or aperiodic.

In one example, the DCI Format triggering the SRS is for one UE. In one example, the DCI Format has a CRC and the CRC is scrambled by an early SRS specific RNTI. In one example, the DCI Format includes one or more of the following fields:
UE ID of the UE to transmit the SRS. In one example, the UE ID can be provided by RA procedure (e.g., Msg2 or Msg4 or MsgB).
SRS resource ID and/or SRS resource set ID (e.g., if multiple SRS resources are configured to UE, e.g., by SIB or Msg4). In one example, the SRS resource ID or resource set ID is further determined based on the xTyR capability as indicated by the UE in the RA procedure as aforementioned.
[Minimum] Time offset to first early SRS instance. The time offset can be in time-units and/or in symbols and/or in slots and/or in sub-frames and/or in frames.
Number of SRS instances and/or SRS slots.
Whether frequency hopping is enabled.
Type of SRS resource semi-persistent or aperiodic.

In one example, the DCI Format triggering the SRS is for N (or up to N) UEs. In one example, the DCI Format has a CRC and the CRC is scrambled by an early SRS specific RNTI. In one example, the DCI Format includes N or up to N blocks.
In one example, the UE is configured or indicated a block number or starting location of a block. In one example, the configuration or indication is in the RA procedure (e.g., Msg2 or Msg4 or MsgB). In one example, a block includes one or more of the following fields:
   SRS resource ID and/or SRS resource set ID (e.g., if multiple SRS resources are configured to UE, e.g., by SIB or Msg4). In one example, the SRS resource ID or resource set ID is further determined based on the xTyR capability as indicated by the UE in the RA procedure as aforementioned.
   [Minimum] Time offset to first early SRS instance. The time offset can be in time-units and/or in symbols and/or in slots and/or in sub-frames and/or in frames.
   Number of SRS instances and/or SRS slots.
   Whether frequency hopping is enabled.
   Type of SRS resource semi-persistent or aperiodic.
In one example, the UE is configured or indicated a UE-ID. In one example, the configuration or indication is in the RA procedure (e.g., Msg2 or Msg4 or MsgB). In one example, a block includes one or more of the following fields:
   UE ID of the UE to transmit the SRS. In one example, the UE ID can be provided by RA procedure (e.g., Msg2 or Msg4 or MsgB).
   SRS resource ID and/or SRS resource set ID (e.g., if multiple SRS resources are configured to UE, e.g., by SIB or Msg4). In one example, the SRS resource ID or resource set ID is further determined based on the xTyR capability as indicated by the UE in the RA procedure as aforementioned.
   [Minimum] Time offset to first early SRS instance. The time offset can be in time-units and/or in symbols and/or in slots and/or in sub-frames and/or in frames.
   Number of SRS instances and/or SRS slots.
   Whether frequency hopping is enabled.
   Type of SRS resource semi-persistent or aperiodic.

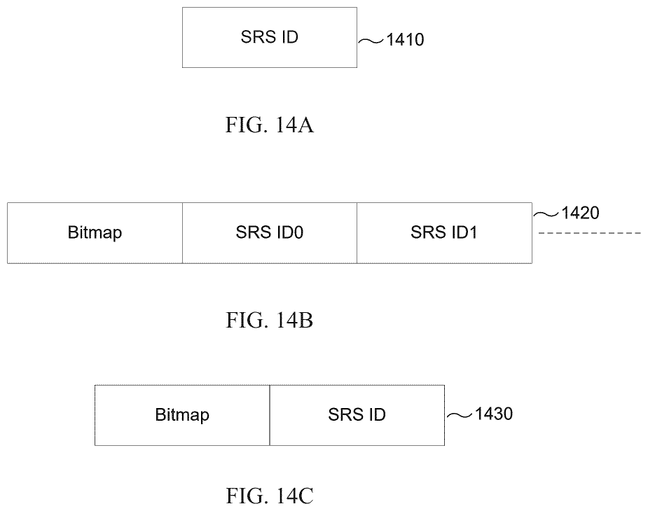

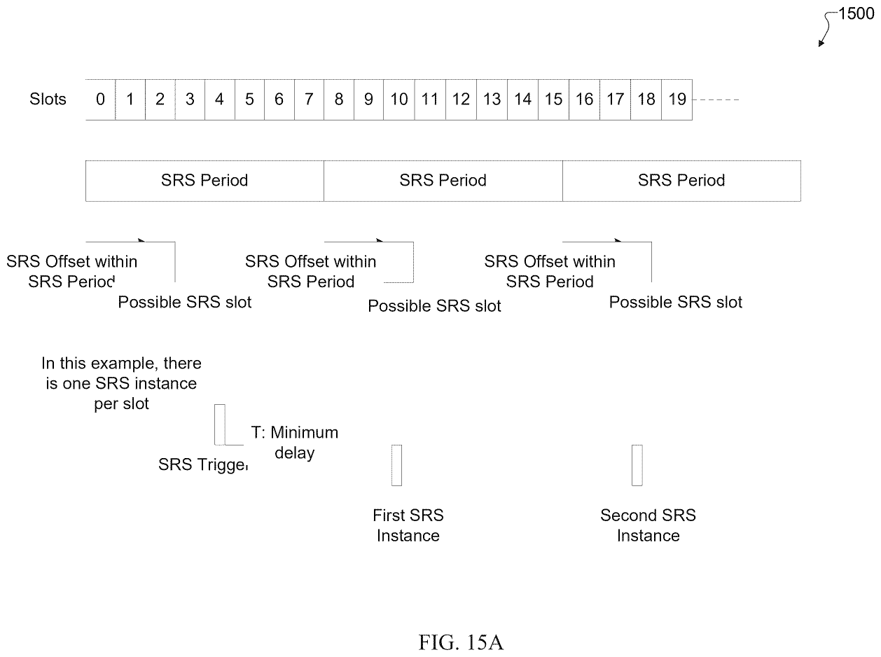

FIGS. 14A-14C illustrate examples of SRS ID being indicated in downlink control information (DCI) format 1410-1430 according to embodiments of the present disclosure. The examples of SRS ID being indicated in downlink control information (DCI) format 1410-1430 shown in FIGS. 14A-14C are for illustration only and other embodiments can be used without departing from the scope of the present disclosure.

In one example, the DCI Format indicates to the UE to trigger the SRS transmission, and the SRS ID is indicated by information in the DCI Format for example as illustrated in FIG. 14A (1410), FIG. 14B (1420) and FIG. 14C (1430).

In one example, in FIG. 14A the UE to transmit SRS is indicated to the UE e.g., by the DCI Format (e.g., based on time and/or frequency resources a PDCCH providing the of DCI Format and/or RNTI of the DCI Format), and SRS ID of the M configured SRS resources/resource sets is included in the DCI Format.

In one example, in FIG. 14B the UE(s) is indicated to transmit SRS by a bit map in a DCI Format and optionally based on time and/or frequency resources of a PDCCH providing the DCI Format and/or the RNTI of the DCI Format SRS ID(s) of the M configured SRS resources/resource sets are included in the DCI Format. For example, the first SRS ID corresponds to the first non-zero bit of the bitmap, the second SRS ID corresponds to the second non-zero bit of the bitmap, and so on. The number of SRS IDs included in the DCI format can be equal to the number of non-zero bits in the bitmap. In one example, padding is included to make the size of the DCI Format constant and independent of the number of non-zero bits in the bitmap. In one example, the DCI format is a two stage or two-part DCI format, in one example, the bitmap is included in the first stage or part, and the SRS resource IDs corresponding to non-zero bits of the bitmap are included in the second stage or part.

In one example, in FIG. 14C the UE(s) is indicated to transmit SRS by a bit map in a DCI Format and optionally based on time and/or frequency resources of a PDCCH providing the DCI Format and/or the RNTI of the DCI Format SRS ID(s) of the M configured SRS resources/resource sets are included in the DCI Format. A SRS resource ID is included in the bit map, and the resource ID for each UE transmitting SRS can be determined based on the order of corresponding non-zero bits and the SRS ID. For example, the UE corresponding to the first non-zero bit transmits SRS resource with SRS ID, the UE corresponding to the second non-zero bit transmits SRS resource with SRS ID+1, and so on. The rule can be a function of the SRS ID and the non-zero-bit position relative to other non-zero bits in the bitmap.

In one example, the slot or subframe or frame used by a UE to transmit SRS resource can be based on configuration of the corresponding SRS (e.g., using system information).

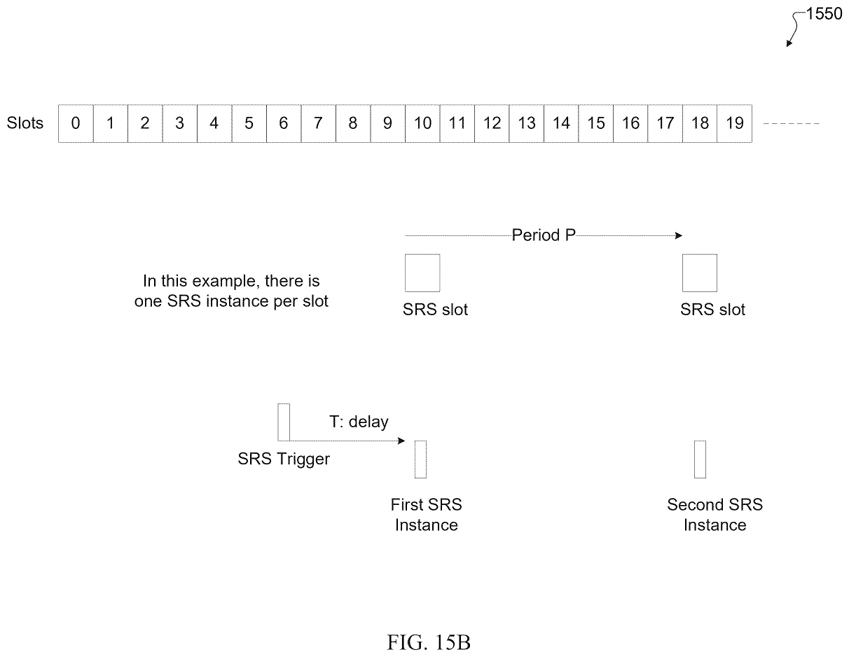

FIGS. 15A and 15B illustrate examples of SRS configuration 1500, 1550 according to embodiments of the present disclosure. The examples of SRS configuration 1500, 1550 shown in FIGS. 15A and 15B are for illustration only and other embodiments can be used without departing from the scope of the present disclosure.

In one example, the SRS resource can be transmitted by a UE a minimum time T from the end (or start) or time unit (e.g., slot) of a PDCCH reception providing the DCI Format triggering the SRS transmission or the start of end of the channel (e.g., PUCCH or PUSCH) carrying the acknowledgment to the DCI format. In one example, the slot or subframe or frame used by a UE to transmit SRS resource can be at or after a time T from the end (or start) or time unit (e.g., slot) of the PDCCH reception providing the DCI Format triggering the SRS transmission or at or after a time T from the end (or start) or time unit (e.g., slot) of the channel (e.g., PUCCH or PUSCH) carrying the acknowledgment to the DCI format. In one example, the slot or subframe or frame used by a UE to transmit SRS resource is that first slot or subframe or frame that starts at or after a time T from the end (or start) or time unit (e.g., slot) of a PDCCH reception providing the DCI Format triggering the SRS transmission or channel carrying corresponding acknowledgement and optionally based on an offset and a periodicity as illustrated in FIG. 15A. Wherein, the time T can be defined in the system specifications and/or configured or updated by network (e.g., using SIB signaling and/or RRC signaling and/or MAC CE signaling and/or L1 control signaling). In one example, the SRS transmission in FIG. 15A, can be one-shot, e.g., one instance of SRS, with a time T from the trigger of SRS (e.g., DCI Format Triggering early SRS or channel carrying corresponding acknowledgement) as aforementioned. In one example, the SRS transmission in FIG. 15A, can be N-shots, e.g., N-instances of SRS, with a periodicity P between each two-consecutive instances, and a minimum time T from the trigger, for the first instance, as aforementioned. In one example, the UE transmits the early SRS in one instance (e.g., first instance after delay T). In one example, the UE transmits the early SRS in N instances (e.g., first N instances after delay T). In one example, the UE transmits the early SRS in one SRS slot (e.g., first SRS slot after delay T), wherein SRS slot can include one or more SRS instances as aforementioned. In one example, the UE transmits the early SRS in N SRS slots (e.g., first N SRS slots after delay T), wherein SRS slot can include one or more SRS instances as aforementioned. In one example, the semi-persistent (SP) early SRS is triggered until it is deactivated. In one example, the SRS transmission corresponds to the resources of the triggered SRS resource set(s).

In one example, T can be configured and/or updated by SIB configuration and/or RA procedure (e.g., Msg2 or Msg4 or MsgB) and/or DCI Format triggering early SRS.

In one example, SRS offset and/or SRS periodicity P can be configured and/or updated by SIB configuration and/or RA procedure (e.g., Msg2 or Msg4 or MsgB) and/or DCI Format triggering early SRS.

FIG. 15A illustrates an example of SRS configuration, where a SRS period is configured (e.g., 8 slots) and a SRS offset within the SRS period for the SRS slots is configured (e.g., 2 slots). The configuration of the SRS offset and SRS period can be by SIB configuration or by RRC configuration. The SRS period and the SRS offset determine the potential (possible) SRS slots. A UE receives a SRS trigger, after a delay T from the SRS trigger the SRS can be transmitted. The UE transmits the first instance of SRS in the earliest (first) potential SRS instance or slot (as determined by the period and offset) occurring after a time T from the SRS trigger (e.g., when SRS is periodic or semi-persistent) as illustrated in FIG. 15A. In FIG. 15A, SRS is transmitted in two instances.

In one example, the delay, T, as number of slots is based on sub-carrier spacing (SCS) of DCI format or SRS or largest/smallest SCS of DCI Format and/or SRS and/or channel carrying corresponding acknowledgment.

In one example, the slot or subframe or frame used by a UE to transmit SRS resource can be at a time T from the end (or start) or time unit (e.g., slot) of the PDCCH reception providing the DCI Format triggering the SRS transmission or channel carrying corresponding acknowledgment. In one example, the SRS is transmitted in multiple SRS slots starting at T after the trigger (e.g., DCI Format triggering early SRS or channel carrying corresponding acknowledgment) and repeated with a periodicity P as illustrated in FIG. 15B. Wherein, the time T and/or P can be defined in the system specifications and/or configured or updated by network (e.g., using SIB signaling and/or RRC signaling and/or MAC CE signaling and/or L1 control signaling). In one example, the SRS transmission in FIG. 15A, can be one-shot, e.g., one instance of SRS, with a time T from the trigger of SRS or channel carrying corresponding acknowledgment as aforementioned. In one example, the SRS transmission in FIG. 15B, can be N-shots, e.g., N-instances of SRS, with a periodicity P between each two-consecutive instances, and a time T from the trigger (e.g., DCI Format Triggering early SRS or channel carrying corresponding acknowledgment), for the first instance, as aforementioned. In one example, the UE transmits the early SRS in one instance (e.g., first instance after delay T). In one example, the UE transmits the early SRS in N instances (e.g., first N instances after delay T). In one example, the UE transmits the early SRS in one SRS slot (e.g., first SRS slot after delay T), wherein SRS slot can include one or more SRS instances as aforementioned. In one example, the UE transmits the early SRS in N SRS slots (e.g., first N SRS slots after delay T), wherein SRS slot can include one or more SRS instances as aforementioned. In one example, the semi-persistent (SP) early SRS is triggered until it is deactivated. In one example, the SRS transmission corresponds to the resources of the triggered SRS resource set(s).

In one example, T can be configured and/or updated by SIB configuration and/or RA procedure (e.g., Msg2 or Msg4 or MsgB) and/or DCI Format triggering early SRS.

In one example, SRS periodicity P can be configured and/or updated by SIB configuration and/or RA procedure (e.g., Msg2 or Msg4 or MsgB) and/or DCI Format triggering early SRS.

In one example, the delay, T, as number of slots is based on sub-carrier spacing (SCS) of DCI format or SRS or largest/smallest SCS of DCI Format and/or SRS and/or channel carrying corresponding acknowledgment.

In one example, the SRS resource can be transmitted at or after a time T after an end (or start) or time unit (e.g., slot) of a PUCCH or PUSCH transmission with acknowledgment information corresponding to the PDCCH carrying the DCI triggering the SRS transmission. In one example, the slot or subframe or frame used to transmit SRS resource can be at or after a time T after the end (or start) or time unit (e.g., slot) of a PUCCH or PUSCH transmission with an acknowledgment information corresponding to the PDCCH carrying the DCI triggering the SRS transmission. In one example, the slot or subframe or frame used to transmit SRS resource is that first slot or subframe or frame that starts at or after a time T after the end (or start) or time unit (e.g., slot) of a PUCCH or PUSCH transmission with an acknowledgment information corresponding to the PDCCH carrying the DCI triggering the SRS transmission and optionally based on an offset and a periodicity as illustrated in FIG. 15A, where the SRS trigger is replaced by acknowledgment to SRS trigger. Wherein, the time T can be defined in the system specifications and/or configured or updated by network (e.g., using SIB signaling and/or RRC signaling and/or MAC CE signaling and/or L1 control signaling). In one example, the SRS transmission in FIG. 15A, can be one-shot, e.g., one instance of SRS, with a time T from the trigger (e.g., PUCCH/PUSCH carrying ACK of the PDCCH carrying the DCI triggering early SRS) as aforementioned. In one example, the SRS transmission in FIG. 15A, can be N-shots, e.g., N-instances of SRS, with a periodicity P between each two-consecutive instances, and a minimum time T from the trigger, for the first instance, as aforementioned. In one example, the UE transmits the early SRS in one instance (e.g., first instance after delay T). In one example, the UE transmits the early SRS in N instances (e.g., first N instances after delay T). In one example, the UE transmits the early SRS in one SRS slot (e.g., first SRS slot after delay T), wherein SRS slot can include one or more SRS instances as aforementioned. In one example, the UE transmits the early SRS in N SRS slots (e.g., first N SRS slots after delay T), wherein SRS slot can include one or more SRS instances as aforementioned. In one example, the semi-persistent (SP) early SRS is triggered until it is deactivated. In one example, the SRS transmission corresponds to the resources of the triggered SRS resource set(s).

In one example, T can be configured and/or updated by SIB configuration and/or RA procedure (e.g., Msg2 or Msg4 or MsgB) and/or PDSCH triggering early SRS.

In one example, SRS offset and/or SRS periodicity P can be configured and/or updated by SIB configuration and/or RA procedure (e.g., Msg2 or Msg4 or MsgB) and/or PDSCH triggering early SRS.

In one example, the delay, T, as number of slots is based on sub-carrier spacing (SCS) of DCI format or SRS or largest/smallest SCS of DCI Format and/or SRS and/or channel carrying corresponding acknowledgment.

In one example, the slot or subframe or frame used by a UE to transmit SRS resource can be at a time T from the end (or start) or time unit (e.g., slot) of the PUCCH or PUSCH carrying the ACK of the PDCCH carrying the DCI triggering the SRS transmission. In one example, the SRS is transmitted in multiple SRS slots starting at T after the trigger) (e.g., PUCCH/PUSCH carrying ACK of the PDCCH carrying the DCI triggering the SRS transmission) and repeated with a periodicity P as illustrated in FIG. 15B. Wherein, the time T and/or P can be defined in the system specifications and/or configured or updated by network (e.g., using SIB signaling and/or RRC signaling and/or MAC CE signaling and/or L1 control signaling). In one example, the SRS transmission in FIG. 15A, can be one-shot, e.g., one instance of SRS, with a time T from the trigger (e.g., PUCCH/PUSCH carrying ACK of the PDCCH carrying the DCI triggering the SRS transmission) as aforementioned. In one example, the SRS transmission in FIG. 15B, can be N-shots, e.g., N-instances of SRS, with a periodicity P between each two-consecutive instances, and a time T from the trigger (e.g., PUCCH/PUSCH carrying ACK of PDSCH or MAC CE triggering early SRS), for the first instance, as aforementioned. In one example, the UE transmits the early SRS in one instance (e.g., first instance after delay T). In one example, the UE transmits the early SRS in N instances (e.g., first N instances after delay T). In one example, the UE transmits the early SRS in one SRS slot (e.g., first SRS slot after delay T), wherein SRS slot can include one or more SRS instances as aforementioned. In one example, the UE transmits the early SRS in N SRS slots (e.g., first N SRS slots after delay T), wherein SRS slot can include one or more SRS instances as aforementioned. In one example, the semi-persistent (SP) early SRS is triggered until it is deactivated. In one example, the SRS transmission corresponds to the resources of the triggered SRS resource set(s).

In one example, T can be configured and/or updated by SIB configuration and/or RA procedure (e.g., Msg2 or Msg4 or MsgB) and/or PDSCH triggering early SRS.

In one example, SRS periodicity P can be configured and/or updated by SIB configuration and/or RA procedure (e.g., Msg2 or Msg4 or MsgB) and/or PDSCH triggering early SRS.

In one example, the delay, T, as number of slots is based on sub-carrier spacing (SCS) of DCI format or SRS or largest/smallest SCS of DCI Format and/or SRS and/or channel carrying corresponding acknowledgment.

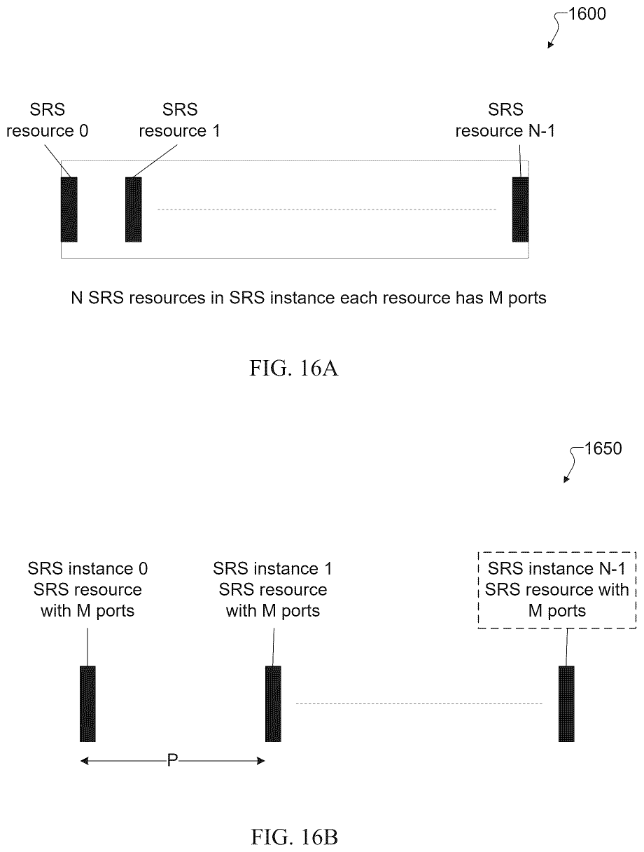

FIGS. 16A and 16B illustrate examples of transmitting SRS resources per instance 1600, 1650 according to embodiments of the present disclosure. The examples of transmitting SRS resources per instance 1600, 1650 shown in FIGS. 16A and 16B are for illustration only and other embodiments can be used without departing from the scope of the present disclosure.

In one example, a UE with SRS antenna switching capability xTyR, transmits N SRS resources per instance as illustrated in FIG. 16A, each SRS resource has M ports. SRS resource has index i, where i=0, 1, . . . ,N−1. In one example, each SRS resource of the N SRS resources corresponds to a different symbol within the same slot, or across multiple slots. In one example,

$$N = \frac{y}{x} .$$

In one example, M=x. In one example, the M ports of the SRS resource i are different from the M ports of SRS resource j, where, i=0, 1, . . . , N−1, j=0, 1, . . . N−1, and i≠j. In one example, a UE with SRS antenna switching capability xTyR, transmits 1 SRS resources per instance across N instances, as illustrated in FIG. 16B, each SRS resource has M ports. SRS resource has index i, where i=0, 1, . . . , N−1. In one example,

$$N = \frac{y}{x} .$$

In one example, M=x. In one example, the M ports of the SRS resource i are different from the M ports of SRS resource j, where, i=0, 1, . . . , N−1, j=0, 1, . . . N−1, and i≠j. In one example, the SRS repeats for N instances. In one example, the SRS can repeat for more than N instances and the N SRS resources cycle periodically through the SRS instances. In one example, SRS instance k is used for SRS resource i, where i=k % N, and the first SRS instance after the trigger has k=0.

In one example, a UE can indicate a codepoint corresponding to a set of SRS antenna switching capabilities, e.g., {Tx1Ry1, Tx2Ry2, . . . TxnRyn}, wherein

$$\frac{y 1}{x 1} = \frac{y 2}{x 2} … = \frac{y n}{x n} .$$

The UE transmits N SRS resources per instance, where

$$N = \frac{y 1}{x 1} .$$

In one example, the number of SRS ports is determined based on xi of the UE SRS antenna switching capability supported by the UE. In one example, the number of SRS ports, M, is determined based on M=max(x1, x2, . . . , xn). In one example, the number of SRS ports, M, is determined based on M=min(x1, x2, . . . , xn).

In one example, this message is a SIB message. In one example, this message is a RRC message. In one example, this message is a MAC CE message. In one example, the PDSCH providing the message is scheduled by a corresponding DCI Format.

In one example, the higher layer message includes a UE ID. In one example, the UE ID is a UE ID assigned or allocated by the core network, for example S-Temporary Mobile Subscription Identifier (S-TMSI or NG 5G S-TMSI). In one example, the UE ID is part of (or related to) the UE ID assigned by the core network, e.g. indicted UE ID is the n least significant bits of the UE ID, or indicted UE ID is the n most significant bits of the UE ID, or indicated ID is UE ID % N, or indicated ID is ceiling (UE ID/N). Where, % is the modulus function, where x % y is the remainder of dividing x by y. In one example, the UE ID is a UE ID assigned or allocated by the radio access network (RAN). In one example, UE ID is the I-RNTI. In one example, the UE-ID is a short I-RNTI (e.g., 24 bits of the I-RNTI). In one example, the UE ID is a long I-RNTI (e.g., 40 bits I-RNTI). In one example, the UE ID is part of (or related to) the UE ID assigned by the RAN, e.g. indicted UE ID is the n least significant bits of the UE ID, or indicted UE ID is the n most significant bits of the UE ID, or indicated ID is UE ID % N, or indicated ID is ceiling (UE ID/N). In one example, the UE ID is provided in the RA procedure (e.g., Msg2 or Msg4 or MsgB). In one example, the PDSCH is scheduled by a DCI Format, and the DCI Format includes a CRC and the CRC is scrambled with a UE specific RNTI, e.g., C-RNTI. In one example, the PDSCH is scheduled by a DCI Format, and the DCI Format is to multiple UEs and is scrambled by a group common RNTI. In one example, the PDSCH is scheduled by a DCI Format, and the DCI Format is to multiple UEs and is scrambled by a group common RNTI for early SRS. In one example, the PDSCH is to multiple UEs and includes multiple blocks or MAC CEs corresponding to the multiple UEs, and a UE is configured or indicated a block number or MAC CE number or a starting location of a block or MAC CE for the UE. In one example, the DCI Format is to multiple UEs and includes multiple blocks or MAC CEs corresponding to the multiple UEs, and a block or MAC CE or MAC CE header includes a UE ID and possibly other information related to the SRS resource.

In one example, the higher layer message includes 1 UE ID, for example as illustrated in FIG. 13A (1310) and FIG. 13C (1330), wherein a UE-ID is as aforementioned. In a variant example, the signaling of the UE ID is split between the DCI Format and the higher layer message. In one example, the higher layer message includes N UE-IDs, for example as illustrated in FIG. 13B (1320), FIG. 13D (1340) and FIG. 13E (1350), wherein a UE-ID is as aforementioned. In one example, N is defined in the system specifications, e.g., N=2 or N=3 or N=4, . . . . In one example, N is configured to the UE, for example, N can be in the system information e.g. SIB1 or configured by RRC signaling and/or MAC CE signaling and/or L1 control signaling. In a variant example, the signaling of the N UE IDs is split between the DCI Format and the higher layer message. In one example, the DCI format includes one part of the UE ID for each of the N UE IDs, and the higher layer message includes a second part for each of the N UE IDs. In one example, the DCI format includes one part of the UE ID that is common for the N UE IDs, and the higher layer message includes a second part for each of the N UE IDs. In one example, the DCI Format includes the number N of UE IDs and the N UE IDs are included in the message scheduled by the DCI Format. In one example, N can be configured or indicated to the UE in RA procedure (e.g., Msg2 or Msg4 or MsgB).

In one example, the RNTI of the DCI Format for scheduling PDSCH (e.g., used to scramble the CRC of the DCI Format) can be indicated to the UE in the RA procedure (e.g., Msg2 or Msg4 or MsgB). In one example, the RNTI of the DCI Format is UE-specific RNTI (e.g., C-RNTI). In one example, the RNTI of the DCI Format is UE-group common RNTI. In one example, the RNTI of the DCI Format is UE-group common RNTI for early SRS.

In one example, the UE can be indicated in the RA procedure (e.g., Msg2 or Msg4 or MsgB) to monitor DCI Format scheduling PDSCH for early SRS. In one example, network can indicate to the UE if it supports DCI Format triggering of early SRS, wherein the indication can be based on SIB signaling and/or signaling in RA procedure (e.g., Msg2 or Msg4 or MsgB). In one example, the UE can indicate to the network in RA procedure (e.g., Msg1 or Msg3 or Msg A PRACH or MsgA PUSCH) if it monitors (or can monitor) DCI Format scheduling PDSCH for early SRS.

In one example, SRS resource is configured by system information. In one example, M SRS resources/resource sets are configured by system information, wherein a UE can determine the SRS resources/resource sets to use when triggered to transmit SRS (e.g., by indication in the DCI Format). In one example, M SRS resources/resource sets are configured by system information, wherein a UE can determine the SRS resources/resource sets to use when triggered to transmit SRS. In one example, SRS resource/resource set ID is included in the configuration of the SRS resource/resource set. In one example, the SRS resource/resource set ID is determined based on the order of the SRS resource/resource set in the list of M SRS resources/resource sets. For a first SRS resource/resource set in the list has SRS resource/resource set ID 0 or SRS resource/resource set ID 1. A second SRS resource/resource set in the list has SRS resource/resource set ID 1 or SRS resource/resource set ID 2 respectively.

In one example, a SRS resource/resource set determination can be based on a mapping or linkage between UE-ID and the M configured SRS resources/resource sets. In one example, a SRS resource/resource set determination can be based on a mapping or linkage between the resources used for the higher layer message and/or the PDCCH providing the corresponding DCI Format (e.g., time and/or frequency resources, e.g., (e.g., starting) channel control elements (CCEs) or (e.g., starting) resource element groups (REGs) or (e.g., starting) resource blocks (RBs) or (e.g., starting) symbols or slots or subframes or frames etc.) and the M configured SRS resources/resource sets. In one example, a SRS resource/resource set determination can be based on a mapping or linkage between UE-ID and resources/resource sets used for higher layer message and/or the PDCCH providing the corresponding DCI Format as aforementioned, and the M configured SRS resources/resource sets.

In one example, the higher layer message and/or the corresponding DCI Format includes a SRS resource/resource set ID as illustrated in FIG. 13(c), FIG. 13(d) and FIG. 13(e). In one example, a SRS resource/resource set ID is included for each UE ID for example as illustrated in FIG. 13(c) and FIG. 13(d), wherein UE ID0 triggers SRS ID0, UE ID1 triggers SRS ID1, etc. In a variant example, higher layer message and/or the corresponding DCI Format includes one SRS ID as illustrated in FIG. 13(e). In one example of FIG. 13(e), the SRS ID is for the UE ID0, the SRS ID for another UE ID can be determined based on the SRS ID and a rule, for example, UE ID1 can use SRS ID+1, UE ID2 can use SRS ID+2, etc. The rule can be a function of the SRS ID and the UE ID. In one example, the UE-ID can be configured or indicated to the UE in the RA procedure (e.g., Msg2 or Msg4 or MsgB).

In one example, the CRC of the higher layer message and/or the corresponding DCI Format is scrambled with a RNTI and the RNTI is associated with triggering SRS. In one example, the RNTI is group common RNTI. In one example, the RNTI is group common RNTI for early SRS. In one example, the RNTI is UE-specific RNTI (e.g., for C-RNTI). In one example, the RNTI is indicated or configured to the UE in the RA procedure (e.g., Msg2 or Msg4 or MsgB).

In one example, the higher layer message and/or the corresponding DCI Format indicates to the UE to trigger the SRS transmission. In one example, the higher layer message and/or the corresponding DCI Format includes a bitmap, and there is mapping or linkage between a bit in the bitmap and the UE. In one example, the PDSCH and/or the corresponding DCI Format includes multiple blocks or MAC CEs, and there is mapping or linkage between a block or MAC CE in the multiple blocks or MAC CEs and the UE. In one example, this mapping or linkage is based on rule (e.g., derived based on the UE ID). In one example, this mapping or linkage is based on a network configuration. In one example, this mapping or linkage is based on a combination of a rule and network configuration. In one example, a UE is configured with a bit in the bitmap that corresponds to the UE. In one example, a UE is configured or indicated a block or MAC CE number or a starting location of the block or MAC CE, and the UE determines the block in the PDSCH or MAC PDU intended for it based on the aforementioned configuration or indication. In one example, the indication or configuration is in the RA procedure (e.g., Msg2 or Msg4 or MsgB).

In one example, the higher layer message and/or the corresponding DCI Format indicates to the UE to trigger the SRS transmission based on the time and/or frequency resources of the PDCCH providing the DCI Format, e.g., (e.g., starting) channel control elements (CCEs) or (e.g., starting) resource element groups (REGs) or (e.g., starting) resource blocks (RBs) or (e.g., starting) symbols or slots or subframes or frames, etc. In one example, this mapping or linkage is based on rule (e.g., derived based on the UE ID). In one example, this mapping or linkage is based on a network configuration. In one example, this mapping or linkage is based on a combination of a rule and network configuration. In one example, a UE is configured with the time and frequency resources of the higher layer message and/or the corresponding DCI Format that correspond to the UE.

In one example, the higher layer message and/or the corresponding DCI Format indicates to the UE to trigger the SRS transmission based on the RNTI used to scramble the CRC of the DCI format. In one example, multiple RNTIs are configured for a DCI format triggering SRS and/or a higher layer message. In one example, this mapping or linkage between RNTI and UE is based on a rule (e.g., derived based on the UE ID). In one example, this mapping or linkage between RNTI and UE is based on a network configuration. In one example, this mapping or linkage between RNTI and UE is based on a combination of a rule and network configuration. In one example, a UE is configured with a RNTI for SRS triggering that corresponds to the UE. In one example, the RNTI is a UE-specific RNTI, e.g., C-RNTI. In one example, the RNTI is a group common RNTI (e.g., for multiple UEs). In one example, the RNTI is a group common RNTI (e.g., for multiple UEs) for early SRS. In one example, the RNTI is configured or indicated to the UE in the RA procedure (e.g., Msg2 or Msg4 or MsgB). In one example, for a group common RNTI the UE is further configured block or MAC CE or bit within the PDSCH or DCI Format as aforementioned.

In one example, the higher layer message and/or the PDCCH providing the corresponding DCI Format indicates to the UE to trigger the SRS transmission based on one or more of bitmap or group of blocks/MAC CEs and time/frequency resource for higher layer message and/or the PDCCH providing the corresponding DCI format and the RNTI for higher layer message and/or the corresponding DCI Format as aforementioned.

In one example, the higher layer message (e.g., in PDSCH) and/or the corresponding DCI Format trigger SRS transmission indicates to the UE to transmit the SRS transmission, and the SRS ID is determined from other parameters. In one example, the determination can be based on a mapping or linkage between UE-ID and the M configured SRS resources/resource sets. In one example, the determination can be based on a mapping or linkage between the resources used for the higher layer message and/or the corresponding PDCCH that provides the DCI Format (e.g., time and/or frequency resources, e.g., (e.g., starting) channel control elements (CCEs) or (e.g., starting) resource element groups (REGs) or (e.g., starting) resource blocks (RBs) or (e.g., starting) symbols or slots or subframes or frames etc.) and the M configured SRS resources/resource sets. In one example, the indication can be based on a mapping or linkage between UE-ID and resources used for the PDCCH providing the DCI Format as aforementioned, and the M configured SRS resources/resource sets. In one example, the SRS resource/resource set is configured by network in Msg2 and/or Msg4 and/or MsgB, and the UE uses the SRS resource/resource set based on the configuration in Msg2 and/or Msg4 and/or MsgB. In one example the SRS resource/resource set configuration in Msg2 and/or Msg4 and/or MsgB is based on the indicated antenna switching capability xTyR by the UE. In one example, multiple SRS resources/resource sets are configured in the SIB, and the UE is indicated an SRS resource/resource set of the multiple SRS resources/resource sets in Msg2 and/or Msg4 and/or MsgB. In one example, multiple SRS resources/resource sets are configured in the SIB, and the UE is indicated an SRS resource/resource set in the DCI format triggering the SRS. In one example, the determination or indication (in Msg2 and/or Msg4 and/or MsgB and/or PDSCH (e.g., MAC CE) triggering early SRS) of the SRS resource/resource set is based on the xTyR capability of the UE, wherein the xTyR capability of the UE can be indicated to the network in the RA procedure (e.g., Msg1 and/or Msg3 or MsgA PRACH and/or MsgA PUSCH). In one example, a set of resources is configured for each xTyR capability and the UE is indicated a SRS resource/resource sets within the set/list of resources/resource sets configured for capability xTyR indicated by the RA procedure, wherein the indication can be in Msg2 and/or Msg4 and/or MsgB and/or PDSCH (e.g., MAC CE) triggering early SRS. In one example, the network indicates a resource/resource set, from the resources/resource sets configured by the SIB or Msg4 or MsgB, that supports the xTyR capability indicated by the UE in the RA procedure. In one example, the indication of the resource within the set/list of resources/resource sets is by RA procedure (e.g., Msg2 or Msg4 or MsgB) or by the DCI Format or corresponding PDSCH triggering the early SRS.

In one example, the PDSCH (or MAC CE within the PDSCH) triggering the SRS is for one UE. In one example, a DCI Format scheduling the PDSCH has a CRC and the CRC is scrambled by a UE-specific RNTI (e.g., C-RNTI). In one example, the PDSCH (or MAC CE within the PDSCH) includes one or more of the following fields:
SRS resource ID and/or SRS resource set ID (e.g., if multiple SRS resources are configured to UE, e.g., by SIB or Msg4). In one example, the SRS resource ID or resource set ID is further determined based on the xTyR capability as indicated by the UE in the RA procedure as aforementioned.
[Minimum] Time offset to first early SRS instance. The time offset can be in time-units and/or in symbols and/or in slots and/or in sub-frames and/or in frames.
Number of SRS instances and/or SRS slots.
Whether frequency hopping is enabled.
Type of SRS resource semi-persistent or aperiodic.

In one example, the PDSCH (or MAC CE within the PDSCH) triggering the SRS is for one UE. In one example, a DCI Format scheduling the PDSCH has a CRC and the CRC is scrambled by an early SRS specific RNTI. In one example, the PDSCH (or MAC CE within the PDSCH) includes one or more of the following fields:
UE ID of the UE to transmit the SRS. In one example, the UE ID can be provided by RA procedure (e.g., Msg2 or Msg4 or MsgB).
SRS resource ID and/or SRS resource set ID (e.g., if multiple SRS resources are configured to UE, e.g., by SIB or Msg4). In one example, the SRS resource ID or resource set ID is further determined based on the xTyR capability as indicated by the UE in the RA procedure as aforementioned.
[Minimum] Time offset to first early SRS instance. The time offset can be in time-units and/or in symbols and/or in slots and/or in sub-frames and/or in frames.
Number of SRS instances and/or SRS slots.
Whether frequency hopping is enabled.
Type of SRS resource semi-persistent or aperiodic.

In one example, the PDSCH (or MAC CE within the PDSCH) triggering the SRS is for N (or up to N) UEs. In one example, a DCI Format scheduling the PDSCH has a CRC and the CRC is scrambled by an early SRS specific RNTI. In one example, the PDSCH (or MAC CE within the PDSCH) includes N or up to N blocks (or MAC CEs).
In one example, the UE is configured or indicated a block (or MAC CE) number or starting location of a block (or MAC CE). In one example, the configuration or indication is in the RA procedure (e.g., Msg2 or Msg4 or MsgB). In one example, a block includes one or more of the following fields:
   SRS resource ID and/or SRS resource set ID (e.g., if multiple SRS resources are configured to UE, e.g., by SIB or Msg4). In one example, the SRS resource ID or resource set ID is further determined based on the xTyR capability as indicated by the UE in the RA procedure as aforementioned.
   [Minimum] Time offset to first early SRS instance. The time offset can be in time-units and/or in symbols and/or in slots and/or in sub-frames and/or in frames.
   Number of SRS instances and/or SRS slots.
   Whether frequency hopping is enabled.
   Type of SRS resource semi-persistent or aperiodic.
In one example, the UE is configured or indicated a UE-ID. In one example, the configuration or indication is in the RA procedure (e.g., Msg2 or Msg4 or MsgB). In one example, a block (or MAC CE) includes one or more of the following fields:
   UE ID of the UE to transmit the SRS. In one example, the UE ID can be provided by RA procedure (e.g., Msg2 or Msg4 or MsgB).
   SRS resource ID and/or SRS resource set ID (e.g., if multiple SRS resources are configured to UE, e.g., by SIB or Msg4). In one example, the SRS resource ID or resource set ID is further determined based on the xTyR capability as indicated by the UE in the RA procedure as aforementioned.
   [Minimum] Time offset to first early SRS instance. The time offset can be in time-units and/or in symbols and/or in slots and/or in sub-frames and/or in frames.
   Number of SRS instances and/or SRS slots.
   Whether frequency hopping is enabled.
   Type of SRS resource semi-persistent or aperiodic.

In one example, the higher layer message and/or the corresponding PDCCH/DCI Format indicates to the UE to trigger the SRS transmission, and the SRS ID is indicated in the higher layer message and/or the corresponding PDCCH/DCI Format for example as illustrated in FIG. 14A (1410), FIG. 14B (1420) and FIG. 14C (1430).

In one example, in FIG. 14A (1410) the UE is indicated to transmit SRS by the higher layer message and/or the corresponding PDCCH/DCI Format (e.g., based on time and/or frequency resources of higher layer message and/or the corresponding PDCCH/DCI Format and/or RNTI of higher layer message and/or the corresponding DCI Format), and SRS ID of the M configured SRS resources/resource sets is included in the higher layer message and/or the corresponding DCI Format.

In one example, in FIG. 14B (1420) the UE(s) to transmit SRS are determined by bit map in the higher layer message and/or the corresponding DCI Format and optionally based on time and/or frequency resources of higher layer message and/or the corresponding PDCCH/DCI Format and/or RNTI of higher layer message and/or the corresponding DCI Format, and SRS ID(s) of the M configured SRS resources/resource sets are included in the higher layer message and/or the corresponding DCI Format. For example, the first SRS ID corresponds to the first non-zero bit of the bitmap, the second SRS ID corresponds to the second non-zero bit of the bitmap, and so on. The number of SRS IDs included in higher layer message and/or the corresponding DCI Format can equal to the number of non-zero bits in the bitmap. In one example, padding is included to make the size of the DCI Format associated with the higher layer message constant and independent of the number of non-zero bits in the bitmap. In one example, the DCI format is a two stage or two-part DCI format, in one example, the bitmap is included in the first stage or part, and the SRS resource/resource set IDs corresponding to non-zero bits of the bitmap are included in the second stage or part and/or the higher layer message.

In one example, in FIG. 14C the UE(s) to transmit SRS are determined by bit map in the higher layer message and/or the corresponding DCI Format and optionally based on time and/or frequency resources of higher layer message and/or the corresponding PDCCH/DCI Format and/or RNTI of higher layer message and/or the corresponding DCI Format, and SRS ID(s) of the M configured SRS resources/resource sets are included in the higher layer message and/or the corresponding DCI Format. A SRS resource/resource set ID is included in the bit map, the resource ID for each UE transmitting SRS can be determined based on the order of corresponding non-zero bit and the SRS ID. For example, the UE corresponding to the first non-zero bit transmits SRS resource/resource set with SRS ID, the UE corresponding to the second non-zero bit transmits SRS resource/resource set with SRS ID+1, and so on. The rule can be a function of the SRS ID and the non-zero-bit position relative to other non-zero bits in the bitmap.

In one example, the slot or subframe or frame used by a UE to transmit SRS resource can be based on configuration of the corresponding SRS (e.g., using system information).

In one example, the SRS resource can be transmitted at or after a time T from the end (or start) or time unit (e.g., slot) of a PDSCH reception providing the higher layer message (e.g., MAC CE) or from the end (or start) or time unit (e.g., slot) of the PDCCH reception providing the corresponding DCI Format triggering the SRS transmission or corresponding channel carrying an acknowledgement (e.g., HARQ-ACK acknowledgement). In one example, the slot or subframe or frame used to transmit SRS resource can be at least a time T after the end (or start) or time unit (e.g., slot) of the PD SCH reception providing the higher layer message or of the PDCCH reception providing the corresponding DCI Format triggering the SRS transmission or corresponding channel carrying an acknowledgement. In one example, the slot or subframe or frame used to transmit SRS resource is that first slot or subframe or frame that starts after a time T from the end (or start) or time unit (e.g., slot) of the PDSCH reception providing the higher layer message or from the end (or start) or time unit (e.g., slot) of the PDCCH reception providing the corresponding DCI Format triggering the SRS transmission or corresponding channel carrying an acknowledgement and optionally based on an offset and a periodicity as illustrated in FIG. 15A. Wherein, the time T can be defined in the system specifications and/or configured or updated by network (e.g., using SIB signaling and/or RRC signaling and/or MAC CE signaling and/or L1 control signaling). In one example, the SRS transmission in FIG. 15A, can be one-shot, e.g., one instance of SRS, with a time T from the trigger of SRS (e.g., PDSCH or MAC CE triggering early SRS) as aforementioned. In one example, the SRS transmission in FIG. 15A, can be N-shots, e.g., N-instances of SRS, with a periodicity P between each two-consecutive instances, and a minimum time T from the trigger, for the first instance, as aforementioned. In one example, the UE transmits the early SRS in one instance (e.g., first instance after delay T). In one example, the UE transmits the early SRS in N instances (e.g., first N instances after delay T). In one example, the UE transmits the early SRS in one SRS slot (e.g., first SRS slot after delay T), wherein SRS slot can include one or more SRS instances as aforementioned. In one example, the UE transmits the early SRS in N SRS slots (e.g., first N SRS slots after delay T), wherein SRS slot can include one or more SRS instances as aforementioned. In one example, the semi-persistent (SP) early SRS is triggered until it is deactivated. In one example, the SRS transmission corresponds to the resources of the triggered SRS resource set(s).

In one example, T can be configured and/or updated by SIB configuration and/or RA procedure (e.g., Msg2 or Msg4 or MsgB) and/or PDSCH triggering early SRS.

In one example, SRS offset and/or SRS periodicity P can be configured and/or updated by SIB configuration and/or RA procedure (e.g., Msg2 or Msg4 or MsgB) and/or PDSCH triggering early SRS.

In one example, the delay, T, as number of slots is based on sub-carrier spacing (SCS) of DCI format or SRS or largest/smallest SCS of DCI Format and/or PDSCH and/or SRS and/or channel carrying corresponding acknowledgment.

In one example, the slot or subframe or frame used by a UE to transmit SRS resource can be at a time T from the end (or start) or time unit (e.g., slot) of the PDCCH reception providing the DCI Format scheduling the PDSCH triggering the SRS transmission or corresponding channel carrying an acknowledgement. In one example, the slot or subframe or frame used by a UE to transmit SRS resource can be at a time T from the end (or start) or time unit (e.g., slot) of the PDSCH triggering the SRS transmission. In one example, the SRS is transmitted in multiple SRS slots starting at T after the trigger (e.g., DCI Format triggering early SRS) and repeated with a periodicity P as illustrated in FIG. 15B. Wherein, the time T and/or P can be defined in the system specifications and/or configured or updated by network (e.g., using SIB signaling and/or RRC signaling and/or MAC CE signaling and/or L1 control signaling). In one example, the SRS transmission in FIG. 15A, can be one-shot, e.g., one instance of SRS, with a time T from the trigger of SRS as aforementioned. In one example, the SRS transmission in FIG. 15B, can be N-shots, e.g., N-instances of SRS, with a periodicity P between each two-consecutive instances, and a time T from the trigger (e.g., PDSCH or MAC CE triggering early SRS or corresponding channel carrying an acknowledgement), for the first instance, as aforementioned. In one example, the UE transmits the early SRS in one instance (e.g., first instance after delay T). In one example, the UE transmits the early SRS in N instances (e.g., first N instances after delay T). In one example, the UE transmits the early SRS in one SRS slot (e.g., first SRS slot after delay T), wherein SRS slot can include one or more SRS instances as aforementioned. In one example, the UE transmits the early SRS in N SRS slots (e.g., first N SRS slots after delay T), wherein SRS slot can include one or more SRS instances as aforementioned. In one example, the semi-persistent (SP) early SRS is triggered until it is deactivated. In one example, the SRS transmission corresponds to the resources of the triggered SRS resource set(s).

In one example, T can be configured and/or updated by SIB configuration and/or RA procedure (e.g., Msg2 or Msg4 or MsgB) and/or PDSCH triggering early SRS.

In one example, SRS periodicity P can be configured and/or updated by SIB configuration and/or RA procedure (e.g., Msg2 or Msg4 or MsgB) and/or PDSCH triggering early SRS.

In one example, the delay, T, as number of slots is based on sub-carrier spacing (SCS) of DCI format or SRS or largest/smallest SCS of DCI Format and/or PDSCH and/or SRS and/or channel carrying corresponding acknowledgment.

In one example, the SRS resource can be transmitted at or after a time T after an end (or start) or time unit (e.g., slot) of a PUCCH or PUSCH transmission with acknowledgment information corresponding to the higher layer message (e.g., PDSCH) triggering the SRS transmission. In one example, the slot or subframe or frame used to transmit SRS resource can be at or after a time T after the end (or start) or time unit (e.g., slot) of a PUCCH or PUSCH transmission with an acknowledgment information corresponding to the higher layer message triggering the SRS transmission. In one example, the slot or subframe or frame used to transmit SRS resource is that first slot or subframe or frame that starts at or after a time T after the end (or start) or time unit (e.g., slot) of a PUCCH or PUSCH transmission with an acknowledgment information corresponding to the higher layer message triggering the SRS transmission and optionally based on an offset and a periodicity as illustrated in FIG. 15A, where the SRS trigger is replaced by acknowledgment to SRS trigger. Wherein, the time T can be defined in the system specifications and/or configured or updated by network (e.g., using SIB signaling and/or RRC signaling and/or MAC CE signaling and/or L1 control signaling). In one example, the SRS transmission in FIG. 15A, can be one-shot, e.g., one instance of SRS, with a time T from the trigger (e.g., PUCCH/PUSCH carrying ACK of PDSCH or MAC CE triggering early SRS) as aforementioned. In one example, the SRS transmission in FIG. 13, can be N-shots, e.g., N-instances of SRS, with a periodicity P between each two-consecutive instances, and a minimum time T from the trigger, for the first instance, as aforementioned. In one example, the UE transmits the early SRS in one instance (e.g., first instance after delay T). In one example, the UE transmits the early SRS in N instances (e.g., first N instances after delay T). In one example, the UE transmits the early SRS in one SRS slot (e.g., first SRS slot after delay T), wherein SRS slot can include one or more SRS instances as aforementioned. In one example, the UE transmits the early SRS in N SRS slots (e.g., first N SRS slots after delay T), wherein SRS slot can include one or more SRS instances as aforementioned. In one example, the semi-persistent (SP) early SRS is triggered until it is deactivated. In one example, the SRS transmission corresponds to the resources of the triggered SRS resource set(s).

In one example, T can be configured and/or updated by SIB configuration and/or RA procedure (e.g., Msg2 or Msg4 or MsgB) and/or PDSCH triggering early SRS.

In one example, SRS offset and/or SRS periodicity P can be configured and/or updated by SIB configuration and/or RA procedure (e.g., Msg2 or Msg4 or MsgB) and/or PDSCH triggering early SRS.

In one example, the delay, T, as number of slots is based on sub-carrier spacing (SCS) of DCI format or SRS or largest/smallest SCS of DCI Format and/or PDSCH and/or SRS and/or channel carrying corresponding acknowledgment.

In one example, the slot or subframe or frame used by a UE to transmit SRS resource can be at a time T from the end (or start) or time unit (e.g., slot) of the PUCCH or PUSCH carrying the ACK of the PDSCH triggering the SRS. In one example, the SRS is transmitted in multiple SRS slots starting at T after the trigger) (e.g., PUCCH/PUSCH carrying ACK of PDSCH or MAC CE triggering early SRS) and repeated with a periodicity P as illustrated in FIG. 15B. Wherein, the time T and/or P can be defined in the system specifications and/or configured or updated by network (e.g., using SIB signaling and/or RRC signaling and/or MAC CE signaling and/or LI control signaling). In one example, the SRS transmission in FIG. 15A, can be one-shot, e.g., one instance of SRS, with a time T from the trigger (e.g., PUCCH/PUSCH carrying ACK of PDSCH or MAC CE triggering early SRS) as aforementioned. In one example, the SRS transmission in FIG. 15B, can be N-shots, e.g., N-instances of SRS, with a periodicity P between each two-consecutive instances, and a time T from the trigger (e.g., PUCCH/PUSCH carrying ACK of PDSCH or MAC CE triggering early SRS), for the first instance, as aforementioned. In one example, the UE transmits the early SRS in one instance (e.g., first instance after delay T). In one example, the UE transmits the early SRS in N instances (e.g., first N instances after delay T). In one example, the UE transmits the early SRS in one SRS slot (e.g., first SRS slot after delay T), wherein SRS slot can include one or more SRS instances as aforementioned. In one example, the UE transmits the early SRS in N SRS slots (e.g., first N SRS slots after delay T), wherein SRS slot can include one or more SRS instances as aforementioned. In one example, the semi-persistent (SP) early SRS is triggered until it is deactivated. In one example, the SRS transmission corresponds to the resources of the triggered SRS resource set(s).

In one example, T can be configured and/or updated by SIB configuration and/or RA procedure (e.g., Msg2 or Msg4 or MsgB) and/or PDSCH triggering early SRS.

In one example, SRS periodicity P can be configured and/or updated by SIB configuration and/or RA procedure (e.g., Msg2 or Msg4 or MsgB) and/or PDSCH triggering early SRS.

In one example, the delay, T, as number of slots is based on sub-carrier spacing (SCS) of DCI format or SRS or largest/smallest SCS of DCI Format and/or PDSCH and/or SRS and/or channel carrying corresponding acknowledgment.

In one example, there is no acknowledgment information for the higher layer message, and the transmission of SRS can be considered as an acknowledgment information. For example, if the network doesn't receive or detect SRS, the higher layer message can be retransmitted.

In a variant of the aforementioned examples, the SRS configuration parameters (or a subset of them) for one or more SRS resources can be included in the higher layer message and/or the corresponding DCI format instead of or in addition to the SRS ID for the one or more SRS resources. The configuration for the SRS resource can be as aforementioned.

In the following examples, as described, a UE can indicate the support of early SRS by the preamble and/or RO used for the random access procedure. In one example a set of preambles and/or ROs are configured for the UE to indicate early SRS (UE can randomly select a preamble/RO from the set for early SRS support indication). The set of preambles and/or ROs can be per-SS/PBCH block, or can be common across SS/PBCH blocks.

In one example, preambles within existing RO configurations can be used to indicate that the UE supports early SRS (e.g., group g), legacy preambles are used to indicate that the UE doesn't support early SRS (e.g., group go). In one example, new ROs can be used to indicate that the UE supports early SRS, e.g., preambles in new ROs can be used to indicate that the UE supports early SRS (e.g., group g), legacy preambles and/or ROs are used to indicate that the UE doesn't support early SRS (e.g., group go).

In the following examples, as described, a UE can indicate its SRS antenna switching xTyR capability for early SRS based on the preamble and/or RO used for the random access procedure. In one example a first set of preambles and/or ROs are configured for the UE to indicate support of a first xTyR capability, a second set of preambles and/or ROs are configured for the UE to indicate support of a second xTyR capability, . . . , an Nth set of preambles and/or ROs are configured for the UE to indicate support of an Nth xTyR capability. Wherein, the UE can randomly select a preamble from a set and the set corresponds to the UE's SRS antenna switching capability (or early SRS antenna switching capability). In one example, the selection of a preamble from any of the N sets indicates to the network that the UE supports early SRS (or supports and desires to transmit early SRS). In one example, the network upon receiving a preamble associated with an ith group determines that the UE can transmit an SRS resource(s) corresponding to the ith group corresponding to a SRS antenna switching capability xTyR associated with the ith group.

In one example, the SRS antenna switching capability xTyR is indicated by a combination of signaling in preamble/RO (e.g., based on the preamble/TO group), and Msg3 or PUSCH MsgA.

In one example, an RO (e.g., per SS/PBCH block or across all SS/PBCH blocks) is configured for indicating the SRS antenna switching xTyR capability. In one example, the RO has M, e.g., 64 preambles, and the M preambles are split among N groups of preambles. In one example, an RO has M preambles per SSB, and the M preambles are split among N groups of preambles. In one example, the RO has M preambles per SSB per preamble group (group A and group B wherein group A and group B indicates different Msg3/MsgA size), and the M preambles are split among N groups of preambles.

In one example, there are N codepoints indicated by the preamble and/or RO, wherein each code-point can be a subset of {1T=1R, 1T2R, 1T4R, 1T6R, 1T8R, 2T=2R, 2T/4R, 2T/6R, 2T/8R, 3T=3R, 3T/6R, 4T=4R, 4T4R, 8T8R}. In a further example, an element of the subset is indicated by Msg3 or MsgA PUSCH.

In one example, configuration of the number of preamble groups for indication of SRS antenna switching capability, the preambles and/or ROs associated with each group (per SS/PBCH block or across SS/PBCH blocks), and xTyR capability (or set of capabilities) associated with each group can be configured and/or updated by SIB and/or RRC and/or MAC CE and/or L1 control (e.g., DCI Format) signaling.

In the following examples, as described, a UE can indicate the support of early SRS and/or the UE's SRS antenna switching xTyR capability for early SRS in Msg3 or MsgA PUSCH. In one example, UE reports in RACH Msg3 or MsgA PUSCH UE's SRS antenna switching xTyR capability or UE doesn't support early SRS.

In a variant of the aforementioned examples the following examples are provided:
In one example, the early SRS capability and/or UE's SRS antenna switching xTyR capability can be indicated in Msg3 or MsgA PUSCH by including a MAC CE (e.g. SRS capability MAC CE) in Msg3 or MsgA MAC PDU wherein the MAC PDU include CCCH SDU and the MAC CE. One or more fields in the MAC CE indicate early SRS capability and/or UE's SRS antenna switching xTyR capability. In one example, UE can indicate that it supports early SRS through the PRACH preamble and in response network provides large enough grant in random access response to transmit Msg3 including UE's other SRS capabilities such as SRS antenna switching xTyR capability in MAC CE.
In one example, the one or more early SRS capability can be indicated by LCID/eLCID of CCCH SDU in Msg3 or MsgA PUSCH/MAC PDU and other SRS capability can be indicated by a MAC CE in Msg3 or MsgA PUSCH/MAC PDU.
In one example, the early SRS capability and/or UE's SRS antenna switching xTyR capability can be indicated in Msg3 or MsgA PUSCH/MAC PDU in LCID/eLCID of CCCH SDU.
In one example, the early SRS capability and/or UE's SRS antenna switching xTyR capability can be indicated in Msg3 or MsgA PUSCH/MAC PDU by a combination of LCID/eLCID of CCCH SDU and MAC CE (e.g., using one or more new fields). In one example, indication of xTyR, y/x can be indicated by LCID/eLCID and x can be indicated by a new field in MAC CE. In one example, indication of xTyR, y/x can be indicated by LCID/eLCID and y can be indicated by a new field in MAC CE. In one example, indication of xTyR, x can be indicated by LCID/eLCID and y/x can be indicated by a new field in MAC CE. In one example, indication of xTyR, y can be indicated by LCID/eLCID and y/x can be indicated by a new field in MAC CE. In one example, indication of xTyR, y can be indicated by LCID/eLCID and x can be indicated by a new field in MAC CE. In one example, indication of xTyR, x can be indicated by LCID/eLCID and y can be indicated by a new field in MAC CE.

In one example, an SRS transmission is triggered in the random access response (RAR) (e.g., Msg2) to a preamble transmission. In one example, an SRS transmission is triggered in the random access response (RAR) (e.g., Msg2) to a preamble transmission for a contention based random access procedure. In one example, an SRS transmission is triggered in the random access response (RAR) (e.g., Msg2) to a preamble transmission for a contention free random access procedure. In one example, the SRS is triggered in a RAR if the UE supports early SRS. In one example, the indication of the support of early SRS is indicated by the preamble and/or PRACH Occasion (RO) used for the random access procedure. For example, the preambles and/or ROs can be partitioned into 2 groups g₀, g₁, if a UE doesn't support early SRS or doesn't request early SRS a preamble and/or RO in the first group is used (e.g. g₀), if a UE supports early SRS or supports and requests early SRS, a preamble and/or RO in the second group is used (e.g. g₁). In a variant example, there are N groups of preambles and/or ROs, as aforementioned, wherein the N groups can indicate the UE's capability to support or not support early SRS, and/or the capability of the UE in regard to SRS antennas switching as aforementioned.

In one example, a UE is configured e.g., by a field or flag in the system information to transmit SRS in response to receiving a RAR. The SRS transmission can be further conditioned on whether the UE transmits an associated PRACH preamble/RO from a first group of preambles/ROs or from a second group of preambles/ROs indicated in the system information. In one example, if a UE is configured by system information with a first set of preambles/ROs for “no early” SRS and a second of preambles/ROs for “early SRS”, the UE can:
If the UE transmits a preamble/RO associated with “no early SRS”, the UE doesn't expect to receive a trigger for early SRS in the RAR. In a variant example, if a UE receives a trigger for early SRS in the RAR, the UE ignores the trigger.
In one example, if the UE transmits a preamble/RO associated with “early SRS”, the RAR doesn't include a flag for early SRS trigger, the UE transmits the early SRS upon receiving the RAR.
In one example, if the UE transmits a preamble/RO associated with “early SRS”, the RAR includes a flag for early SRS trigger, based on the flag the UE transmits or doesn't transmit the early SRS upon receiving the RAR.
In one example, if the UE transmits a preamble/RO associated with “early SRS”, the RAR includes a flag for the UE to monitor PDCCH carrying a DCI format that triggers early SRS transmission as aforementioned.
In one example, if the UE transmits a preamble/RO associated with “early SRS”, the RAR includes a flag for the UE to monitor PDCCH carrying a DCI format scheduling a PDSCH (e.g., carrying MAC CE) that triggers early SRS transmission as aforementioned.

In one example, a UE is indicated in the RAR to transmit a SRS. In one example, a flag or a field in the RAR can indicate whether the UE transmits SRS in response to receiving the RAR. In one example, a field in the MAC sub-header for Random Access Response, e.g., a reserved field in the MAC sub-header for the Random Access Response can be used to trigger the SRS, for example, a value of “1” triggers the SRS, and a value of “0” doesn't trigger the SRS. In one example, a field in the MAC RAR, e.g., a reserved field in the MAC RAR can be used to trigger the SRS, for example, a value of “1” triggers the SRS, and a value of “0” doesn't trigger the SRS.

In one example, a UE is indicated by a flag (e.g., one-bit flag) or a special bit pattern in the RAR to transmit SRS. In one example, the UE transmits SRS instead of or in place of PUSCH Msg3. In one example, the UE transmits SRS in addition to PUSCH Msg3 (before or after PUSCH Msg3). In one example, the flag (e.g., one-bit flag) is included in the MAC sub-header for the Random Access Response, e.g., for Type-1 Random Access Procedure. In one example, the flag (e.g., one-bit flag) is included in the MAC RAR, e.g., for Type-1 Random Access Procedure. In one example, the flag (e.g., one-bit flag) is included in the UL Grant of the MAC RAR, e.g., for Type-1 Random Access Procedure. In one example, a special bit pattern of fields in the UL Grant of the MAC RAR, e.g., for Type-1 Random Access Procedure, indicates transmission of SRS. In one example, the flag (e.g., one-bit flag) is included in the DCI scheduling PDSCH of the MAC RAR. In one example, a special bit pattern of fields in the DCI scheduling the PDSCH of the MAC RAR indicates transmission of SRS.

In one example, a UE is indicated by a SRS resource in the RAR to use for SRS transmission. In one example, the UE transmits SRS instead of or in place of PUSCH Msg3. In one example, the UE transmits SRS in addition to PUSCH Msg3 (before or after PUSCH Msg3). In one example, the SRS resource is included in the MAC RAR, e.g., for Type-1 Random Access Procedure. In one example, the SRS resource is included in the UL Grant of the MAC RAR, e.g., for Type-1 Random Access Procedure. In one example, the SRS resource is included in the DCI scheduling the PDSCH of the MAC RAR. In one example, the SRS resource is linked to (associated with) the preamble index. In one example, the SRS resource is linked to (associated with) the PRACH occasion. In one example, the SRS resource is linked to (associated with) the preamble index and the PRACH occasion. In one example, the preambles and/or ROs are portioned into N groups as aforementioned, the UE can determine the SRS resource based on the group of the preamble and/or RO, e.g., based on the antenna switching capability, in one example, one of the groups can be associated with no early SRS transmission. In one example, the SRS resource includes a SRS resource ID and/or SRS resource set ID configured to the UE from a list of SRS resources and/or a list of SRS resource sets configured to the UE, wherein the configuration can be by SIB signaling or by RRC signaling. In one example, the SRS resource includes configuration/scheduling parameters for the SRS, such as time domain resources (e.g., symbol(s) in a slot to use for SRS, time offset from the RAR, time offset from Msg3, or time offset within a period, SRS period, etc.), frequency domain resources (e.g., starting RB, number of RBs, frequency hopping pattern, etc.), comb parameters (e.g., comb size, comb offset, cyclic shift, etc.), sequence, sequence hopping (e.g., group hopping, sequence hopping or neither, etc.). In one example, the UL grant of the MAC RAR includes parameters to schedule the SRS resource.

In one example, a UE is indicated by a flag (e.g., one-bit flag) or a special bit pattern in the RAR to transmit SRS and is indicated an SRS resource in the RAR. In one example, the UE transmits SRS instead of or in place of PUSCH Msg3. In one example, the UE transmits SRS in addition to PUSCH Msg3 (before or after PUSCH Msg3). In one example, the SRS resource includes a SRS resource ID and/or SRS resource set ID configured to the UE from a list of SRS resources and/or a list of SRS resource sets configured to the UE, wherein the configuration can be by SIB signaling or by RRC signaling. In one example, the SRS resource includes configuration/scheduling parameters for the SRS, such as time domain resources (e.g., symbol(s) in a slot to use for SRS, time offset from the RAR, or time offset within a period, SRS period, etc.), frequency domain resources (e.g., starting RB, number of RBs, frequency hopping pattern, etc.), comb parameters (e.g., comb size, comb offset, cyclic shift, etc.), sequence, sequence hopping (e.g., group hopping, sequence hopping or neither, etc.). In one example, the UL grant of the MAC RAR includes parameters to schedule the SRS resource.

In one example, the UE determines the early SRS resource or resources to transmit based in the antenna switching capability if known. In one example, the antenna switching capability (e.g., xTyR or whether it is supported or not) is signaled based on a preamble and/or RO index or group as aforementioned. In one example, the antenna switching capability is signaled in Msg3, for an early SRS transmitted after Msg3, the network and UE can be aligned on the antenna switching capability and early SRS resource(s) used.

In one example, M SRS resources/resource sets are configured by system information. In one example, the SRS resource set ID and/or the SRS resource ID transmitted by a UE is determined based on one or more of the following:
Based on a TC-RNTI conveyed by the RAR, e.g. the n least significant bits of the TC-RNTI, or the n most significant bits of the TC-RNTI, or indicated ID is TC-RNTI % N, or indicated ID is ceiling (TC-RNTI/N).
Based on a UE-ID indicated in or determined by a paging message that triggered the random access procedure associated with the RAR.
Based on the C-RNTI (or UE-ID), in Msg3, the UE and the gNB can identify a SRS resource (e.g., SRS resource in a stored context associated with the C-RNTI or the UE-ID)
Based on the preamble index associated with the RAR.
Based on the PRACH occasion (RO) associated with the RAR.
Based on the preamble index and PRACH occasion (RO) associated with the RAR.
Based on the group of the preamble and/or RO associated with the RAR as aforementioned.
Based on the antenna switching capability or a default antenna switching capability if antenna switching capability is unknown at the time of early SRS transmission or early SRS triggering.
The time and/or frequency resources of a PDCCH reception providing a DCI format scheduling a RAR or the PDSCH reception providing the RAR.

In one example, in case of antenna switching, with multiple SRS resources, an SRS resource ID (and/or SRS resource set ID) can be determined by or be linked or mapped to multiple SRS resources/SRS resource sets based on the antenna switching capability, and the corresponding number of SRS resources.

In one example, the network configures SRS resource(s) for each preamble-ID. In one example, the network configures SRS resource(s) for each RO within a frame. In one example, the network configures SRS resource(s) for each RO within an association period. In one example, the network configures SRS resource(s) for each RO within an association pattern period. In one example, the network configures SRS resource(s) for each RO within N frames, wherein N is configured and/or updated RRC and/or MAC CE and L1 control (e.g., DCI format) signaling, or N is specified in the system specifications, e.g., N=16, or N=8.

In one example, the network configures SRS resource(s) for each preamble-ID-RO pair. Wherein, RO can be:
Within a frame.
Within an association period.
Within an association pattern period.
Within N frames, wherein N is configured and/or updated RRC and/or MAC CE and Li control (e.g., DCI format) signaling, or N is specified in the system specifications, e.g., N=16, or N=8.

In one example, this mapping between the SRS resource ID (and/or SRS resource set ID) and the aforementioned parameters is based on a rule. In one example, this mapping between the SRS resource ID (and/or SRS resource set ID) and the aforementioned parameters is based on a network configuration. In one example, this mapping between the SRS resource ID (and/or SRS resource set ID) and the aforementioned parameters is based on a combination of a rule and network configuration.

In one example, the SRS resource ID (and/or SRS resource set ID) transmitted by a UE is determined based on one or more of the following:
A SRS ID of the M SRS resource IDs (and/or SRS resource set IDs) configured by system information, wherein the SRS resource ID (and/or SRS resource set ID) is included in the DCI Format scheduling the RAR and/or the RAR. In one example, the SRS resource IDs and/or SRS resource set IDs is further determined by the antenna switching capability (e.g., xTyR) indicated by the UE. In one example, multiple sets or lists of SRS resources are configured, wherein a set is associated with a UE antenna switching capability xTyR, a SRS resource ID is indicated in the DCI Format scheduling the RAR and/or the RAR from the set corresponding UE's xTyR capability as indicated by the UE (e.g., in Msg1).
In a variant, the SRS configuration parameters (or a subset of them) for the SRS resource can be included in the DCI Format scheduling the RAR and/or the RAR instead of or in addition to the SRS ID. Wherein the configuration parameters for the SRS resource can be as aforementioned. In one example, the RAR (Msg2) or the DCI scheduling the RAR includes a time T (e.g., slot and/or symbol and/or subframe and/or frame offset) that indicates when the early SRS or the first instance of the early SRS or the first slot of the early SRS is transmitted. In one example, the time T is from the trigger (e.g., start or end of RAR or start or end of DCI scheduling RAR) to the early SRS (or the slot of the early SRS).

In one example, the SRS resource can be transmitted at or after a time T after the end (or start) or time unit (e.g., slot) of the PDSCH reception providing the RAR or of end (or start) or time unit (e.g., slot) of the PDCCH reception providing the DCI Format scheduling the RAR associated with the UE transmitting SRS and/or channel carrying corresponding acknowledgment. In one example, the slot or subframe or frame used to transmit SRS resource can be at or after a time T after the end (or start) or time unit (e.g., slot) of PDSCH reception providing the RAR or of end (or start) or time unit (e.g., slot) of the PDCCH reception providing the DCI Format scheduling the RAR associated with the UE transmitting SRS and/or channel carrying corresponding acknowledgment. In one example, the slot or subframe or frame used to transmit SRS resource is that first slot or subframe or frame that starts at or after a time T after the end (or start) or time unit (e.g., slot) of PDSCH reception providing the RAR or of end (or start) or time unit (e.g., slot) of PDCCH reception providing the DCI Format scheduling the RAR associated with the ULE transmitting SRS and/or channel carrying corresponding acknowledgment and optionally based on an offset and a periodicity as illustrated in FIG. 13 (the SRS instances can be one-shot, N-shots or semi-persistent), where SRS trigger can be replaced by the PDSCH providing the RAR or the PDCCH providing the DCI Format scheduling the RAR associated with the UE transmitting SRS. Wherein, the time T can be defined in the system specifications and/or configured or updated by network (e.g., using SIB signaling and/or RRC signaling and/or MAC CE signaling and/or L1 control signaling). In one example, the SRS transmission in FIG. 15A, can be one-shot, e.g., one instance of SRS, with a time T from the trigger of SRS (e.g., RAR or DCI scheduling RAR) as aforementioned. In one example, the SRS transmission in FIG. 15B, can be N-shots, e.g., N-instances of SRS, with a periodicity P between each two-consecutive instances, and a minimum time T from the trigger, for the first instance, as aforementioned. In one example, the UE transmits the early SRS in one instance (e.g., first instance after delay T). In one example, the UE transmits the early SRS in N instances (e.g., first N instances after delay T). In one example, the UE transmits the early SRS in one SRS slot (e.g., first SRS slot after delay T), wherein SRS slot can include one or more SRS instances as aforementioned. In one example, the UE transmits the early SRS in N SRS slots (e.g., first N SRS slots after delay T), wherein SRS slot can include one or more SRS instances as aforementioned. In one example, the semi-persistent (SP) early SRS is triggered until it is deactivated. In one example, the SRS transmission corresponds to the resources of the triggered SRS resource set(s).

In one example, T can be configured and/or updated by SIB configuration and/or RAR (Msg2) or DCI scheduling the RAR. In one example, T is selected so that the SRS is transmitted shortly before start of data transmission in connected mode, so that channel sounding result is fresh when data transmission starts.

In one example, SRS offset and/or SRS periodicity P can be configured and/or update by SIB and/or RAR (Msg2) or DCI scheduling the RAR.

In one example, the delay, T, as number of slots is based on sub-carrier spacing (SCS) of DCI format scheduling the RAR or the PDSCH carrying the RAR or SRS or largest/smallest SCS of DCI Format scheduling the RAR and/or PDSCH carrying the RAR and/or SRS and/or channel carrying corresponding acknowledgment.

In one example, the slot or subframe or frame used by a UE to transmit SRS resource can be at a time T from the end (or start) or time unit (e.g., slot) of the PDCCH scheduling the RAR triggering the SRS transmission or channel carrying corresponding acknowledgment. In one example, the slot or subframe or frame used by a UE to transmit SRS resource can be at a time T from the end (or start) or time unit (e.g., slot) of the PDSCH carrying the RAR triggering the SRS transmission or channel carrying corresponding acknowledgment. In one example, the SRS is transmitted in multiple SRS slots starting at T after the trigger (e.g., DCI Format triggering early SRS) and repeated with a periodicity P as illustrated in FIG. 15B. Wherein, the time T and/or P can be defined in the system specifications and/or configured or updated by network (e.g., using SIB signaling and/or RRC signaling and/or MAC CE signaling and/or L1 control signaling). In one example, the SRS transmission in FIG. 15A, can be one-shot, e.g., one instance of SRS, with a time T from the trigger of SRS (e.g., RAR or PDCCH scheduling the RAR) as aforementioned. In one example, the SRS transmission in FIG. 15B, can be N-shots, e.g., N-instances of SRS, with a periodicity P between each two-consecutive instances, and a time T from the trigger, for the first instance, as aforementioned. In one example, the UE transmits the early SRS in one instance (e.g., first instance after delay T). In one example, the UE transmits the early SRS in N instances (e.g., first N instances after delay T). In one example, the UE transmits the early SRS in one SRS slot (e.g., first SRS slot after delay T), wherein SRS slot can include one or more SRS instances as aforementioned. In one example, the UE transmits the early SRS in N SRS slots (e.g., first N SRS slots after delay T), wherein SRS slot can include one or more SRS instances as aforementioned. In one example, the semi-persistent (SP) early SRS is triggered until it is deactivated. In one example, the SRS transmission corresponds to the resources of the triggered SRS resource set(s).

In one example, T can be configured and/or updated by SIB configuration and/or RAR (Msg2) or DCI scheduling the RAR. In one example, T is selected so that the SRS is transmitted shortly before start of data transmission in connected mode, so that channel sounding result is fresh when data transmission starts.

In one example, SRS periodicity P can be configured and/or updated by SIB and/or RAR (Msg2) or DCI scheduling the RAR.

In one example, the delay, T, as number of slots is based on sub-carrier spacing (SCS) of DCI format scheduling the RAR or the PDSCH carrying the RAR or SRS or largest/smallest SCS of DCI Format scheduling the RAR and/or PDSCH carrying the RAR and/or SRS and/or channel carrying corresponding acknowledgment.

In one example, the RAR and/or DCI scheduling the RAR includes a flag to trigger SRS. The SRS is transmitted after RACH Msg3. In one example, Msg3 can convey antenna switching capability, and the SRS resource(s) is determined based on the antenna switching capability as aforementioned. In a variant example, the antenna switching capability is conveyed by a combination of signaling in the preamble/RO (e.g., based on preamble and/or RO group as aforementioned) and signaling in Msg3. In one example, early SRS capability in Msg3 is indicated by 1 bit in RRC message or using a specific LCID/eLCID in MAC PDU.

In one example, if the RAR includes a trigger for early SRS transmission, Msg3 can further include an indication whether or not the UE is transmitting the early SRS.

In one example, the SRS resource can be transmitted at or after a time T after the end (or start) or time unit (e.g., slot) of the PUSCH transmission containing Msg3 associated with the UE transmitting SRS. In one example, the slot or subframe or frame used to transmit SRS resource can be at or after a time T after the end (or start) or time unit (e.g., slot) of the PUSCH transmission containing Msg3 associated with the UE transmitting SRS. In one example, the slot or subframe or frame used to transmit SRS resource is that first slot or subframe or frame that starts at or after a time T after the end (or start) or time unit (e.g., slot) of the PUSCH transmission containing Msg3 associated with the UE transmitting SRS and optionally based on an offset and a periodicity as illustrated in FIG. 15A (the SRS instances can be one-shot, N-shots or semi-persistent), where SRS trigger can be replaced by the PUSCH transmission containing Msg3 associated with the UE transmitting SRS. Wherein, the time T can be defined in the system specifications and/or configured or updated by network (e.g., using SIB signaling and/or RRC signaling and/or MAC CE signaling and/or L1 control signaling).

In one example, an SRS transmission is triggered in contention resolution message providing a C-RNTI for the UE, or in Msg4, of a random access procedure. In one example, an SRS transmission is triggered in contention resolution message or Msg4 of a contention-based random access procedure. In one example, the SRS is triggered in a Msg4 if the UE supports early SRS. In one example, the indication of the support of early SRS is indicated by the preamble and/or PRACH Occasion (RO) used for the random access procedure. For example, the preambles and/or ROs can be partitioned into 2 groups g₀, g₁, if a UE doesn't support early SRS or doesn't request early SRS a preamble and/or RO in the first group is used (e.g. g₀), if a UE supports early SRS or supports and requests early SRS, a preamble and/or RO in the second group is used (e.g. g₁). In a variant example, there are N groups of preambles and/or ROs, as aforementioned, wherein the N groups can indicate the UE's capability to support or not support early SRS, and/or the capability of the UE in regard to SRS antennas switching as aforementioned.

In one example, the indication of the support of early SRS is indicated by Msg3 (or MsgA) of the random access procedure. Support of early SRS can be indicated in MAC subheader (e.g. by using a pre-defined LCID or eLCID) or MAC CE or RRC message (e.g. RRC setup request or RRC resume request) included in Msg3/MsgA MAC PDU. In a variant example, Msg3 can indicate the UE's capability to support or not support early SRS, and/or the capability of the UE in regard to SRS antennas switching as aforementioned. In a variant example, the UE's capability to support or not support early SRS, and/or the antenna switching capability is conveyed by a combination of signaling in the preamble/RO (e.g., based on preamble and/or RO group as aforementioned) and signaling in Msg3. In one example, the SRS transmission in FIG. 15A, can be one-shot, e.g., one instance of SRS, with a time T from the trigger or reference of SRS (e.g., Msg3) as aforementioned. In one example, the SRS transmission in FIG. 15A, can be N-shots, e.g., N-instances of SRS, with a periodicity P between each two-consecutive instances, and a minimum time T from the trigger, for the first instance, as aforementioned. In one example, the UE transmits the early SRS in one instance (e.g., first instance after delay T). In one example, the UE transmits the early SRS in N instances (e.g., first N instances after delay T). In one example, the UE transmits the early SRS in one SRS slot (e.g., first SRS slot after delay T), wherein SRS slot can include one or more SRS instances as aforementioned. In one example, the UE transmits the early SRS in N SRS slots (e.g., first N SRS slots after delay T), wherein SRS slot can include one or more SRS instances as aforementioned. In one example, the semi-persistent (SP) early SRS is triggered until it is deactivated. In one example, the SRS transmission corresponds to the resources of the triggered SRS resource set(s).

In one example, T can be configured and/or updated by SIB configuration and/or RAR (Msg2) or DCI scheduling the RAR. In one example, T is selected so that the SRS is transmitted shortly before start of data transmission in connected mode, so that channel sounding result is fresh when data transmission starts.

In one example, SRS offset and/or SRS periodicity P can be configured and/or updated by SIB and/or RAR (Msg2) and/or DCI scheduling the RAR.

In one example, the delay, T, as number of slots is based on sub-carrier spacing (SCS) of DCI format scheduling the RAR or the PDSCH carrying the RAR or PUSCH carrying Msg3 or SRS or largest/smallest SCS of DCI Format scheduling the RAR and/or PDSCH carrying the RAR and/or channel carrying corresponding acknowledgement and/or PUSCH carrying Msg3 and/or SRS.

In one example, the slot or subframe or frame used by a UE to transmit SRS resource can be at a time T from the end (or start) or time unit (e.g., slot) of the PUSCH carrying Msg3. In one example, the SRS is transmitted in multiple SRS slots starting at T after the trigger (e.g., DCI Format triggering early SRS) and repeated with a periodicity P as illustrated in FIG. 15B. Wherein, the time T and/or P can be defined in the system specifications and/or configured or updated by network (e.g., using SIB signaling and/or RRC signaling and/or MAC CE signaling and/or L1 control signaling). In one example, the SRS transmission in FIG. 15A, can be one-shot, e.g., one instance of SRS, with a time T from the reference or trigger of SRS (e.g., Msg3) as aforementioned. In one example, the SRS transmission in FIG. 15B, can be N-shots, e.g., N-instances of SRS, with a periodicity P between each two-consecutive instances, and a time T from the trigger, for the first instance, as aforementioned. In one example, the UE transmits the early SRS in one instance (e.g., first instance after delay T). In one example, the UE transmits the early SRS in N instances (e.g., first N instances after delay T). In one example, the UE transmits the early SRS in one SRS slot (e.g., first SRS slot after delay T), wherein SRS slot can include one or more SRS instances as aforementioned. In one example, the UE transmits the early SRS in N SRS slots (e.g., first N SRS slots after delay T), wherein SRS slot can include one or more SRS instances as aforementioned. In one example, the semi-persistent (SP) early SRS is triggered until it is deactivated. In one example, the SRS transmission corresponds to the resources of the triggered SRS resource set(s).

In one example, T can be configured and/or updated by SIB configuration and/or RAR (Msg2) or DCI scheduling the RAR. In one example, T is selected so that the SRS is transmitted shortly before start of data transmission in connected mode, so that channel sounding result is fresh when data transmission starts.

In one example, SRS periodicity P can be configured and/or updated by SIB and/or RAR (Msg2) or DCI scheduling the RAR.

In one example, the delay, T, as number of slots is based on sub-carrier spacing (SCS) of DCI format scheduling the RAR or the PDSCH carrying the RAR or PUSCH carrying Msg3 or SRS or largest/smallest SCS of DCI Format scheduling the RAR and/or PDSCH carrying the RAR and/or channel carrying corresponding acknowledgement and/or PUSCH carrying Msg3 and/or SRS.

In one example, a UE is configured e.g., by a field or flag in the system information to transmit SRS in response to receiving a contention resolution message, or in Msg4, or in a DCI Format scheduling Msg4 or MsgB. The SRS transmission can be further conditioned on whether the UE transmits an associated PRACH preamble from a first group of preambles or from a second group of preambles indicated in the system information. In one example, if a UE is configured by system information with a first set of preamble for “no early” SRS and a second of preambles for “early SRS”, the UE can:
If the UE transmits a preamble associated with “no early SRS”, the UE doesn't expect to receive a trigger for early SRS in a contention resolution message, or in Msg4, or in a DCI Format scheduling Msg4. In a variant example, if a UE receives a trigger for early SRS in a contention resolution message, or in Msg4, or in a DCI Format scheduling Msg4, the UE ignores the trigger.
In one example, if the UE transmits a preamble associated with “early SRS”, the contention resolution message, or Msg4, or DCI Format scheduling Msg4 doesn't include a flag for early SRS trigger, the UE transmits the early SRS upon receiving, subject to a delay as aforementioned the contention resolution message, or Msg4, or DCI Format scheduling Msg4.
In one example, if the UE transmits a preamble associated with “early SRS”, the contention resolution message, or Msg4, or DCI Format scheduling Msg4 includes a flag for early SRS trigger, based on the flag the UE transmits or doesn't transmit the early SRS upon receiving the contention resolution message, or Msg4, or DCI Format scheduling Msg4.
In one example, if the UE transmits a preamble/RO associated with “early SRS”, Msg4 or the DCI Format scheduling Msg4 includes a flag for the UE to monitor PDCCH carrying a DCI format that triggers early SRS transmission as aforementioned. In one example, the DCI Format triggering early SRS has CRC scrambled with a UE-specific RNTI (e.g., C-RNTI). In one example, the DCI Format triggering early SRS has CRC scrambled with UE-group common RNTI for early SRS. In one example, Msg4 includes the ULE-group common RNTI for early SRS. In one example, Msg4 includes an SRS configuration for early SRS. In one example, the SRS configuration for early SRS is based on xTyR capability, e.g., as indicated by the UE indicated in Msg1 and/or Msg3.
In one example, if the UE transmits a preamble/RO associated with “early SRS”, Msg4 or the DCI Format scheduling Msg4 includes a flag for the UE to monitor PDCCH carrying a DCI format scheduling a PDSCH (e.g., carrying MAC CE) that triggers early SRS transmission as aforementioned. In one example, the DCI Format scheduling the PDSCH that triggers early SRS has CRC scrambled with a UE-specific RNTI (e.g., C-RNTI). In one example, the DCI Format scheduling the PDSCH that triggers early SRS has CRC scrambled with UE-group common RNTI for early SRS. In one example, Msg4 includes the ULE-group common RNTI for early SRS. In one example, Msg4 includes an SRS configuration for early SRS. In one example, the SRS configuration for early SRS is based on xTyR capability, e.g., as indicated by the UE indicated in Msg1 and/or Msg3.

In one example, a field in the DCI Format scheduling Msg4 can indicate whether or not the UE is triggered to transmit early SRS in response to Msg4. In one example, the field is 1-bit, “1” indicates that early SRS is triggered in response to Msg4, and “0” indicates that early SRS is not triggered in response to Msg4, or vice versa. In one example, the field is 2-bits (or in general n-bits), wherein a first value of the filed indicates that early SRS is not triggered in response to Msg4, and, a second, third and fourth . . . values of the field indicate one of respective first, second and third, . . . configurations to use for early SRS. The first, second and third, . . . configurations can be configured in the SIB (e.g., SIB1), or provided by a configuration in Msg4.

In one example, when the field for indicating early SRS trigger is one-bit, the field for indicating early SRS trigger is provided by a bit (e.g., the MSB or LSB bit) of downlink assignment index field in the DCI Format scheduling Msg4. In one example, the second bit of the downlink assignment index field in the DCI Format scheduling Msg4 is reserved. In one example, the second bit of the downlink assignment index field in the DCI Format scheduling Msg4 is used to indicate a number of repetitions, if any, of PUCCH. In one example, whether the second bit of the downlink assignment index field in the DCI Format scheduling Msg4 is reserved or is used to indicate a number of repetitions, if any, of PUCCH Msg4 can be configured in the SIB.

In one example, when the field for indicating early SRS trigger is one-bit, the field for indicating early SRS trigger is provided by a bit (e.g., the MSB or LSB bit) of one of the following fields, the remaining bits can be used for the intended purpose:
Modulation and coding scheme (MCS) field, wherein the remaining bits (e.g., 4 bits) are used to indicate the MCS for Msg4.
Redundancy version (RV) field, wherein the remaining bits (e.g., 1 bit) is used to indicate the RV for Msg4 (e.g., RV can be 0 and 1, or 0 and 2, or 0 and 3).
HARQ process number (HPN) field, wherein the remaining bits (e.g., 3 bits) are used to indicate a HPN.
TPC command field, wherein the remaining bits (e.g., 1 bit) is used to indicate TPC value for PUCCH carrying Msg4 HARQ-ACK (e.g., a bit to indicate whether to increase or decrease power by a power step size in dB, or a bit to indicate whether to increase the power by a power step size in dB, or keep unchanged, or a bit to indicate whether to decrease the power by a power step size in dB, or keep unchanged)
PUCCH resource indicator (PRI) field, wherein the remaining bits (e.g., 2 bits) are used to indicate the PRI for Msg4 PUCCH.
PDSCH-to-HARQ feedback timing indicator (PHFTI) field, wherein the remaining bits (e.g., 2 bits) are used to indicate the PHFTI for Msg4 PUCCH.

In one example, when the field for indicating early SRS trigger is two-bits, the field for indicating early SRS trigger is provided by the downlink assignment index field in the DCI Format scheduling Msg4. In one example, whether the downlink assignment index field in the DCI Format scheduling Msg4 is reserved or is used for early SRS triggering and/or is used to indicate a number of repetitions, if any, of PUCCH Msg4 can be configured by the SIB (e.g., SIB1) or dynamically indicated by another field in the DCI Format scheduling Msg4.

In one example, when the field for indicating early SRS trigger is two-bits, the field is provided by two bits (e.g., the two MSB or two LSB bits of a field—when the field has more than 2 bits) of one of the following fields, the remaining bits can be used for the intended purpose:
Modulation and coding scheme (MCS) field, wherein the remaining bits (e.g., 3 bits) are used to indicate the MCS for Msg4.
Redundancy version (RV) field, wherein the RV of Msg4 is 0, e.g., RV field has 2 bits.
HARQ process number (HPN) field, wherein the remaining bits (e.g., 2 bits) are used to indicate a HPN.
TPC command field, wherein the power of the Msg4 PUCCH remains unchanged, e.g., TPC field has 2 bits.
PUCCH resource indicator (PRI) field, wherein the remaining bits (e.g., 1 bit) is used to indicate the PRI for Msg4 PUCCH.
PDSCH-to-HARQ feedback timing indicator (PHFTI) field, wherein the remaining bit (e.g., 1 bit) is used to indicate the PIHFTI for Msg4 PUCCH.

In one example, when the field for indicating early SRS trigger is two-bits, the field is provided by a first bit (e.g., the MSB or LSB bit of first field) of one of the following fields, and second bit (e.g., the MSB or LSB bit of a second field) of one of the following fields, the remaining bits can be used for the intended purpose:
Modulation and coding scheme (MCS) field, wherein the remaining bits (e.g., 4 bits) are used to indicate the MCS for Msg4.
Redundancy version (RV) field, wherein the remaining bits (e.g., 1 bit) is used to indicate the RV for Msg4 (e.g., RV can be 0 and 1, or 0 and 2, or 0 and 3).
HARQ process number (HPN) field, wherein the remaining bits (e.g., 3 bits) are used to indicate a HPN.
TPC command field, wherein the remaining bit (e.g., 1 bit) is used to indicate TPC value for PUCCH carrying Msg4 HARQ-ACK (e.g., a bit to indicated whether to increase or decrease power by a power step size in dB, or a bit to indicate whether to increase the power by a power step size in dB, or keep unchanged, or a bit to indicate whether to decrease the power by a power step size in dB, or keep unchanged)
PUCCH resource indicator (PRI) field, wherein the remaining bits (e.g., 2 bits) are used to indicate the PRI for Msg4 PUCCH.
PDSCH-to-HARQ feedback timing indicator (PHFTI) field, wherein the remaining bits (e.g., 2 bits) are used to indicate the PHFTI for Msg4 PUCCH.

In a variant example, a field is added to the DCI Format scheduling Msg4 for early SRS triggering. In one example, the field for early SRS triggering is 1-bit. In one example, the field for early SRS triggering is 2-bits. In one example, the field for early SRS triggering is n-bits. In one example, whether the field for early SRS triggering is added to the DCI Format scheduling Msg4, can be based on indication in Msg1 (PRACH preamble), or Msg3, e.g., based on whether or not the UE supports early SRS triggering. In one example, the size of the field added (e.g., n) can be based on configuration in SIB (e.g., SBI1 or SIB2), e.g., SIB can configure n or SIB can configure a number of early SRS configurations, N, for early SRS transmission, and n=┌log₂(N+1)┐, or =┌log₂ N┐.

In the aforementioned examples, Msg4 can be replaced by MsgB, and DCI Format scheduling Msg4 can be replaced by DCI Format scheduling MsgB, and Msg4 PUCCH can be replaced by MsgB PUCCH, and Msg1 (PRACH preamble) can be replaced MsgA PRACH, and Msg3 can be replaced MsgA PUSCH.

In the aforementioned examples, early SRS triggering, can be replaced by early CSI-RS measurement and/or early CSI reporting, wherein the trigger can be for early measuring of CSI-RS (or SSB) using configured resources (e.g., in SIB1 or in Msg4) and/or early reporting of CSI on uplink resources (e.g., PUCCH or PUSCH) wherein the UL resources and report configuration are configured by SIBI or in Msg4.

For brevity, only the contention resolution message is referred to in the following. Contention resolution message can refer, herein, to Msg4 or PDSCH carrying Msg4 or PDCCH or DCI scheduling Msg4.

In one example, a UE is indicated in the contention resolution message to transmit a SRS. In one example, a flag or a field in the contention resolution message can indicate whether the UE transmits SRS in response to receiving the contention resolution message.

In one example, a MAC CE in the contention resolution message can provide a configuration for SRS transmission by the UE.

In one example, the UE determines the early SRS resource or resources or SRS resource set(s) to transmit based in the antenna switching capability if known. In one example, the antenna switching capability (e.g., xTyR or whether it is supported or not) is signaled based on a preamble and/or RO index or group and/or signaling in Msg3 as aforementioned.

In one example, M SRS resources/or SRS resource sets are configured by system information. In one example, the SRS resource ID (and/or SRS resource set ID) transmitted by a UE is determined based on one or more of the following:
Based on a C-RNTI conveyed by the contention resolution, e.g. the n least significant bits of the C-RNTI, or the n most significant bits of the C-RNTI, or indicated ID is C-RNTI % N, or indicated ID is ceiling (C-RNTI/N).
Based on the C-RNTI (or UE-ID) the UE and the gNB can identify a SRS resource (e.g., SRS resource in a stored context associated with the C-RNTI or the UE-ID).
Based on a TC-RNTI used by the random access procedure, e.g. the n least significant bits of the TC-RNTI, or the n most significant bits of the TC-RNTI, or indicated ID is TC-RNTI % N, or indicated ID is ceiling (TC-RNTI/N).
Based on a UE-ID indicated in a paging message that triggered the random access procedure associated with the contention resolution.
Based on the preamble index associated with the random access procedure.
Based on the PRACH occasion (RO) associated with the RAR.
Based on the preamble index and PRACH occasion (RO) associated with the RAR.
Based on the group of the preamble and/or RO associated with the RAR as aforementioned.
Based on signaling in Msg3.
Based on the antenna switching capability or a default antenna switching capability if antenna switching capability is unknown at the time of early SRS transmission or early SRS triggering.
The time and/or frequency resources of a DCI format scheduling a contention resolution or of the contention resolution.
Based on the resource used for HARQ-ACK acknowledgment of contention resolution.
Based on an information provided by a MAC CE in the contention resolution message.

In one example, in case of antenna switching, with multiple SRS resources/or resource sets, an SRS resource ID (and/or SRS resource set ID) can be determined by or be linked or mapped to multiple SRS resources based on the antenna switching capability, and the corresponding number of SRS resources.

In one example, the network configures SRS resource(s)/or SRS resource set(s) for each preamble-ID. In one example, the network configures SRS resource(s)/or SRS resource set(s) for each RO within a frame. In one example, the network configures SRS resource(s)/or SRS resource set(s) for each RO within an association period. In one example, the network configures SRS resource(s)/or SRS resource set(s) for each RO within an association pattern period. In one example, the network configures SRS resource(s)/or SRS resource set(s) for each RO within N frames, wherein N is configured and/or updated RRC and/or MAC CE and L1 control (e.g., DCI format) signaling, or N is specified in the system specifications, e.g., N=16, or N=8.

In one example, the network configures SRS resource(s)/or SRS resource set(s) for each preamble-ID-RO pair. Wherein, RO can be:
Within a frame.
Within an association period.
Within an association pattern period.
Within N frames, wherein N is configured and/or updated RRC and/or MAC CE and Li control (e.g., DCI format) signaling, or N is specified in the system specifications, e.g., N=16, or N=8.

In one example, based on the antenna switching capability (e.g., xTyR) configured by the UE, a SRS configuration of one or more SRS resources or resource sets is configured by Msg4. In one example, based on the antenna switching capability (e.g., xTyR) indicated by the UE, a SRS configuration, configured in the SIB, is indicated in Msg4 (e.g., using SRS resource ID and/or SRS resource set ID). In one example, a set or list of resources or resource sets is configured by SIB for each xTyR capability and the UE is indicated a resource or resource set within the set or list of resources configured for capability xTyR indicated by the UE, e.g., indicated by the RA procedure. In one example, the network indicates a SRS resource/or resource sets, from the SRS resources/or resource sets configured by the SIB or Msg4, that supports the xTyR capability indicated by the UE in the RA procedure.

In one example, this mapping between the SRS resource ID (and/or SRS resource set ID) and the aforementioned parameters is based on a rule. In one example, this mapping between the SRS resource ID (and/or SRS resource set ID) and the aforementioned parameters is based on a network configuration. In one example, this mapping between the SRS resource ID (and/or SRS resource set ID) and the aforementioned parameters is based on a combination of a rule and network configuration.

In one example, the SRS resource ID (and/or SRS resource set ID) transmitted by a UE is determined based on one or more of the following:
A SRS ID of the M SRS resource IDs (and/or SRS resource set IDs) configured by system information, wherein the SRS resource ID (and/or SRS resource set ID) is included in the DCI Format scheduling the contention resolution and/or in the contention resolution message. In one example, the SRS resource IDs and/or SRS resource set IDs is further determined by the antenna switching capability (e.g., xTyR) indicated by the UE. In one example, multiple sets or lists of SRS resources or resource sets are configured, wherein a set is associated with a UE antenna switching capability xTyR, a SRS resource ID is indicated in the DCI Format scheduling the RAR/or Msg4 and/or the RAR/or Msg4 from the set corresponding UE's xTyR capability as indicated by the UE (e.g., in Msg1 and/or Msg3).
In a variant, the SRS configuration parameters (or a subset of them) for the SRS resource can be included in the DCI Format scheduling the contention resolution message or Msg4 and/or in the contention resolution message or Msg4 instead of or in addition to the SRS ID. Wherein the configuration parameters for the SRS resource can be as aforementioned. In one example, Msg4 or the DCI scheduling Msg4 includes a time T (e.g., slot and/or symbol and/or subframe and/or frame offset) that indicates when the early SRS or the first instance of the early SRS or the first slot of the early SRS is transmitted. In one example, the time T is from the trigger (e.g., start or end of Msg4 or start or end of DCI scheduling Msg4) or channel carrying the acknowledgment to the early SRS (or the slot of the early SRS).

In one example, the SRS resource can be transmitted at or after a time T after the end (or start) or time unit (e.g., slot) of the PDSCH reception providing the contention resolution message or of the PDCCH reception providing the DCI Format scheduling the contention resolution message associated with the UE transmitting SRS or channel carrying the acknowledgement. In one example, the slot or subframe or frame used to transmit SRS resource can be at or after a time T after the end (or start) or time unit (e.g., slot) of the PDSCH reception providing the contention resolution message or of the PDCCH reception providing the DCI Format scheduling the contention resolution message associated with the UE transmitting SRS or channel carrying the acknowledgement. In one example, the slot or subframe or frame used to transmit SRS resource is that first slot or subframe or frame that starts at or after a time T after the end (or start) or time unit (e.g., slot) of the PDSCH reception providing the contention resolution message or of the PDCCH reception providing the DCI Format scheduling the contention resolution message associated with the UE transmitting SRS or channel carrying the acknowledgement and optionally based on an offset and a periodicity as illustrated in FIG. 15A (the SRS instances can be one-shot, N-shots or semi-persistent), where SRS trigger can be replaced by the PDSCH providing the contention resolution message or the PDCCH providing the DCI Format scheduling the contention resolution message associated with the UE transmitting SRS transmission or channel carrying the acknowledgement (e.g., PUCCH in response to Mgs4). Wherein, the time T can be defined in the system specifications and/or configured or updated by network (e.g., using SIB signaling and/or RRC signaling and/or MAC CE signaling and/or L1 control signaling). In one example, the SRS transmission in FIG. 15A, can be one-shot, e.g., one instance of SRS, with a time T from the trigger of SRS (e.g., Msg4 or DCI scheduling Msg4) as aforementioned. In one example, the SRS transmission in FIG. 15A, can be N-shots, e.g., N-instances of SRS, with a periodicity P between each two-consecutive instances, and a minimum time T from the trigger, for the first instance, as aforementioned. In one example, the UE transmits the early SRS in one instance (e.g., first instance after delay T). In one example, the UE transmits the early SRS in N instances (e.g., first N instances after delay T). In one example, the UE transmits the early SRS in one SRS slot (e.g., first SRS slot after delay T), wherein SRS slot can include one or more SRS instances as aforementioned. In one example, the ULE transmits the early SRS in N SRS slots (e.g., first N SRS slots after delay T), wherein SRS slot can include one or more SRS instances as aforementioned. In one example, the semi-persistent (SP) early SRS is triggered until it is deactivated. In one example, the SRS transmission corresponds to the resources of the triggered SRS resource set(s).

In one example, T can be configured and/or updated by SIB configuration and/or RAR (Msg2) or DCI scheduling the RAR and/or Msg4 or DCI scheduling Msg4. In one example, T is selected so that the SRS is transmitted shortly before start of data transmission in connected mode, so that channel sounding result is fresh when data transmission starts.

In one example, SRS offset and/or SRS periodicity P can be configured and/or updated by SIB and/or Msg4 or DCI scheduling Msg4.

In one example, the delay, T, as number of slots is based on sub-carrier spacing (SCS) of DCI format scheduling Msg4 or the PDSCH carrying Msg4 or SRS or largest/smallest SCS of DCI Format scheduling Msg4 and/or PDSCH carrying Msg4 and/or SRS and/or channel carrying corresponding acknowledgment.

In one example, the slot or subframe or frame used by a UE to transmit SRS resource can be at a time T from the end (or start) or time unit (e.g., slot) of the PDCCH scheduling Msg4 triggering the SRS transmission or channel carrying the acknowledgement. In one example, the slot or subframe or frame used by a UE to transmit SRS resource can be at a time T from the end (or start) or time unit (e.g., slot) of the PDSCH carrying Msg4 triggering the SRS transmission or channel carrying the acknowledgement. In one example, the SRS is transmitted in multiple SRS slots starting at T after the trigger (e.g., DCI Format triggering early SRS) and repeated with a periodicity P as illustrated in FIG. 13C. Wherein, the time T and/or P can be defined in the system specifications and/or configured or updated by network (e.g., using SIB signaling and/or RRC signaling and/or MAC CE signaling and/or L1 control signaling). In one example, the SRS transmission in FIG. 13, can be one-shot, e.g., one instance of SRS, with a time T from the trigger of SRS (e.g., Msg4 or PDCCH scheduling Msg4 or channel carrying the acknowledgement) as aforementioned. In one example, the SRS transmission in FIG. 13C, can be N-shots, e.g., N-instances of SRS, with a periodicity P between each two-consecutive instances, and a time T from the trigger, for the first instance, as aforementioned. In one example, the UE transmits the early SRS in one instance (e.g., first instance after delay T). In one example, the UE transmits the early SRS in N instances (e.g., first N instances after delay T). In one example, the UE transmits the early SRS in one SRS slot (e.g., first SRS slot after delay T), wherein SRS slot can include one or more SRS instances as aforementioned. In one example, the UE transmits the early SRS in N SRS slots (e.g., first N SRS slots after delay T), wherein SRS slot can include one or more SRS instances as aforementioned. In one example, the semi-persistent (SP) early SRS is triggered until it is deactivated. In one example, the SRS transmission corresponds to the resources of the triggered SRS resource set(s).

In one example, T can be configured and/or updated by SIB configuration and/or RAR (Msg2) or DCI scheduling the RAR and/or Msg4 or DCI scheduling Msg4. In one example, T is selected so that the SRS is transmitted shortly before start of data transmission in connected mode, so that channel sounding result is fresh when data transmission starts.

In one example, SRS periodicity P can be configured and/or updated by SIB and/or Msg4 or DCI scheduling Msg4.

In one example, the delay, T, as number of slots is based on sub-carrier spacing (SCS) of DCI format scheduling Msg4 or the PDSCH carrying Msg4 or SRS or largest/smallest SCS of DCI Format scheduling Msg4 and/or PDSCH carrying Msg4 and/or SRS and/or channel carrying the acknowledgement.

In one example, an SRS transmission is triggered in MsgB of a Type-2 random access procedure (the following can also apply to Msg4 of a Type-1 random access procedure, with Msg4 replacing MsgB). In one example, MsgB is for successRAR. In one example, MsgB is for a fallback RAR. In one example, an SRS transmission is triggered in MsgB successRAR of a contention-based random access procedure. In one example, an SRS transmission is triggered in MsgB fallbackRAR of a contention-free random access procedure. In one example, the SRS is triggered in a successRAR or fallbackRAR if the UE supports early SRS. In one example, the indication of the support of early SRS is indicated by the preamble and/or PRACH Occasion (RO) used for the Type-2 random access procedure. For example, the preambles and/or ROs of the MsgA PRACH can be partitioned into 2 groups g₀, g₁, if a UE doesn't support early SRS or doesn't request early SRS a preamble and/or RO in the first group is used (e.g. g₀), if a UE supports early SRS or supports and requests early SRS, a preamble and/or RO in the second group is used (e.g. g₁). In a variant example, there are N groups of preambles and/or ROs, as aforementioned, wherein the N groups can indicate the UE's capability to support or not support early SRS, and/or the capability of the UE in regard to SRS antennas switching as aforementioned.

In one example, the indication of the support of early SRS is indicated by MsgA PUSCH of the random access procedure. In a variant example, MsgA PUSCH can indicate the UE's capability to support or not support early SRS, and/or the capability of the UE in regard to SRS antennas switching as aforementioned. In a variant example, the UE's capability to support or not support early SRS, and/or the antenna switching capability is conveyed by a combination of signaling in the preamble/RO of MsgA PRACH (e.g., based on preamble and/or RO group as aforementioned) and signaling in MsgA PUSCH. In one example, early SRS capability in MsgA is indicated by 1 bit in RRC message or using a specific LCID/eLCID in MAC PDU.

In one example, a UE is configured e.g., by a field or flag in the system information to transmit SRS in response to receiving a MsgB. The SRS transmission can be further conditioned on whether the UE transmits an associated MsgA PRACH preamble/RO from a first group of preambles/ROs or from a second group of preambles/ROs indicated in the system information. In one example, if a UE is configured by system information with a first set of preamble for “no early” SRS and a second of preambles for “early SRS”, the UE can:
If the UE transmits a preamble/RO associated with “no early SRS”, the UE doesn't expect to receive a trigger for early SRS in the successRAR or fallbackRAR or MsgB. In a variant example, if a UE receives a trigger for early SRS in the successRAR or fallbackRAR or MgsB, the UE ignores the trigger.
In one example, if the UE transmits a preamble/RO associated with “early SRS”, the successRAR or fallbackRAR or MsgB or DCI scheduling MsgB doesn't include a flag for early SRS trigger, the UE transmits the early SRS upon receiving the successRAR or fallbackRAR or MsgB.
In one example, if the UE transmits a preamble/RO associated with “early SRS”, the successRAR or fallbackRAR or MsgB or DCI scheduling MsgB includes a flag for early SRS trigger, based on the flag the UE transmits or doesn't transmit the early SRS upon receiving the successRAR or fallbackRAR or MsgB.
In one example, if the UE transmits a preamble/RO associated with “early SRS”, the successRAR or fallbackRAR or MsgB or the DCI format scheduling MsgB includes a flag for the UE to monitor PDCCH carrying a DCI format that triggers early SRS transmission as aforementioned. In one example, the DCI Format triggering early SRS has CRC scrambled with a UE-specific RNTI (e.g., C-RNTI). In one example, the DCI Format triggering early SRS has CRC scrambled with UE-group common RNTI for early SRS. In one example, MsgB includes the UE-group common RNTI for early SRS. In one example, MsgB includes an SRS configuration for early SRS. In one example, the SRS configuration for early SRS is based on xTyR capability, e.g., as indicated by the UE indicated in MsgA PRACH and/or MsgA PUSCH.
In one example, if the UE transmits a preamble/RO associated with “early SRS”, the successRAR or fallbackRAR or MsgB or the DCI format scheduling MsgB includes a flag for the UE to monitor PDCCH carrying a DCI format scheduling a PDSCH (e.g., carrying MAC CE) that triggers early SRS transmission as aforementioned. In one example, the DCI Format scheduling the PDSCH that triggers early SRS has CRC scrambled with a UE-specific RNTI (e.g., C-RNTI). In one example, the DCI Format scheduling the PDSCH that triggers early SRS has CRC scrambled with UE-group common RNTI for early SRS. In one example, MsgB includes the UE-group common RNTI for early SRS. In one example, MsgB includes an SRS configuration for early SRS. In one example, the SRS configuration for early SRS is based on xTyR capability, e.g., as indicated by the UE indicated in MsgA PRACH and/or MsgA PUSCH.

In one example, a UE is indicated in the MsgB to transmit a SRS. In one example, a flag or a field in the MsgB or DCI scheduling MsgB can indicate whether the UE transmits SRS in response to receiving the MsgB. In one example, MsgB can include a fallback RAR. In one example, MsgB can include a success RAR. In one example, a field in the MAC sub-header for success RAR or the fallback RAR, e.g., a reserved field in the MAC sub-header for the success RAR or fallback RAR can be used to trigger the SRS, for example, a value of “1” triggers the SRS, and a value of “0” doesn't trigger the SRS or a field in a DCI scheduling MsgB. In one example, a field in the success RAR or fallback RAR or DCI scheduling MsgB, e.g., a reserved field in the success RAR or fallback RAR can be used to trigger the SRS, for example, a value of “1” triggers the SRS, and a value of “0” doesn't trigger the SRS.

In one example, a UE is indicated by a flag (e.g., one-bit flag) or a special bit pattern in the MsgB (e.g., fallbackRAR or successRAR) or DCI scheduling MsgB to transmit SRS. In one example, the UE transmits SRS instead of or in place of PUSCH Msg3. In one example, the UE transmits SRS in addition to PUSCH Msg3, e.g., scheduled by fallbackRAR, (before or after PUSCH Msg3). In one example, the flag (e.g., one-bit flag) is included in the MAC sub-header for the success RAR or fallback RAR, e.g., for Type-2 Random Access Procedure. In one example, the flag (e.g., one-bit flag) is included in MsgB (e.g., fallbackRAR or successRAR) or DCI scheduling MsgB, e.g., for Type-2 Random Access Procedure. In one example, the flag (e.g., one-bit flag) is included in the UL Grant of MsgB (e.g., fallbackRAR), e.g., for Type-2 Random Access Procedure. In one example, a special bit pattern of fields in the UL Grant of MsgB (e.g., fallbackRAR), e.g., for Type-2 Random Access Procedure, indicates transmission of SRS. In one example, the flag (e.g., one-bit flag) is included in the DCI scheduling PDSCH of MsgB (e.g., fallbackRAR or successRAR). In one example, a special bit pattern of fields in the DCI scheduling the PDSCH of MsgB (e.g., fallbackRAR or successRAR) indicates transmission of SRS.

In one example, a UE is indicated by a SRS resource in MsgB (e.g., fallbackRAR or successRAR) or DCI scheduling MsgB to use for SRS transmission. In one example, the UE transmits SRS instead of or in place of PUSCH Msg3. In one example, the UE transmits SRS in addition to PUSCH Msg3, e.g., scheduled by fallbackRAR, (before or after PUSCH Msg3). In one example, the SRS resource is included in MsgB (e.g., fallbackRAR or successRAR) or DCI scheduling MsgB, e.g., for Type-2 Random Access Procedure. In one example, the SRS resource is included in the UL Grant of MsgB (e.g., fallbackRAR), e.g., for Type-2 Random Access Procedure. In one example, the SRS resource is included in the DCI scheduling the PDSCH of MsgB (e.g., fallbackRAR or successRAR). In one example, the SRS resource is linked to (associated with) the preamble index. In one example, the SRS resource is linked to (associated with) the PRACH occasion. In one example, the SRS resource is linked to (associated with) the preamble index and the PRACH occasion. In one example, the preambles and/or ROs of MsgA PRACH are partitioned into N groups as aforementioned, the UE can determine the SRS resource based on the group of the preamble and/or RO, e.g., based on the antenna switching capability, in one example, one of the groups can be associated with no early SRS transmission. In one example, the SRS resource includes a SRS resource ID and/or SRS resource set ID configured to the UE from a list of SRS resources and/or a list of SRS resource sets configured to the UE, wherein the configuration can be by SIB signaling or by RRC signaling. In one example, the SRS resource includes configuration/scheduling parameters for the SRS, such as time domain resources (e.g., symbol(s) in a slot to use for SRS, time offset from MsgB (e.g., fallbackRAR or successRAR) or channel carrying acknowledgment to MsgB, or time offset within a period, SRS period, etc.), frequency domain resources (e.g., starting RB, number of RBs, frequency hopping pattern, etc.), comb parameters (e.g., comb size, comb offset, cyclic shift, etc.), sequence, sequence hopping (e.g., group hopping, sequence hopping or neither, etc.). In one example, the UL grant of the fallbackRAR includes parameters to schedule the SRS resource. In one example, the successRAR includes an UL grant with parameters to schedule the SRS resource.

In one example, a UE is indicated by a flag (e.g., one-bit flag) or a special bit pattern in MsgB (e.g., fallbackRAR or successRAR) or DCI scheduling MsgB to transmit SRS and is indicated an SRS resource in MsgB (e.g., fallbackRAR or successRAR) or DCI scheduling MsgB. In one example, the UE transmits SRS instead of or in place of PUSCH Msg3, e.g., scheduled by fallbackRAR. In one example, the UE transmits SRS in addition to PUSCH Msg3 (before or after PUSCH Msg3). In one example, the SRS resource includes a SRS resource ID and/or SRS resource set ID configured to the UE from a list of SRS resources and/or a list of SRS resource sets configured to the UE, wherein the configuration can be by SIB signaling or by RRC signaling. In one example, the SRS resource includes configuration/scheduling parameters for the SRS, such as time domain resources (e.g., symbol(s) in a slot to use for SRS, time offset from MsgB (e.g., fallbackRAR or successRAR) or channel carrying acknowledgment to MsgB, or time offset within a period, SRS period, etc.), frequency domain resources (e.g., starting RB, number of RBs, frequency hopping pattern, etc.), comb parameters (e.g., comb size, comb offset, cyclic shift, etc.), sequence, sequence hopping (e.g., group hopping, sequence hopping or neither, etc.). In one example, the UL grant of the fallbackRAR includes parameters to schedule the SRS resource. In one example, the successRAR includes an UL grant with parameters to schedule the SRS resource.

In one example, the UE determines the early SRS resource or resources to transmit based in the antenna switching capability if known. In one example, the antenna switching capability (e.g., xTyR or whether it is supported or not) is signaled based on a preamble and/or RO index or group of MsgA PRACH and/or signaling in MsgA PUSCH as aforementioned.

In one example, M SRS resources are configured by system information. In one example, the SRS resource ID (and/or SRS resource set ID) transmitted by a UE is determined based on one or more of the following:
Based on a C-RNTI conveyed by the MsgB, e.g. the n least significant bits of the C-RNTI, or the n most significant bits of the C-RNTI, or indicated ID is C-RNTI % N, or indicated ID is ceiling (C-RNTI/N).
Based on the C-RNTI (or UE-ID) the ULE and the gNB can identify a SRS resource (e.g., SRS resource in a stored context associated with the C-RNTI or the UE-ID).
Based on a TC-RNTI used by the random access procedure, e.g. the n least significant bits of the TC-RNTI, or the n most significant bits of the TC-RNTI, or indicated ID is TC-RNTI % N, or indicated ID is ceiling (TC-RNTI/N).
Based on a UE-ID indicated in a paging message that triggered the random access procedure associated with the MsgB.
Based on the preamble index associated with the random access procedure.
Based on the PRACH occasion (RO) associated with the RAR.
Based on the preamble index and PRACH occasion (RO) associated with the RAR.
Based on the group of the preamble and/or RO of MsgA PRACH associated with the successRAR or fallbackRAR as aforementioned.
Based on signaling in MsgB or DCI scheduling MsgB.
Based on the antenna switching capability or a default antenna switching capability if antenna switching capability is unknown at the time of early SRS transmission or early SRS triggering
The time and/or frequency resources of a DCI format scheduling a MsgB or of the MsgB.
Based on the resource used for HARQ-ACK acknowledgment of MsgB.

In one example, in case of antenna switching, with multiple SRS resources/or resource sets, an SRS resource ID (and/or SRS resource set ID) can be determined by or be linked or mapped to multiple SRS resources/or resource sets based on the antenna switching capability, and the corresponding number of SRS resources.

In one example, the network configures SRS resource(s)/or SRS resource set(s) for each preamble-ID. In one example, the network configures SRS resource(s)/or SRS resource set(s) for each RO within a frame. In one example, the network configures SRS resource(s)/or SRS resource set(s) for each RO within an association period. In one example, the network configures SRS resource(s)/or SRS resource set(s) for each RO within an association pattern period. In one example, the network configures SRS resource(s)/or SRS resource set(s) for each RO within N frames, wherein N is configured and/or updated RRC and/or MAC CE and L1 control (e.g., DCI format) signaling, or N is specified in the system specifications, e.g., N=16, or N=8.

In one example, the network configures SRS resource(s)/or SRS resource set(s) for each preamble-ID-RO pair. Wherein, RO can be:
Within a frame.
Within an association period.
Within an association pattern period.
Within N frames, wherein N is configured and/or updated RRC and/or MAC CE and Li control (e.g., DCI format) signaling, or N is specified in the system specifications, e.g., N=16, or N=8.

In one example, based on the antenna switching capability (e.g., xTyR) configured by the UE, a SRS configuration of one or more SRS resources or resource sets is configured by MsgB. In one example, based on the antenna switching capability (e.g., xTyR) indicated by the UE, a SRS configuration, configured in the SIB, is indicated in MsgB (e.g., using SRS resource ID and/or SRS resource set ID). In one example, a set or list of resources or resource sets is configured by SIB for each xTyR capability and the UE is indicated a resource within the set or list of resources or resource sets configured for capability xTyR indicated by the UE, e.g., indicated by the RA procedure. In one example, the network indicates a SRS resource/or resource set, from the SRS resources/or resource sets configured by the SIB or MsgB, that supports the xTyR capability indicated by the UE in the RA procedure.

In one example, this mapping between the SRS resource ID (and/or SRS resource set ID) and the aforementioned parameters is based on a rule. In one example, this mapping between the SRS resource ID (and/or SRS resource set ID) and the aforementioned parameters is based on a network configuration. In one example, this mapping between the SRS resource ID (and/or SRS resource set ID) and the aforementioned parameters is based on a combination of a rule and network configuration.

In one example, the SRS resource ID (and/or SRS resource set ID) transmitted by a UE is determined based on one or more of the following:
A SRS ID of the M SRS resource IDs (and/or SRS resource set IDs) configured by system information, wherein the SRS resource ID (and/or SRS resource set ID) is included in the DCI Format scheduling the MsgB and/or the MsgB. In one example, the SRS resource IDs and/or SRS resource set IDs is further determined by the antenna switching capability (e.g., xTyR) indicated by the UE. In one example, multiple sets or lists of SRS resources are configured, wherein a set is associated with a UE antenna switching capability xTyR, a SRS resource ID is indicated in the DCI Format scheduling the RAR/or MsgB and/or the RAR/or MsgB from the set corresponding UE's xTyR capability as indicated by the UE (e.g., in MsgA PRACH and/or MsgA PUSCH).
In a variant, the SRS configuration parameters (or a subset of them) for the SRS resource can be included in the DCI Format scheduling the MsgB and/or the MsgB instead of or in addition to the SRS ID. Wherein the configuration parameters for the SRS resource can be as aforementioned. In one example, MsgB or the DCI scheduling MsgB includes a time T (e.g., slot and/or symbol and/or subframe and/or frame offset) that indicates when the early SRS or the first instance of the early SRS or the first slot of the early SRS is transmitted. In one example, the time T is from the trigger (e.g., start or end of MsgB or start or end of DCI scheduling MsgB) or channel carrying the acknowledgement to the early SRS (or the slot of the early SRS).

In one example, the SRS resource can be transmitted at or after a time T after the end (or start) or time unit (e.g., slot) of the PDSCH reception providing MsgB or of the PDCCH reception providing the DCI Format scheduling the MsgB associated with the UE transmitting SRS or channel carrying the acknowledgement (e.g., PUCCH carrying MsgB ACK). In one example, the slot or subframe or frame used to transmit SRS resource can be at or after a time T after the end (or start) or time unit (e.g., slot) of the PDSCH reception providing MsgB or of the PDCCH reception providing the DCI Format scheduling the MsgB associated with the UE transmitting SRS or channel carrying the acknowledgement. In one example, the slot or subframe or frame used to transmit SRS resource is that first slot or subframe or frame that starts at or after a time T after the end (or start) or time unit (e.g., slot) of the PDSCH reception providing MsgB or of the PDCCH reception providing the DCI Format scheduling the MsgB associated with the UE transmitting SRS or channel carrying the acknowledgement and optionally based on an offset and a periodicity as illustrated in FIG. 13 (the SRS instances can be one-shot, N-shots or semi-persistent), where SRS trigger can be replaced by the MsgB or the PDCCH reception providing the DCI Format scheduling the MsgB associated with the UE transmitting SRS or channel carrying the acknowledgement. Wherein, the time T can be defined in the system specifications and/or configured or updated by network (e.g., using SIB signaling and/or RRC signaling and/or MAC CE signaling and/or L1 control signaling). In one example, the SRS transmission in FIG. 13, can be one-shot, e.g., one instance of SRS, with a time T from the trigger of SRS (e.g., MsgB or DCI scheduling MsgB or channel carrying the acknowledgement) as aforementioned. In one example, the SRS transmission in FIG. 13, can be N-shots, e.g., N-instances of SRS, with a periodicity P between each two-consecutive instances, and a minimum time T from the trigger, for the first instance, as aforementioned. In one example, the UE transmits the early SRS in one instance (e.g., first instance after delay T). In one example, the UE transmits the early SRS in N instances (e.g., first N instances after delay T). In one example, the UE transmits the early SRS in one SRS slot (e.g., first SRS slot after delay T), wherein SRS slot can include one or more SRS instances as aforementioned. In one example, the UE transmits the early SRS in N SRS slots (e.g., first N SRS slots after delay T), wherein SRS slot can include one or more SRS instances as aforementioned. In one example, the semi-persistent (SP) early SRS is triggered until it is deactivated. In one example, the SRS transmission corresponds to the resources of the triggered SRS resource set(s).

In one example, T can be configured and/or updated by SIB configuration and/or MsgB or DCI scheduling MsgB. In one example, T is selected so that the SRS is transmitted shortly before start of data transmission in connected mode, so that channel sounding result is fresh when data transmission starts.

In one example, SRS offset and/or SRS periodicity P can be configured and/or updated by SIB and/or MsgB or DCI scheduling MsgB.

In one example, the delay, T, as number of slots is based on sub-carrier spacing (SCS) of DCI format scheduling MsgB or the PDSCH carrying MsgB or SRS or largest/smallest SCS of DCI Format scheduling MsgB and/or PDSCH carrying MsgB and/or SRS and/or channel carrying the acknowledgement.

In one example, the slot or subframe or frame used by a UE to transmit SRS resource can be at a time T from the end (or start) or time unit (e.g., slot) of the PDCCH scheduling MsgB triggering the SRS transmission or channel carrying the acknowledgement. In one example, the slot or subframe or frame used by a UE to transmit SRS resource can be at a time T from the end (or start) or time unit (e.g., slot) of the PDSCH carrying MsgB triggering the SRS transmission or channel carrying the acknowledgement. In one example, the SRS is transmitted in multiple SRS slots starting at T after the trigger (e.g., DCI Format triggering early SRS or channel carrying the acknowledgement) and repeated with a periodicity P as illustrated in FIG. 13C. Wherein, the time T and/or P can be defined in the system specifications and/or configured or updated by network (e.g., using SIB signaling and/or RRC signaling and/or MAC CE signaling and/or L1 control signaling). In one example, the SRS transmission in FIG. 13, can be one-shot, e.g., one instance of SRS, with a time T from the trigger of SRS (e.g., MsgB or PDCCH scheduling MsgB or channel carrying the acknowledgement) as aforementioned. In one example, the SRS transmission in FIG. 13C, can be N-shots, e.g., N-instances of SRS, with a periodicity P between each two-consecutive instances, and a time T from the trigger, for the first instance, as aforementioned. In one example, the UE transmits the early SRS in one instance (e.g., first instance after delay T). In one example, the UE transmits the early SRS in N instances (e.g., first N instances after delay T). In one example, the UE transmits the early SRS in one SRS slot (e.g., first SRS slot after delay T), wherein SRS slot can include one or more SRS instances as aforementioned. In one example, the UE transmits the early SRS in N SRS slots (e.g., first N SRS slots after delay T), wherein SRS slot can include one or more SRS instances as aforementioned. In one example, the semi-persistent (SP) early SRS is triggered until it is deactivated. In one example, the SRS transmission corresponds to the resources of the triggered SRS resource set(s).

In one example, T can be configured and/or updated by SIB configuration and/or MsgB or DCI scheduling the MsgB. In one example, T is selected so that the SRS is transmitted shortly before start of data transmission in connected mode, so that channel sounding result is fresh when data transmission starts.

In one example, SRS periodicity P can be configured and/or updated by SIB and/or MsgB or DCI scheduling MsgB. In one example, the delay, T, as number of slots is based on sub-carrier spacing (SCS) of DCI format scheduling MsgB or the PDSCH carrying MsgB or SRS or largest/smallest SCS of DCI Format scheduling MsgB and/or PDSCH carrying MsgB and/or SRS and/or channel carrying corresponding acknowledgment.

In the aforementioned examples,
UE transmits a preamble for a Type-1 random access procedure or a Type-2 random access procedure. In one example, a Type-2 random access procedure includes a PRACH and a PUSCH.
In one example, the preambles and/or ROs are partitioned into 2 groups or into groups, wherein the preamble and/or RO group used for the random access procedure can indicate whether or not the UE supports early SRS. In other examples, the preamble and/or RO group used for the random access procedure can indicate an SRS antenna switching capability (xTyR) or the UE doesn't support SRS antenna switching.
In one example, for Type-2 random access procedure, MsgA PRACH (based on preamble and/or RO group) and/or MsgA PUSCH (based on signaling in MsgA PUSCH) can indicate capability of UE to support early SRS and/or SRS antenna switching capability (xTyR) or the UE doesn't support SRS antenna switching.
The network responds to the preamble of the Type-1 random access procedure or the Type-2 random access procedure, with a RAR or a success RAR or a fallback RAR.
   In one example, the RAR or a success RAR or a fallback RAR or MsgB or corresponding DCI Format includes a trigger for SRS.
   In one example, the RAR or a success RAR or a fallback RAR or MsgB or corresponding DCI Format includes a flag for the UE to monitor a PDCCH carrying a DCI for triggering the early SRS, or a PDCCH carrying a DCI for scheduling a PDSCH for triggering the early SRS.
   In one example, the RAR or a success RAR or a fallback RAR or corresponding DCI Format indicates a resource(s) for SRS, e.g., explicitly or based on preamble ID or RO or TC-RNTI or C-RNTI or antenna switching capability if known, or default antenna switching capability as aforementioned. In one example, the resources indicated are configured by the SIB.
   In one example, the SRS resource(s) is transmitted before Msg3.
   In one example, the SRS resource(s) is transmitted after Msg3. In a further example, Msg3 can indicate capability of UE to support early SRS and/or SRS antenna switching capability (xTyR) or the UE doesn't support SRS antenna switching, transmission of early SRS and/or early SRS resource(s) can be based on signaling in Msg3,
   In one example, the SRS resource is transmitted with (or as part of) Msg3.
   In one example, the SRS resource is transmitted after Msg4.
   In one example, the SRS resource is transmitted after UE is in connected state.
For type 1 random access procedure, the UE transmits Msg3. In one example, Msg3 includes C-RNTI MAC CE or CCCH SDU.
In one example, for Type-1 random access procedure, Msg3 (based on preamble and/or RO group) and/or MsgA PUSCH (based on signaling in MsgA PUSCH) can indicate capability of UE to support early SRS and/or SRS antenna switching capability (xTyR) or the UE doesn't support SRS antenna switching
The network responds to the Msg3 of the Type-1 random access procedure with a Msg4
   In one example, the Msg4 or corresponding DCI Format (DCI scheduling Msg4) includes a trigger for SRS,
   In one example, the Msg4 or corresponding DCI Format (DCI scheduling Msg4) indicates a resource for SRS, e.g., explicitly or based on preamble ID or RO or TC-RNTI or C-RNTI or antenna switching capability if known, or default antenna switching capability as aforementioned.
   In one example, the SRS resource is transmitted after UE is in connected state.

In the aforementioned examples, the early SRS is triggered in Msg2 or Msg4 or MsgB and the transmission of early SRS occurs after Msg5 (e.g., connection setup complete or resume setup complete).

In one example, the early SRS capability and/or SRS antenna switching capability is indicated in Msg5 (e.g., connection setup complete or resume setup complete).

In one example, the early SRS capability and/or SRS antenna switching capability is indicated in a PUCCH and/or PUSCH message the UE transmits after Msg5 (e.g., connection setup complete or resume setup complete).

In one example, the early SRS capability and/or SRS antenna switching capability is indicated in a PUCCH and/or PUSCH message the UE transmits after UE capability exchange between UE and gNB.

In one example, the early SRS capability and/or SRS antenna switching capability is determined after network determines UE context associated with the UE triggering the random access procedure for a UE in the INACTIVE state. In one example, the early SRS capability and/or SRS antenna switching capability is determined after Resume Request message (e.g., Msg3) for a UE in the INACTIVE state.

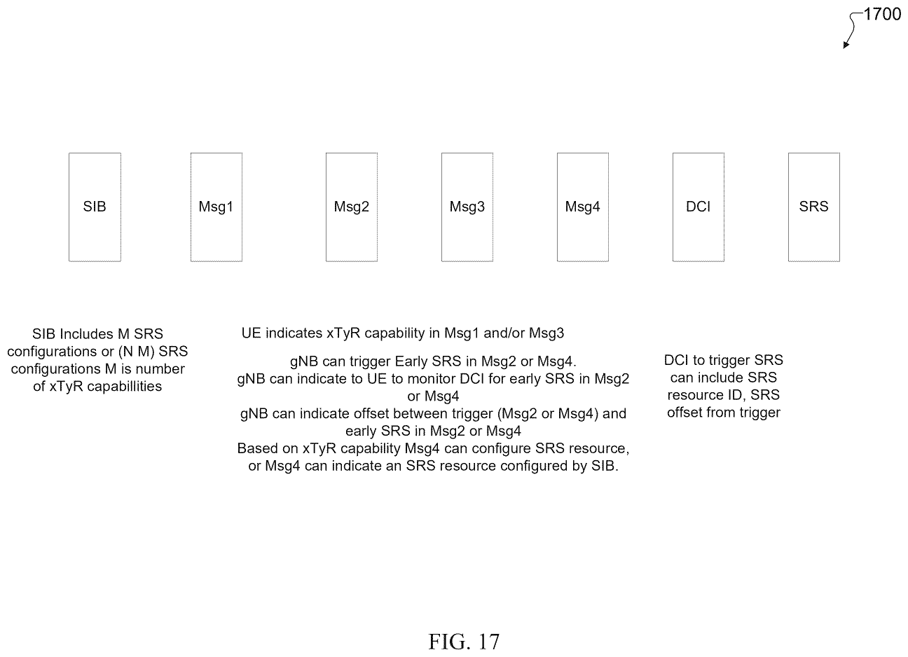

FIG. 17 illustrates an example procedure 1700 for early SRS transmission according to embodiments of the present disclosure. The example procedure 1700 shown in FIG. 17 is for illustration only and other embodiments can be used without departing from the scope of the present disclosure.

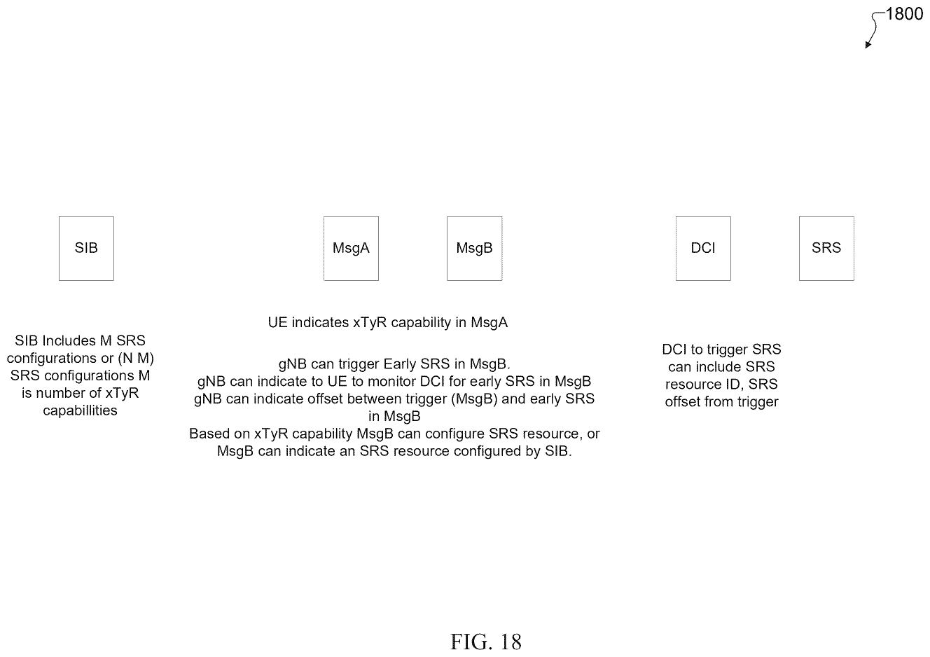

FIG. 18 illustrates another example procedure 1800 for early SRS transmission according to embodiments of the present disclosure. The example procedure 1800 shown in FIG. 18 is for illustration only and other embodiments can be used without departing from the scope of the present disclosure.

In FIGS. 17 and 18, SIB can provide the following information to the UE:
Whether the network supports (or not) early SRS.
Whether the network supports (or not) DCI Format for triggering early SRS
Whether the network supports (or not) MAC CE or PDSCH for triggering early SRS
A set of resources for early SRS.
   In one example the SRS resources or resource sets can be mapped or linked to a preamble and/or RO used by the UE in a random access procedure.
   In one example the SRS resources or resource sets can be a pool of resources (e.g., pooled across antenna switching xTyR capabilities). The UE can be indicated a resource or resource set from the resources or resource sets based on the UE's antenna switching capability (xTyR).
   In one example, multiple sets or list of SRS resources or resource sets are configured, wherein each set or list can be associated with a UE antenna switching capability (xTyR).
An offset or list of offsets for transmission of early SRS, the offset is between the early SRS trigger or reference and the transmission of early SRS.

In FIG. 17 for a Type-1 random access procedure, the UE can indicate its xTyR capability in Msg1 and/or Msg3. For example, this can be based on a preamble used for the random access procedure (preamble partitioning among xTyR capabilities). Alternatively, signaling in Msg3 can indicate the xTyR capability. Alternatively, a combination of signaling in Msg1 and Msg3 can indicate the xTyR capability.

In FIG. 18 for a Type-2 random access procedure, the UE can indicate its xTyR capability in MsgA. For example, this can be based on a preamble of MsgA PRACH used for the random access procedure (preamble partitioning among xTyR capabilities). Alternatively, signaling in MsgA PUSCH can indicate the xTyR capability. Alternatively, a combination of signaling in MsgA PRACH and MsgA PUSCH can indicate the xTyR capability.

In FIGS. 17 and 18, depending on the Type of random access procedure, the network after it knows the UE's antenna switching capability can trigger early SRS resource. In one example, the early SRS resource can be a one-shot early SRS transmitted in one SRS instance or one SRS slot. In one example, the early SRS resource can be a N-shot early SRS transmitted in N SRS instances or N SRS slots, e.g., with a periodicity P. In one example, the early SRS resource can be semi-persistent SRS that is transmitted periodically. At a later time, a DCI Format or PDSCH (e.g., with MAC CE) can deactivate the semi-persistent SRS.

In one example, the early SRS can be triggered (e.g., for aperiodic, 1-shot or N-shot SRS) or activated (e.g., for semi-persistent SRS) in Msg2 or Msg4 or MsgB or the DCI Format scheduling Msg2 or Msg4 or MsgB. Msg2 or Msg4 or MsgB or the DCI Format scheduling Msg2 or Msg4 or MsgB can indicate a resource ID for early SRS from the SRS resources or resource sets configured by SIB, the SRS resource or resource set indicated can be based on the UE's xTyR capability. In a variant example, Msg4 or MsgB or corresponding DCI Format can include a SRS configuration with one or more SRS resources (e.g., based on UE's xTyR capability), one of which can be used for early SRS.

In one example, Msg2 or Msg4 or MsgB or the DCI Format scheduling Msg2 or Msg4 or MsgB can indicate an offset for transmission of early SRS, the offset is between the early SRS trigger or reference and the transmission of early SRS. For example, the offset can be to delay the SRS transmission to start just before the transmission of the data to have a fresh estimate of the channel.

In one example, Msg2 or Msg4 or MsgB or the DCI Format scheduling Msg2 or Msg4 or MsgB can indicate by a flag support for DCI Format of SRS triggering or PDSCH (e.g., carrying MAC CE) for SRS triggering. In one example, Msg2 or Msg4 or MsgB or the DCI Format scheduling Msg2 or Msg4 or MsgB can indicate the RNTI for early SRS. In one example, Msg2 or Msg4 or MsgB or the DCI Format scheduling Msg2 or Msg4 or MsgB can indicate a block within the DCI format or PDSCH for early SRS for the UE.

In one example, the early SRS transmission can be triggered by a DCI Format or by a PDSCH (e.g., carrying a MAC CE). In one example, the DCI Format can be UE specific. In one example, the DCI Format can be UE-group common. In one example, the DCI Format or PDSCH can indicate the SRS resource or resource set to use (e.g., based on the xTyR capability), the SRS resource or resource set can be from the SRS resources or resource sets configured by SIB or Msg4 or MsgB. In variant example, the SRS resource or resource set is pre-indicated in Msg2 or Msg4 or MsgB.

In one example, DCI Format or a PDSCH (e.g., carrying a MAC CE) can indicate an offset for transmission of early SRS, the offset is between the early SRS trigger or reference and the transmission of early SRS.

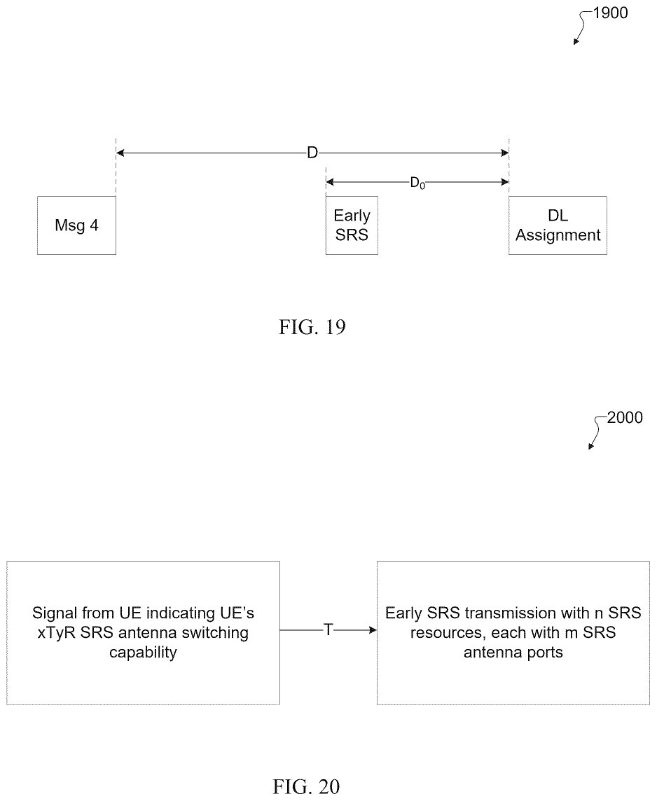

FIG. 19 illustrates an example of UE reception of a downlink assignment and transmission of associated early SRS 1900 according to embodiments of the present disclosure. The example of UE reception of a downlink assignment and transmission of associated early SRS 1900 shown in FIG. 19 is for illustration only and other embodiments can be used without departing from the scope of the present disclosure.

In one example, the UE receives a downlink assignment (e.g., for a DL transmission, for example first DL transmission after UE enters connected mode) a time D after Msg4 or after Msg2 or after MsgB as illustrated in FIG. 19 or a channel carrying a corresponding acknowledgment. In one example, the UE receives a downlink assignment at least a time D after Msg4 or after Msg2 or after MsgB. In one example, the UE receives a downlink assignment in a slot that starts a time D (or at least a time D) after Msg4 or after Msg2 or after MsgB or a channel carrying a corresponding acknowledgment. In one example, the UE receives a downlink assignment in a first (in time) slot that starts a time D after Msg4 or after Msg2 or after MsgB or a channel carrying a corresponding acknowledgment. In the aforementioned examples, a downlink assignment can be a DCI Format scheduling a DL transmission (e.g., DCI Format 1_0 or DCI Format 1_1 or DCI Format 1_2 in NR or similar DCI formats in 6G). In one example, D can be units of time, e.g., milli-seconds. In one example, D can be in units of symbols and/or slots and/or subframes and/or frames. In one example, D is from end of Msg4/Msg2/MsgB or a channel carrying a corresponding acknowledgment to start of downlink assignment as illustrated in FIG. 19. In one example, D is from start of Msg4/Msg2/MsgB or a channel carrying a corresponding acknowledgment to start of downlink assignment. In one example, D is from end of Msg4/Msg2/MsgB or a channel carrying a corresponding acknowledgment to end of downlink assignment. In one example, D is from start of Msg4/Msg2/MsgB or a channel carrying a corresponding acknowledgment to end of downlink assignment. In one example, D is from end of Msg4/Msg2/MsgB or a channel carrying a corresponding acknowledgment to start of slot of downlink assignment. In one example, D is from start of Msg4/Msg2/MsgB or a channel carrying a corresponding acknowledgment to start of slot of downlink assignment. In one example, D is from start (or end) of slot of Msg4/Msg2/MsgB or a channel carrying a corresponding acknowledgment to start (or end) of slot of downlink assignment.

In one example, D is defined in the system specifications. In one example, D is configured or provided by system information block (SIB). In one example, D is configured or provided by Msg2 or Msg4 or MsgB or a DCI Format triggering the SRS (e.g., early SRS). In one example, D is configured or provided by a signal or channel triggering SRS (e.g., early SRS), e.g., Msg2 or Msg4 or MsgB or a DCI Format triggering the SRS (e.g., early SRS).

In one example, the UE receives a PDSCH (e.g., for a DL transmission, for example first DL transmission after UE enters connected mode) a time D after Msg4 or after Msg2 or after MsgB as illustrated in FIG. 19 or a channel carrying a corresponding acknowledgment. In one example, the UE receives a PDSCH at least a time D after Msg4 or after Msg2 or after MsgB or a channel carrying a corresponding acknowledgment. In one example, the UE receives a PDSCH in a slot that starts a time D (or at least a time D) after Msg4 or after Msg2 or after MsgB or a channel carrying a corresponding acknowledgment. In one example, the UE receives a PDSCH in a first (in time) slot that starts a time D after Msg4 or after Msg2 or after MsgB or a channel carrying a corresponding acknowledgment. In one example, D can be units of time, e.g., milli-seconds. In one example, D can be in units of symbols and/or slots and/or subframes and/or frames. In one example, D is from end of Msg4/Msg2/MsgB or a channel carrying a corresponding acknowledgment to start of PDSCH. In one example, D is from start of Msg4/Msg2/MsgB or a channel carrying a corresponding acknowledgment to start of PDSCH. In one example, D is from end of Msg4/Msg2/MsgB or a channel carrying a corresponding acknowledgment to end of PDSCH. In one example, D is from start of Msg4/Msg2/MsgB or a channel carrying a corresponding acknowledgment to end of PDSCH. In one example, D is from end of Msg4/Msg2/MsgB or a channel carrying a corresponding acknowledgment to start of slot of PDSCH. In one example, D is from start of Msg4/Msg2/MsgB or a channel carrying a corresponding acknowledgment to start of slot of PDSCH. In one example, D is from start (or end) of slot of Msg4/Msg2/MsgB or a channel carrying a corresponding acknowledgment to start (or end) of slot of PDSCH.

In one example, D is defined in the system specifications. In one example, D is configured or provided by system information block (SIB). In one example, D is configured or provided by Msg2 or Msg4 or MsgB or a DCI Format triggering the SRS (e.g., early SRS). In one example, D is configured or provided by a signal or channel triggering SRS (e.g., early SRS), e.g., Msg2 or Msg4 or MsgB or a DCI Format triggering the SRS (e.g., early SRS).

In one example, the UE transmits the SRS (e.g., early SRS) a time D₀ before the downlink assignment as illustrated in FIG. 19. In one example, the UE transmits the SRS (e.g., early SRS) a time D₀ before PDSCH. In one example, the UE transmits the SRS (e.g., early SRS) at least a time Do before the downlink assignment or PDSCH. In one example, the UE transmits the SRS (e.g., early SRS) at most a time D₀ before the DL assignment or PDSCH. In one example, the UE transmits the SRS (e.g., early SRS) in a slot that starts (or ends) a time D₀(or at least a time D₀ or at most a time DO) before the DL assignment or PDSCH. In one example, the UE transmits the SRS (e.g., early SRS) in a latest slot that starts (or ends) a time D₀ before the DL assignment or PDSCH.

In one example, D₀ is defined in the system specifications. In one example, D₀ is configured or provided by system information block (SIB). In one example, D₀ is configured or provided by Msg2 or Msg4 or MsgB or a DCI Format triggering the SRS (e.g., early SRS). In one example, D₀ is configured or provided by a signal or channel triggering SRS (e.g., early SRS), e.g., Msg2 or Msg4 or MsgB or a DCI Format triggering the SRS (e.g., early SRS).

In one example, D₀ can be units of time, e.g., milli-seconds. In one example, D₀ can be in units of symbols and/or slots and/or subframes and/or frames. In one example, D₀ is from end of SRS to start of downlink assignment or PDSCH. In one example, D₀ is from start of SRS to start of downlink assignment or PDSCH as illustrated in FIG. 19. In one example, D₀ is from end of SRS to end of downlink assignment or PDSCH. In one example, D₀ is from start of SRS to end of downlink assignment or PDSCH. In one example, D₀ is from start of SRS slot to start of downlink assignment or PDSCH. In one example, D₀ is from start of SRS slot to end of downlink assignment or PDSCH. In one example, D₀ is from end of SRS slot to start of downlink assignment or PDSCH. In one example, D₀ is from end of SRS slot to end of downlink assignment or PDSCH. In one example, Do is from start of SRS slot to start of slot of downlink assignment or PDSCH. In one example, D₀ is from start of SRS slot to end of slot of downlink assignment or PDSCH. In one example, D₀ is from end of SRS slot to start of slot of downlink assignment or PDSCH. In one example, D₀ is from end of SRS slot to end of slot of downlink assignment or PDSCH.

FIG. 20 illustrates an example of UE transmission of xTyR capability 2000 according to embodiments of the present disclosure. The example of UE transmission of xTyR capability 2000 shown in FIG. 20 is for illustration only and other embodiments can be used without departing from the scope of the present disclosure.

In one example, a UE indicates its early SRS capability during random access procedure (e.g., in Msg1 or Msg3 or MsgA) as described in this disclosure. In one example, early SRS capability can indicate whether or not the UE supports early SRS. In one example, if a UE supports early SRS, the network triggers the UE to transmit early SRS, for example the trigger can be in Msg2 or Msg4 or MsgB or a DCI that triggers SRS (e.g., early SRS) as described in this disclosure. In one example, the UE transmits a signal that indicates the UE's xTyR capability before transmitting the SRS (e.g., early SRS) as illustrated in FIG. 20.

In one example, the signal indicating the UE's early SRS capability is PUCCH. In one example, the PUCCH can be PUCCH Format 0 or PUCCH Format 1 with a one bit or two payload indicating 1 out of 2 SRS antenna switching capabilities or 1 out of 4 SRS antenna switching capabilities respectively. In one example, there can be two PUCCH channels and the UE transmits the first PUCCH and the second PUCCH, and the first PUCCH has m₀ bits payload, and the second PUCCH has m₁ bits payload, wherein mᵢ∈{1,2} and i=0,1. In one example, the UE can indicate, using the 2 PUCCHs 1 out 2^{m}^{₀}^{+m}^{₁} SRS antenna switching capabilities. In one example, there can be two PUCCH channels and the UE transmits one of the first PUCCH or the second PUCCH, and the first PUCCH has m₀ bits payload, and the second PUCCH has m₁ bits payload, wherein mᵢ∈{1,2} and i=0,1. In one example, the UE can indicate, using the one of the two PUCCHes 1 out 2^{m}^{₀}+2^{m}^{₁} SRS antenna switching capabilities.

In one example, the SRS transmission is according to the SRS antenna switching capability indicated by the UE using the signal that indicates the UE's xTyR capability. For example, this can determine the number of SRS transmissions and the number of SRS ports for each SRS transmission. In one example, the number of antenna ports for SRS is based on (or equals) x. In one example, the number of SRS transmissions is based on x and y. In one example the number of SRS transmission equals y/x. For example, a UE with SRS antenna switching capability 2T4R can transmit 2 (=4/2) SRS resources, each SRS resource has two antenna ports to sound the 4 channels corresponding to the 4 receive antennas. Each SRS resource with two antenna ports can sound 2 channels corresponding to 2 receive antennas.

In one example, the signal/channel indicating the UE's xTyR SRS antenna switching capability (referred to as signal A) is transmitted a time T before the early SRS (or before the first resource of the early SRS). Wherein, T can be defined in the system specifications and/or configured or updated by SIB, Msg2/Msg4 or MgsB signaling or by a DCI Format triggering SRS (e.g., early SRS) or corresponding PDSCH. In one example signal A and SRS are in a same slot. In one example, signal A and SRS can be in different slots. In one example, T is from start of signal A to start of SRS. In one example, T is from end of signal A to start of SRS. In one example, T is from start of signal A to end of SRS. In one example, T is from end of signal A to end of SRS. In one example, T is from start (or end) of signal A to start (or end) of slot of SRS. In one example, T is from start (or end) of slot of signal A to start (or end) of SRS. In one example, T is from start (or end) of slot of signal A to start (or end) of slot of SRS. In one example, T can be units of time, e.g., milli-seconds. In one example, T can be in units of symbols and/or slots and/or subframes and/or frames.

In one example, the SRS is transmitted associated with PRACH preamble. In one example, a UE can be configured by system information to transmit SRS associated with or after a PRACH preamble. In one example, a UE can be indicated by a PEI and/or a paging message to transmit SRS associated with or after a PRACH preamble as aforementioned. The SRS transmission can be further conditioned on whether the UE transmits an associated PRACH preamble/RO from a first group of preambles and/or ROs or from a second group of preambles and/or ROs indicated in the system information. The SRS transmission can be further conditioned on whether the UE transmits an associated PRACH preamble/RO from a group of preambles and/or ROs from N groups of preambles and/or ROs indicated in the system information.

In one example, a UE can transmit a preamble, wherein the preamble (Msg1) indicates support of early SRS and/or the UE's antenna switching capability xTyR. In response to the preamble (Msg1), network can transmit a DCI format or PDSCH (e.g., carrying MAC CE) that trigger early SRS, following the aforementioned examples. In one example the network can indicate in the SIB, whether or not the network supports DCI format or PDSCH (e.g., carrying MAC CE) for triggering early SRS.

In one example, the SRS is associated with a RACH scheduled transmission or a Msg 3. In one example, a UE can be configured by system information to transmit SRS associated with or after a Msg3. In one example, a UE can be indicated by a PEI and/or a paging message to transmit SRS associated with or after a Msg3 as aforementioned. In one example, a UE can be indicated by a RAR to transmit SRS associated with or after a Msg3 as aforementioned. The SRS transmission can be further conditioned on whether the UE transmits an associated PRACH preamble/RO from a first group of preambles and/or ROs or from a second group of preambles and/or ROs indicated in the system information. The SRS transmission can be further conditioned on whether the UE transmits an associated PRACH preamble/RO from a group of preambles and/or ROs from N groups of preambles and/or ROs indicated in the system information. In one example, a UE can indicate in the Msg3 (e.g., by flag) whether or not there is an SRS transmission associated with Msg3. In one example, Msg3 indicates antenna switching capability (xTyR), or not being able to support antenna switching.

In one example, a UE can transmit a Msg3, wherein the Msg3 indicates support of early SRS and/or the UE's antenna switching capability xTyR. In one example, a UE can transmit a preamble (Msg1) and Msg3, wherein the preamble (Msg1) and Msg3 indicate support of early SRS and/or the UE's antenna switching capability xTyR. In response to the preamble (Msg1) and/or Msg3, network can transmit a DCI format or PDSCH (e.g., carrying MAC CE) that trigger early SRS, following the aforementioned examples. In one example the network can indicate in the SIB, whether or not the network supports DCI format or PDSCH (e.g., carrying MAC CE) for triggering early SRS.

In one example, the SRS is associated with a MsgA of Type-2 random access procedure. In one example, a UE can be configured by system information to transmit SRS associated with or after a MsgA. In one example, a UE can be indicated by a PEI and/or a paging message to transmit SRS associated with or after a MsgA as aforementioned. The SRS transmission can be further conditioned on whether the UE transmits an associated msgA PRACH preamble/RO from a first group of preambles and/or ROs or from a second group of preambles and/or ROs indicated in the system information. The SRS transmission can be further conditioned on whether the UE transmits an associated MsgA PRACH preamble/RO from a group of preambles and/or ROs from N groups of preambles and/or ROs indicated in the system information. In one example, a UE can indicate in the MsgA PUSCH (e.g., by flag) whether or not there is an SRS transmission associated with MsgA. In one example, MsgA PUSCH indicates antenna switching capability (xTyR), or not being able to support antenna switching.

In one example, a UE can transmit a MsgA PRACH, wherein the MsgA PRACH indicates support of early SRS and/or the UE's antenna switching capability xTyR. In one example, a UE can transmit a MsgA PUSCH, wherein the MsgA PUSCH indicates support of early SRS and/or the UE's antenna switching capability xTyR. In one example, a UE can transmit a MsgA PRACH and MsgA PUSCH, wherein the MsgA PRACH and MsgA PUSCH indicate support of early SRS and/or the UE's antenna switching capability xTyR. In response to the MsgA PRACH and/or MsgA PUSCH, network can transmit a DCI format or PDSCH (e.g., carrying MAC CE) that trigger early SRS, following the aforementioned examples. In one example the network can indicate in the SIB, whether or not the network supports DCI format or PDSCH (e.g., carrying MAC CE) for triggering early SRS.

In the aforementioned examples, early SRS triggering, can be replaced by early CSI-RS measurement and/or early CSI reporting, wherein the trigger can be for early measuring of CSI-RS (or SSB) using configured resources, e.g., for CSI-RS or SSB, (e.g., in SIB1 or in Msg4) and/or early reporting of CSI on uplink resources (e.g., PUCCH or PUSCH) wherein the UL resources and report configuration are configured by SIB1 or in Msg4.

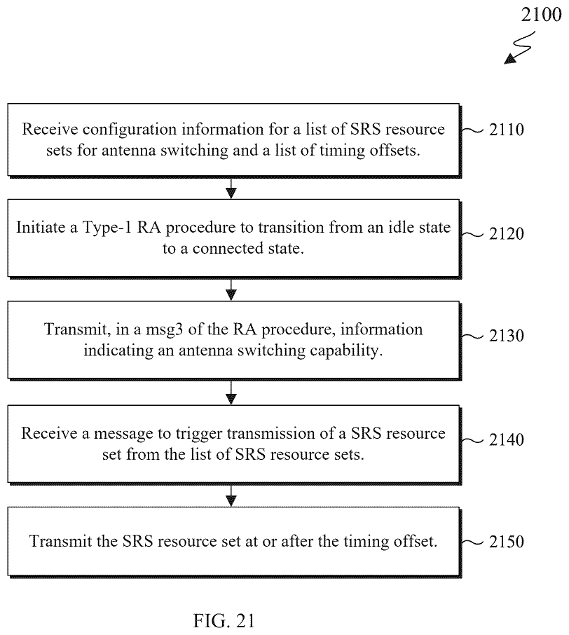

FIG. 21 illustrates an example method 2100 performed by a UE in a wireless communication system according to embodiments of the present disclosure. The method 2100 of FIG. 21 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 2100 is for illustration only and other embodiments can be used without departing from the scope of the present disclosure.

The method 2100 begins with the UE receiving configuration information for a list of SRS resource sets for antenna switching and a list of timing offsets (2110). The UE then initiates a Type-1 RA procedure to transition from an idle state to a connected state (2120). The UE then transmits, in a msg3 of the RA procedure, information indicating an antenna switching capability (2130).

The UE then receives a message to trigger transmission of a SRS resource set from the list of SRS resource sets (2140). For example, in 2140, the SRS resource set corresponds to the antenna switching capability, the message indicates a timing offset from the list of timing offsets, and the timing offset is relative to a slot that includes the message. In various embodiments, the message is a msg4 of the RA procedure. In various embodiments, the message is a DCI format, and the UE monitors a PDCCH for the DCI format starting at a time duration after an end of msg4 of the RA procedure. In various embodiments, the UE receives a block number from K blocks, and the trigger for transmission of the SRS resource set is included in a block identified by the block number. In various embodiments, the SRS resource set is an aperiodic SRS resource set. In various embodiments, the SRS resource set is a semi-persistent SRS resource set with a periodicity indicated in the message that triggers transmission of the SRS resource set.

The UE then transmits the SRS resource set at or after the timing offset (2150). In various embodiments, the UE monitors a PDCCH that includes a DCI format that deactivates the semi-persistent SRS resource set.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) comprising:
a transceiver configured to receive configuration information for:
a list of sounding reference signal (SRS) resource sets for antenna switching, and
a list of timing offsets; and
a processor operably coupled to the transceiver, the processor configured to initiate a Type-1 random access (RA) procedure to transition from an idle state to a connected state,
wherein the transceiver is further configured to:
transmit, in a message 3 (msg3) of the RA procedure, information indicating an antenna switching capability,
receive a message to trigger transmission of a SRS resource set from the list of SRS resource sets, wherein:
the SRS resource set corresponds to the antenna switching capability,
the message indicates a timing offset from the list of timing offsets, and
the timing offset is relative to a slot that includes the message, and transmit the SRS resource set at or after the timing offset.

2. The UE of claim 1, wherein the message is a message 4 (msg4) of the RA procedure.

3. The UE of claim 1, wherein:
the message is a downlink control information (DCI) format, and
the transceiver is further configured to monitor a physical downlink control channel (PDCCH) for the DCI format starting at a time duration (T2) after an end of a message 4 (msg4) of the RA procedure.

4. The UE of claim 3, wherein:
the transceiver is configured to receive a block number from K blocks, and
the trigger for transmission of the SRS resource set is included in a block identified by the block number.

5. The UE of claim 1, wherein the SRS resource set is an aperiodic SRS resource set.

6. The UE of claim 1, wherein:
the SRS resource set is a semi-persistent SRS resource set with a periodicity (P), and
the P is indicated in the message that triggers transmission of the SRS resource set.

7. The UE of claim 6, wherein:
the transceiver is further configured to monitor a physical downlink control channel (PDCCH) that includes a downlink control information (DCI) format, and
the DCI format deactivates the semi-persistent SRS resource set.

8. A base station (BS) comprising:
a processor; and
a transceiver operably coupled to the processor, the transceiver configured to:
transmit configuration information for:
a list of sounding reference signal (SRS) resource sets for antenna switching, and
a list of timing offsets,
receive a physical random access channel (PRACH) preamble from a user equipment (UE) for a Type-1 random access (RA) procedure to transition from an idle state to a connected state,
receive, in a message 3 (msg3) of the RA procedure, information indicating an antenna switching capability,
transmit a message to trigger transmission of an SRS resource set from the list of SRS resource sets, wherein:
the SRS resource set corresponds to the antenna switching capability,
the message indicates a timing offset from the list of timing offsets, and
the timing offset is relative to a slot that includes the message, and
receive the SRS resource set at or after the timing offset.

9. The BS of claim 8, wherein the message is a message 4 (msg4) of the RA procedure.

10. The BS of claim 8, wherein:
the message is a downlink control information (DCI) format, and
the transceiver is further configured to transmit a physical downlink control channel (PDCCH) for the DCI format after a time duration (T2) after an end of a message 4 (msg4) of the RA procedure.

11. The BS of claim 10, wherein:
the transceiver is configured to transmit a block number from K blocks, and
the trigger for transmission of the SRS resource set is included in a block identified by the block number.

12. The BS of claim 8, wherein the SRS resource set is an aperiodic SRS resource set.

13. The BS of claim 8, wherein:
the SRS resource set is a semi-persistent SRS resource set with a periodicity (P), and
the P is indicated in the message that triggers transmission of the SRS resource set.

14. The BS of claim 13, wherein:
the transceiver is further configured to transmit a physical downlink control channel (PDCCH) that includes a downlink control information (DCI) format, and
the DCI format deactivates the semi-persistent SRS resource set.

15. A method of operating a user equipment (UE), the method comprising:
receiving configuration information for:
a list of sounding reference signal (SRS) resource sets for antenna switching, and
a list of timing offsets;
initiating a Type-1 random access (RA) procedure to transition from an idle state to a connected state;
transmitting, in a message 3 (msg3) of the RA procedure, information indicating an antenna switching capability;
receiving a message to trigger transmission of an SRS resource set from the list of SRS resource sets, wherein:
the SRS resource set corresponds to the antenna switching capability,
the message indicates a timing offset from the list of timing offsets, and
the timing offset is relative to a slot that includes the message; and
transmitting the SRS resource set at or after the timing offset.

16. The method of claim 15, wherein the message is a message 4 (msg4) of the RA procedure.

17. The method of claim 15, wherein:
the message is a downlink control information (DCI) format, and
the method further comprises monitoring a physical downlink control channel (PDCCH) for the DCI format starting at a time duration (T2) after an end of a message 4 (msg4) of the RA procedure.

18. The method of claim 15, wherein the SRS resource set is an aperiodic SRS resource set.

19. The method of claim 15, wherein:
the SRS resource set is a semi-persistent SRS resource set with a periodicity (P), and
the P is indicated in the message that triggers transmission of the SRS resource set.

20. The method of claim 19, further comprising:
monitoring a physical downlink control channel (PDCCH) that includes a downlink control information (DCI) format,
wherein the DCI format deactivates the semi-persistent SRS resource set.
